(19) United States
(12) Patent Application Publication
(10) Pub. No.: US 2014/0309333 A1
(43) Pub. Date: Oct. 16, 2014

(54) Resins, Resin/Fibre Composites, Methods of Use and Methods of Preparation

(71) Applicant: Peter C. Hodgson, Speers Point (AU)

(72) Inventor: Peter C. Hodgson, Speers Point (AU)

(73) Assignee: MIRteq Pty Limited, Warabrook NSW (AU)

(21) Appl. No.: 14/128,932

(22) PCT Filed: Jul. 5, 2012
(86) PCT No.: PCT/AU2012/000808

§ 371 Date: Jun. 3, 2014

Related U.S. Application Data
(60) Provisional application No. 61/457,916, filed on Jul. 6, 2011.

(51) Int. Cl. C08K 7/14; C08L 63/04

(52) U.S. Cl. CPC C08K 7/14; C08L 63/04
USPC 523/400; 524/554; 524/604

(57) ABSTRACT

The present disclosure, pertains to resins, fibres, and/or resin/fibre composites. Certain aspects are directed to: the construction, composition and methods for producing resins, resin systems and/or resin blends that are suitable for use in very short fibre polymerisable liquid composites and other composites. Certain aspects are to the treatment of fibres and other types of reinforcement fillers so that they are suitable for use in very short fibre polymerisable liquid composites and other composites. Certain aspects are to methods of use and/or methods for producing very short fibre polymerisable liquid composites that can be produced by combining the aforesaid resins, resin systems and/or resin blends and treated fibres and other types of reinforcement fillers to produce suitable very short fibre polymerisable liquid composites.

### FIELD OF THE INVENTION

The present disclosure pertains to resins, fibres, and/or resin/fibre composites.

### BACKGROUND OF THE INVENTION

Fibre reinforced polymer composites are known in the art and are commonly made by reacting a curable resin with a reactive diluent in the presence of a free radical initiator. Typically, the curable resin is an unsaturated polyester resin and the reactive diluent is a vinyl monomer. Reinforcing materials such as fibre are often included in the formulations. Such reinforced composites are used in many industrial applications, including: construction, automotive, aerospace, and marine and for corrosion resistant products.

For many fibre reinforced polymer composites, the fibre lengths typically range from about 3 mm and greater, for example, filament winding. In these fibre polymer composites the majority of fibres are held in position by mechanical friction and there is only relatively weak bonding of the fibres to the resin matrix. Therefore, the performance of such polymer composites is influenced by the length of the fibres employed and in these composites there is a discontinuity/gap/space between the fibres and the resin. Cracks initiated in the resin matrix find it difficult to jump gaps, therefore in these composites cracks initiated in the resin are usually arrested at the resin boundary and do not reach the fibre surface. However, traditional resin/fibre composites have a number of shortcomings.

For example, it is difficult to “wet” the fibres with the resin composition prior to curing, and even dispersion of long fibres throughout the composite is difficult, especially for complex parts.

In addition, such traditional fibre reinforced polymer composites are limited by their production techniques, which generally require manual layering, or are limited in the shape and complexity of the moulds.

To overcome some of these shortcomings, short fibres, such as short glass fibres, may be used, for example, as disclosed in International Application No. PCT/AU2006/001536.

Very Short Fibre Polymerisable Liquid Composites (“VSFPLCs”) can produce composites with a number of desirable properties. VSFPLCs can be used to replace standard fibre layouts in a variety of applications, for example, open and closed moulding applications and also can be used, for example, as alternatives to thermoplastics in resin injection moulding and/or rotation moulding applications. They can also be used with traditional laminates. Typically, the fibres in VSFPLCs form strong chemical bonds between the resin and the fibres during the curing process. Coupling agents may be used to achieve this. A problem with silane coupling agents is that, unmodified, they can provide catalytic surfaces that tend to cause embrittlement of very short fibre/resin formulations over time. PCT/AU2006/001536 describes a fibre treatment which substantially reduces the tendency to become brittle with time. Prior to the fibre treatment disclosed in the above referenced patent many attempts were made to reduce embrittlement of such composites. However, none of these attempts were fully successful. One of the issues with the earlier prior art (before PCT/AU2006/001536) was that as the flexural strength of these earlier composites increased so did the flexural modulus, which reduced the area under the stress strain curve and increased brittleness. Also these earlier composites had little resistance to crack propagation. If the composites developed a tiny crack, or if there was an imperfection in the surface under tension, the ultimate yield stress, for example, could drop from 150 MPa for pristine laminates down to less than 80 MPa for panels with small defects in the surface under tension.

In addition, very short fibre composites made using commercially available milled glass have been found to be lacking in one or more properties, for example, the composites are brittle, have poor impact resistance, poor resistance to crack propagation and/or the interphase became brittle with time. Furthermore, in order to produce strong composites the fibre volume fraction was high and that influenced the physical properties. Polymerizing the coupling agent on the surface of the fibre did not reduce embrittlement because the interphase did not have similar properties to the bulk resin.

The present disclosure is directed to overcome and/or ameliorate at least one of the disadvantages of the prior art, as will become apparent from the discussion herein. The present disclosure is also to provide other advantages and/or improvements as discussed herein.

### SUMMARY OF INVENTION

Certain embodiments of the present disclosure are direct to resins, fibres, and/or resin/fibre composites.

Certain aspects are directed to: the construction, composition and methods for producing resins, resin, systems and/or resin blends that are suitable for use in very short fibre polymerisable liquid composites and other composites.

Certain aspects are to the treatment of fibres and other types of reinforcement fillers so that they are suitable for use in very short fibre polymerisable liquid composites and other composites.

Certain aspects are to methods of use and/or methods for producing very short fibre polymerisable liquid composites that can be produced by combining the aforesaid resins, resin systems and/or resin blends and treated fibres and other types of reinforcement fillers to produce suitable very short fibre polymerisable liquid composites.

Certain embodiments are to resin-fibre cured composite(s), comprising:

A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and
C) a coupling agent composition, wherein the coupling agent composition is present between 0.5 to 5 wt. % of the weight of fibres in the composite;
wherein:
a) the resin-fibre composite has one or more of the following properties:
i) a flexural strength of between 30 to 150 MPa;
ii) a tensile strength of between 20 to 110 MPa;
iii) an unnotched Izod impact strength of between 1.5 to 6 KJ/m²; and/or
iv) exhibits increased resistance to crack propagation;
b) the plurality of fibres have one or more of the following characteristics:
i) at least 85 wt. % of the plurality of fibres are less than 1 mm in length;
ii) a mean fibre length in the range between 200 to 700 microns; and/or
iii) a mean fibre diameter in the range of between 5 to 20 microns.

Certain embodiments are to resin-fibre composite(s), comprising:

A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and the fibre volume fraction is between 3 to 45% of the resin-fibre composite; and
C) a coupling agent composition, wherein the coupling agent composition is present between 0.5 to 5 wt. % of the weight of fibres in the composite;
wherein:
a) the resin-fibre composite has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m²;
viii) a HDT of between 50 to 150° C.;
ix) exhibits increased resistance to crack propagation;
x) energy required to break a standard panel in flexure greater than or equal to 2.5 J; and/or
xi) is substantially isotropic;
b) the plurality of fibres have one or more of the following characteristics:
i) at least 85 wt. % of the plurality of fibres are less than 1 mm in length;
ii) a mean fibre length in the range between 200 to 700 microns;
iii) a mean fibre diameter in the range of between 5 to 20 microns;
iv) a substantial percentage of the plurality of fibres have an aspect ratio of between 6 to 60;
v) no more than 3 wt. % of the plurality of fibres are greater than 2 mm in length; and/or
vi) no more than 5 wt. % of the plurality of fibres are greater than 1 mm in length;
c) the resin-fibre composite has one or more of the following additional properties:
i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
ii) a portion of the resin composition is conjugated to the at least one fibre of the plurality of fibres via a coupling agent residue of said coupling agent composition;
iii) a substantial portion of the plurality of fibres that are conjugated via the coupling agent residue are substantially non-catalytic;
iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation;
v) a portion of the resin composition is adhered via the coupling agent residue to at least one fibre of the plurality of fibres;
vi) the interphase is plasticized to reduce, or substantially reduce, interfacial stress in the cured composite;
vii) the interphase and the resin composition are similar, substantially similar, or sufficiently similar, wherein the physical properties are selected from one or more of the following: tensile modulus, tensile elongation flexural modulus and/or flexural elongation;
viii) the interphase efficiently transmits stress from the resin composition to the at least one fibre in the cured composite; and/or
ix) the interphase passivates the catalytic surface of the at least one fibre in the cured composite.

Certain embodiments are to resin-fibre composite(s), comprising:

A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and the fibre volume fraction is between 3 to 45% of the resin-fibre composite; and
C) a coupling agent composition, wherein the coupling agent composition is present between 0.5 to 5 wt. % of the weight of fibres in the composite;
wherein:
a) the resin-fibre composite has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m²;
viii) a HDT of between 50 to 150° C.;
ix) exhibits increased resistance to crack propagation;
x) energy required to break a standard panel in flexure greater than or equal to 2.5 J; and/or
xi) is substantially isotropic;
b) the plurality of fibres have one or more of the following characteristics:
i) at least 85 wt. % of the plurality of fibres are less than 1 mm in length;
ii) a mean fibre length in the range between 200 to 700 microns;
iii) a mean fibre diameter in the range of between 5 to 20 microns;
iv) a substantial percentage of the plurality of fibres have an aspect ratio of between 6 to 60;
v) no more than 3 wt. % of the plurality of fibres are greater than 2 mm in length; and/or
vi) no more than 5 wt. % of the plurality of fibres are greater than 1 mm in length. In addition, one or more additional properties as disclosed herein may be combined with the above embodiments.

Certain embodiments are to resin(s), comprising a resin composition having a molecular weight of between 3,000 and 15,000 Daltons;

wherein:
a) the resin composition is between 30 to 95 wt. % of the resin; and
b) the resin, upon curing, has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1.0 to 7 GPa;
vi) a tensile elongation of between 0.2 to 15%;
vii) an unnotched Izod impact strength of between 1.5 to 6 KJ/m²;
viii) a HDT of between 50 to 150° C.;
ix) exhibits increased resistance to crack propagation;
x) energy required to break a standard panel in flexure greater than or equals to 2.5 J; and/or
xi) is substantially isotropic.

Certain embodiments are to resin(s), comprising:

i) a first polyester segment, comprising one or more first dicarboxylic acid residues and one or more first diol residues;
ii) a second polyester segment, comprising one or more second dicarboxylic acid residues and one or more second diol residues; and
iii) a third polyester segment, comprising one or more third vinylic-containing acid residues and one or more third diol residues;
wherein:
a) the terminal ends of the first polyester segment are conjugated to the second polyester segments;
b) the second polyester segments, conjugated to the first polyester segment, are further conjugated to the third polyester segments;
c) the resin, terminating with the third polyester segments, terminates with the one or more third vinylic-containing acid residues and/or the one or more third diol residues; and
d) the resin, upon curing, has one or more of the following properties:
i) a flexural modulus of between 1 to 7 GPa;
ii) a flexural strength of between 30 to 150 MPa;
iii) a flexural elongation at break of between 2.0 to 20%;
iv) a tensile strength of between 20 to 110 MPa;
v) a tensile modulus of between 1 to 7 GPa;
vi) a tensile elongation of between 2.0 to 15%;
vii) an unnotched Izod impact strength of between 1.5 to 6 KJ/m²;
viii) a HDT of between 50 to 150° C.;
ix) exhibits increased resistance to crack propagation;
x) energy required to break a standard panel in flexure greater than or equal to 2.5 J; and/or
xi) is substantially isotropic.

Certain embodiments are to liquid resin-fibre composite(s), comprising:

A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and the fibre volume fraction is between 3 to 45% of the resin-fibre composite; and
C) a coupling agent composition, wherein the coupling agent composition is present between 0.5 to 5 wt. % of the weight of fibres in the composite;
wherein:
a) the liquid resin-fibre composite has one or more of the following properties:
i) a viscosity in the range of between 50 to 5,000 cPs at 25° C.; and/or
ii) is substantially isotropic;
b) the resin-fibre composite when cured has one or more of the following properties:
i) a flexural modulus of between 1 to 7 GPa;
ii) a flexural strength of between 30 to 150 MPa;
iii) a flexural elongation at break of between 0.2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m²;
viii) a HDT of between 50 to 150° C.;
ix) exhibits increased resistance to crack propagation;
x) energy required to break a standard panel in flexure greater than or equal to 2.5 J; and/or
x) is substantially isotropic;
c) the plurality of fibres have one or more of the following characteristics:
i) at least 85 wt. % of the plurality of fibres are less than 1 mm in length;
ii) a mean fibre length in the range between 200 to 700 microns;
iii) a mean fibre diameter in the range of between 5 to 20 microns;
iv) a substantial percentage of the plurality of fibres have an aspect ratio of between 6 to 60;
v) no more than 3 wt. % of the plurality of fibres are greater than 2 mm in length; and/or
vi) no more than 5 wt. % of the plurality of fibres are greater than 1 mm in length;
d) the liquid resin-fibre composite has one or more of the following additional properties:
i) a portion of the resin composition is conjugated to the at least one fibre of the plurality of fibres via a coupling agent residue of said coupling agent composition;
ii) a substantial portion of the plurality of fibres that are conjugated via the coupling agent residue are substantially non-catalytic;
iii) an interphase between the at least one fibre of the plurality of fibres and the resin composition having substantially the same properties as the resin composition upon curing, wherein the substantially same properties are selected from one or more of the following: tensile modulus, tensile elongation, flexural modulus and/or flexural elongation;
iv) a portion of the resin composition is adhered via the coupling agent residue to at least one fibre of the plurality of fibres;
v) the interphase is plasticized to reduce, or substantially reduce, interfacial stress in the cured composite;
vi) the interphase and the resin composition are similar, substantially similar, or sufficiently similar, wherein the physical properties upon curing are selected from one or more of the following: tensile modulus, tensile elongation flexural.modulus and/or flexural elongation;
vii) the interphase passivates the catalytic surface of the at least one fibre in the cured composite;
viii) the surface energy of a substantial portion of the plurality of fibres is match with the surface tension of the resin to promote wetting by reducing the contact angle of the resin on the fibre in the liquid resin-fibre composite; and/or
ix) the coupling agent is chemically bonded to the substantial percentage of the plurality of fibres surfaces so that the substantial percentage of the plurality of fibres forms a chemical bond with a portion of the resin composition via the coupling agent during the curing process.

Certain embodiments are to liquid resin-fibre composite(s), comprising:

A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and the fibre volume fraction is between 3 to 45% of the resin-fibre composite; and
C) a coupling agent composition, wherein the coupling agent composition is present between 0.5 to 5 wt. % of the weight of fibres in the composite;
wherein:
a) the liquid resin-fibre composite has one or more of the following properties:
i) a viscosity in the range of between 50 to 5,000 cPs at 25° C.; and/or
ii) is substantially isotropic;
b) the resin-fibre composite when cured has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m²;
viii) a HDT of between 50 to 150° C.;
ix) exhibits increased resistance to crack propagation;
x) energy required to break a standard panel in flexure greater than or equal to 2.5 J; and/or
x) is substantially isotropic;
c) the plurality of fibres have one or more of the following characteristics:
i) at least 85 wt. % of the plurality of fibres are less than 1 mm in length;
ii) a mean fibre length in the range between 200 to 700 microns;
iii) a mean fibre diameter in the range of between 5 to 20 microns;
iv) a substantial percentage of the plurality of fibres have an aspect ratio of between 6 to 60;
v) no more than 3 wt. % of the plurality of fibres are greater than 2 mm in length; and/or
vi) no more than 5 wt. % of the plurality of fibres are greater than 1 mm in length.
In addition, one or more of the disclosed addition properties may be combined with the above embodiments.

Certain embodiments are to resin composition(s), comprising: a blend of at least two or more resins; wherein:

a) the blend of at least two or more resins has one or more of the following properties:
i) a viscosity in the range of between 50 to 5,000 cPs at 25° C.; and
ii) is substantially isotropic; and
b) the resin composition has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m²;
viii) a HDT between 50 to 150° C.;
ix) exhibits increased resistance to crack propagation;
x) energy required to break a standard panel in flexure greater than or equal to 2.5 J; and/or
xi) is substantially isotropic.

Certain embodiments are to resin-fibre composite(s), comprising:

A) a blend of at least two or more resins; and
B) a plurality of fibres, wherein the plurality of fibres are between 5 to 65 wt. % of the resin-fibre composite; and the fibre volume fraction is between 3 to 45% of the resin-fibre composite;
wherein:
a) the blend of at least two or more resins has one or more of the following properties:
i) a viscosity in the range of between 50 to 5,000 cPs at 25° C.; and/or
ii) is substantially isotropic;
b) the resin-fibre composite has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m²;
viii) a HDT between 50 to 150° C.;
ix) exhibits increased resistance to crack propagation;
x) energy required to break a standard panel in flexure great than or equal to 2.5 J; and/or
xi) is substantially isotropic;
c) the plurality of fibres have one or more of the following characteristics:
i) at least 85 wt. % of the plurality of fibres are less than 1 mm in length;
ii) a mean fibre length in the range between 200 to 700 microns;
iii) a mean fibre diameter in the range of between 5 to 20 microns;
iv) a substantial percentage of the plurality of fibres have an aspect ratio of between 6 to 60;
v) no more than 0.3 wt. % of the plurality of fibres are greater than 2 mm in length; and/or
vi) no more than 5 wt. % of the plurality of fibres are greater than 1 mm in length; and/or
d) the resin-fibre composite has one or more of the following additional properties:
i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
ii) a portion of the resin composition is conjugated to the at least one fibre of the plurality of fibres via a coupling agent residue of said coupling agent composition;
iii) a substantial portion of the plurality of fibres that are conjugated via the coupling agent residue are substantially non-catalytic;
iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation;
v) a portion of the resin composition is adhered via the coupling agent residue to at least one fibre of the plurality of fibres;
vi) the interphase is plasticized to reduce, or substantially reduce, interfacial stress in the cured composite;
vii) the interphase and the resin composition are similar, substantially similar, or sufficiently similar, wherein the physical properties are selected from one or more of the following: tensile modulus, tensile elongation flexural modulus and/or flexural elongation;
viii) the interphase efficiently transmits stress from the resin composition to the at least one fibre in the cured composite; and/or
ix) the interphase passivates the catalytic surface of the at least one fibre in the cured composite.

Certain embodiments are to resin-fibre composite(s) comprising:

A) a resin composition having a molecular weight of between 3,000 and 4,000 Daltons, with one or more of the following properties: a tensile elongation at break greater than or equal to 5%; and/or a flexural yield stress of greater than 100 MPa; wherein the resin composition is between 35 wt. % to 40 wt. % of the resin-fibre composite;
B) a plurality of fibres, wherein the plurality of fibres are between 60 wt. % to 65 wt. % of the resin-fibre composite; and the fibre volume fraction is between 24 to 26% of the resin-fibre composite; and
C) a coupling agent composition, wherein the coupling agent composition is present between 3 to 5 wt. % of the total weight of the plurality of fibres and the coupling agent composition in the composite;
wherein:
a) the resin-fibre composite has one or more of the following properties:
i) a flexural modulus of between 5.8 to 7 GPa;
ii) a flexural strength of between 130 to 140 MPa;
iii) an flexural elongation at break of between 2% to 3%;
iv) a tensile strength of between 84 MPa to 100 MPa;
v) an HDT of between 70 and 75° C.; and/or
vi) is substantially isotropic;
b) the plurality of fibres have one or more of the following characteristics:
i) at least 85 wt. % of the plurality of fibres are less than 1 mm in length;
ii) a mean fibre length in the range between 200 to 350 microns;
iii) a mean fibre diameter is in the range between 10 to 14 microns; and/or
iv) a substantial percentage of the plurality of fibres have an aspect ratio of between 6 to 30;
c) the resin-fibre composite has one or more of the following additional properties:
i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
ii) a portion of the resin composition is conjugated to the at least one fibre of the plurality of fibres via a coupling agent residue of said coupling agent composition;
iii) a substantial portion of the plurality of fibres that are conjugated via the coupling agent residue are substantially non-catalytic; and/or
iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation.

The following embodiments may be useful for general purpose injection molding as well as other applications. Resin-Fibre composite(s), comprising:

A) a resin composition having a molecular weight of between 3000 and 5000 Daltons, with one or more of the following properties: tensile elongation at break greater than or equal to 7% and/or a flexural yield stress of greater than 80 MPa, wherein the resin composition is between 70 wt. % to 82 wt. % of the resin-fibre composite;
B) a plurality of fibres, wherein the plurality of fibres are between 18 wt. % to 30 wt. % of the resin-fibre composite; and the fibre volume fraction is between 8 to 15% of the resin-fibre composite; and
C) a coupling agent composition, wherein the coupling agent composition is present between 3 to 5 wt. % of the total weight of the plurality of fibres and the coupling agent composition in the composite;
wherein:
a) the resin-fibre composite has one or more of the following properties:

i) a flexural modulus of between 3 to 4.5 GPa;

ii) a flexural strength of between 80 to 120 MPa;
iii) an flexural elongation at break of between 4.5% and 7.5%;
iv) a tensile strength of between 48 MPa and 70 MPa;
v) an HDT of between 60 and 65° C.; and/or
vi) is substantially isotropic;
b) the plurality of fibres have one or more of the following characteristics:
i) at least 85 wt. % of the plurality of fibres are less than 1 mm in length;
ii) a mean fibre length in the range between 300 to 750 microns;
iii) a mean fibre diameter in the range between 11 to 13 microns; and/or
iv) a substantial percentage of the plurality of fibres have an aspect ratio of between 58 to 62;
c) the resin-fibre composite has one or more of the following additional properties:
i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
ii) a portion of the resin composition is conjugated to the at least one fibre of the plurality of fibres via a coupling agent residue of said coupling agent composition;
iii) a substantial portion of the plurality of fibres that are conjugated via the coupling agent residue are substantially non-catalytic; and/or
iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation.

The following embodiments may be useful for high HDT injection molding as well as other applications. Resin-Fibre composite(s), comprising:

A) a resin composition having a molecular weight of between 3,000 and 7,000 Daltons, with one or more of the following properties: tensile elongation at break greater than or equal to 3%; a flexural yield stress of greater than 70 MPa and/or an HDT of greater than 130° C., wherein the resin composition is between 70 wt. % to 82 wt. % of the resin-fibre composite;
B) a plurality of fibres, wherein the plurality of fibres are between 18 wt. % to 30 wt. % of the resin-fibre composite and the fibre volume fraction is between 8 to 15% of the resin-fibre composite; and
C) a coupling agent composition, wherein the coupling agent composition is present between 3 to 5 wt. % of the total weight of the plurality of fibres and the coupling agent composition in the composite;
wherein:
a) the resin-fibre composite has one or more of the following properties:
i) a flexural modulus of between 3.7 to 4.5 GPa;
ii) a flexural strength of between 80 to 100 MPa;
iii) an flexural elongation at break of between 2.5% and 3.5%;
iv) a tensile strength of between 48 MPa and 60 MPa;
v) an HDT of between 120 and 150° C.; and/or
vi) is substantially isotropic;
b) the plurality of fibres have one or more of the following characteristics:
i) at least 85 wt. % of the fibres are less than 1 mm in length;
ii) a mean fibre length in the range between 300 to 750 microns;
iii) a mean fibre diameter is around 12 microns; and/or
iv) a substantial percentage of the plurality of fibres have an aspect ratio of 60;
c) the resin-fibre composite has one or more of the following additional properties:
i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
ii) a portion of the resin composition is conjugated to the at least one fibre of the plurality of fibres via a coupling agent residue of said coupling agent composition;
iii) a substantial portion of the plurality of fibres that are conjugated via the coupling agent residue are substantially non-catalytic; and/or
iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation.

The following embodiments may be useful for chemically resistant injection molding as well as other applications. Resin-fibre composite(s), comprising:

A) an epoxy vinyl ester resin composition having a molecular weight of between 3,000 and 5,000 Daltons, with one or more of the following properties: tensile elongation at break greater than or equal to 7%, and/or a flexural yield stress of greater than 80 MPa, wherein the resin composition is between 70 to 82 wt. % of the resin-fibre composite;
B) a plurality of fibres, wherein the plurality of fibres are between 18 to 30 wt. % of the resin-fibre composite; and the fibre volume fraction is between 8 to 15% of the resin-fibre composite; and
C) a coupling agent composition, wherein the coupling agent composition is present between 3 to 5 wt. % of fibres in the composite;
wherein:
a) the resin-fibre composite has one or more of the following properties:
i) a flexural modulus of between 3 to 4.5 GPa;
ii) a flexural strength of between 80 to 120 MPa;
iii) an flexural elongation at break of between 4.5% and 7.5%;
iv) a tensile strength of between 48 MPa and 70 MPa;
v) an HDT of between 60 and 75° C.; and/or
vi) is substantially isotropic;
b) the plurality of fibres have one or more of the following characteristics:
i) at least 85 wt. % of the fibres are less than 1 mm in length;
ii) a mean fibre length in the range between 300 to 750 microns;
iii) a mean fibre diameter in the range between 11 to 13 microns; and/or
iv) a substantial percentage of the plurality of fibres have an aspect ratio of between 57 to 63;
c) the resin-fibre composite has one or more of the following additional properties:
i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
ii) a portion of the resin composition is conjugated to the at least one fibre of the plurality of fibres via a coupling agent residue of said coupling agent composition;
iii) a substantial portion of the plurality of fibres that are conjugated via the coupling agent residue are substantially non-catalytic; and/or
iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation.

In certain embodiments, the resin-fibre composite has a fibre volume fraction between 4 to 45% of the resin-fibre composite.

In certain embodiments, the resin-fibre composite has a flexural modulus of between 1 to 7 GPa.

In certain embodiments, the resin-fibre composite has a flexural elongation at break of between 2 to 20%.

In certain embodiments, the resin-fibre composite has a tensile modulus of between 1 to 7 GPa.

In certain embodiments, the resin-fibre composite has a tensile elongation of between 2 to 15%.

In certain embodiments, the resin-fibre composite has a HDT of between 50 to 150° C.

In certain embodiments, the resin-fibre composite has an energy required to break a standard panel in flexure of greater than or equal to 2.5 J.

In certain embodiments, the resin-fibre composite is substantially isotropic.

In certain embodiments, the resin-fibre composite has a substantial percentage of the plurality of fibres having an aspect ratio of between 6 to 60.

In certain embodiments, the resin-fibre composite has no more than 3 wt. % of the plurality of fibres are greater than 2 mm in length.

In certain embodiments, the resin-fibre composite has no more than 5 wt. % of the plurality of fibres are greater than 1 mm in length.

In certain embodiments, the resin-fibre composite has at least 85 wt. % of the plurality of fibres are independently overlapped by at least one other fibre within the resin-fibre composite.

In certain embodiments, the resin-fibre composite has a substantial percentage of the plurality of fibres having an aspect ratio of between 6 to 60; no more than 3 wt. % of the plurality of fibres are greater than 2 mm in length; and no more than 5 wt. % of the plurality of fibres are greater than 1 mm in length.

In certain embodiments, the resin-fibre composite has a portion of the resin conjugated to at least one fibre of the plurality of fibres via a coupling agent residue of said coupling agent composition.

In certain embodiments, the resin-fibre composite has a substantial portion of the plurality of fibres that are conjugated via the coupling agent residue are non-catalytic.

In certain embodiments, the resin-fibre composite has am interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation.

In certain embodiments, the resin-fibre composite has a chemical adhesion via a coupling agent residue of said coupling agent composition between a portion of the resin composition and a substantial percentage of the plurality of fibres.

In certain embodiments, the interphase between the resin composition and the substantial percentage of the plurality of fibres is plasticized to reduce, or substantially reduce, interfacial stress in the cured composite.

In certain embodiments, the interphase is modified so that the physical properties between the at least one fibre of the plurality of fibres and the resin composition are similar, substantially similar, or sufficiently similar, wherein the physical properties are selected from one or more of the following: tensile modulus, tensile elongation flexural modulus and/or flexural elongation.

In certain embodiments, the interphase between the resin composition and the substantial percentage of the plurality of fibres efficiently transmits stress from the resin composition to the substantial percentage of the plurality of fibres in the cured composite.

In certain embodiments, the interphase between the resin composition and the substantial percentage of the plurality of fibres passivates the catalytic surface of the substantial percentage of the plurality of fibres in the cured composite.

In certain embodiments, the resin composition, comprises: a blend of at least two or more resins; wherein the blend of at least two or more resins has a viscosity in the range of between 50 to 5,000 cPs at 25° C.

In certain embodiments, the blend of at least two or more resins comprises a weight ratio of between 97/3 for alloying resins up to 50/50 for mixtures that follow the Law of Mixtures.

In certain embodiments, the resin-fibre composite has a resin, comprising:

i) a first polyester segment, comprising one or more first dicarboxylic acid residues and one, or more first diol residues;
ii) a second polyester segment, comprising one or more second dicarboxylic acid residues and one or more second diol residues; and
iii) a third polyester segment, comprising one or more third vinylic-containing acid residues and one or more third diol residues;
wherein:
a) the terminal ends of the first polyester segment are conjugated to the second polyester segments;
b) the second polyester segments, conjugated to the first polyester segment, are further conjugated to the third polyester segments;
c) the resin, terminating with the third polyester segments, terminates with the one or more third vinylic-containing acid residues and/or the one or more third diol residues.

In certain embodiments, the at least one fibre in the resin-fibre composite is at least 50 wt. % of the plurality of fibres.

In certain embodiments, the at least one fibre in the resin-fibre composite is at least 75 wt. % of the plurality, of fibres.

In certain embodiments, the at least one fibre in the resin-fibre composite is at least 85 wt. % of the plurality of fibres.

In certain embodiments, the at least one fibre in the resin-fibre composite is at least 90 wt. % of the plurality of fibres.

In certain embodiments, the at least one fibre in the resin-fibre composite is at least 92 wt. % of the plurality of fibres.

In certain embodiments, the at least one fibre in the resin-fibre composite is at least 95 wt. % of the plurality of fibres.

In certain embodiments, the at least one fibre in the resin-fibre composite is at least 98 wt. % of the plurality of fibres.

In certain embodiments, the at least one fibre in the resin-fibre composite is at least 99 wt. % of the plurality of fibres.

In certain embodiments, the fibre in the resin-fibre composite has a cylindrical space has a diameter that is no greater than twice the diameter of the at least one fibre.

In certain embodiments, the fibre in the resin-fibre composite has a cylindrical space has a diameter that is no greater than 3 times the diameter of the at least one fibre.

In certain embodiments, the fibre in the resin-fibre composite has a cylindrical space has a diameter that is no greater than 4 times the diameter of the at least one fibre.

In certain embodiments, the fibre in the resin-fibre composite has a cylindrical space has a diameter that is no greater than 5 times the diameter of the at least one fibre.

In certain embodiments, the fibre in the resin-fibre composite has a cylindrical space has a diameter that is no greater than 6 times the diameter of the at least one fibre.

### BRIEF DESCRIPTION OF THE FIGURES

For a better understanding of the disclosure, and to show more clearly how it may be carried into effect according to one or more embodiments thereof, reference will now be made, by way of example, to the accompanying figures, in which:

FIG. 1 describes a 3 stage cook of a resin molecule depicting basic structure and structure functionality, according to certain embodiments.

FIG. 2 is a photo illustrating pill/lump formation due to the incidence of long fibers. The one on the left is lumpy due to the presence of an unacceptable amount of longer fibers. The one on the right is much smoother and was made according to certain disclosed embodiments.

FIG. 3 is a photo pill formation (right photo) that occurred due to the influence of long fibres during the fibre coating process. The coated fibre sample on the left is made according to certain disclosed embodiments and has few long fibres and therefore does not have a tendency to pill.

FIG. 4 is a photo illustrating pill formation in milled fibres.

FIG. 5 is a SEM photo of a very short fibre coated with coupling agent monomer and oligomer, according to certain embodiments.

FIG. 6 is a photo of untreated standard E-glass rovings of about 4 mm lengths that is used to mill suitable fibres. The rovings have been rubbed between the hands to illustrate how the strands separate into discrete filaments when the rovings are milled.

FIG. 7 is a photo of treated thermoplastic resin injection moulding E-glass fibres of about 4 mm lengths that have been rubbed between the hands in the same manner as the glass rovings in FIG. 6. These fibres do not separate into discrete filaments because it is important that they do not break down when sheared in a thermoplastic resin injection machine.

FIG. 8 is a photomicrograph of the milled and untreated FIG. 6 E-glass rovings broken down into individual filaments less than 1 mm, according to certain embodiments.

FIG. 9 is a schematic illustration of a vacuum air removal process, according to certain embodiments.

FIG. 10 is a schematic illustration of a vacuum air removal process, according to certain embodiments.

FIG. 11 is a selection of unsaturated polyester alloying resins that may be used to toughen vinyl ester resins, according to certain embodiments.

FIG. 12 is a generic vinyl ester molecule formula, according to certain embodiments.

FIG. 13 describes a 3 stage cook of a resin molecule depicting basic structure and structure functionality, according to certain embodiments.

FIG. 14 is a graph illustrating fibre length distribution, wherein the weight fraction is the y axis and the fibre length is the x axis, according to certain embodiments.

FIG. 15 is a graph illustrating fibre length distribution, wherein the weight fraction is the y axis and the fibre length is the x axis, according to certain embodiments.

FIG. 16 illustrates fibre fraction verses yield stress for a VSFPLC, according to certain embodiments.

FIG. 17 illustrates an exemplary 3 point bend test for a low elongation panel.

FIG. 18 illustrates an exemplary 3 point bend test for a moderate elongation panel.

FIG. 19 illustrates an exemplary 3 point bend test for a high elongation panel.

FIG. 20 is a micrograph of a fractured surface of a VSFPLC made with untreated glass fibres that demonstrates the absence of effective chemical bonding between the resin and glass fibres.

FIG. 21 is a micrograph of a fractured surface of a VSFPLC made with treated glass fibres in a resin composition that demonstrates the glass filaments have fractured because of the chemical bond between the treated glass fibres and the resin, according to certain embodiments.

FIG. 22 is another micrograph of a fractured surface of a VSFPLC made with treated glass fibres in a resin composition that demonstrates the glass filaments have fractured because of the chemical bond between the treated glass fibres and the resin, according to certain embodiments.

### DETAILED DESCRIPTION OF EMBODIMENTS OF THE INVENTION

The following description is provided in relation to several embodiments that may share common characteristics and features. It is to be understood that one or more features of one embodiment may be combined with one or more features of other embodiments. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

The subject headings used in the detailed description are included only for the ease of reference of the reader and should not be used to limit the subject matter found throughout the disclosure or the claims. The subject headings should not be used in construing the scope of the claims or the claim limitations.

The accompanying drawings are not necessarily to scale, and some features may be exaggerated or minimized to show details of particular components.

Certain embodiments of the present disclosure pertains to:
a) the construction, composition and methods for producing resins, resin systems and/or resin blends that are suitable for use in very short fibre polymerisable liquid composites and other composites;
b) the treatment of fibres and other types of reinforcement fillers so that they are suitable for use in very short fibre polymerisable liquid composites and other composites; and/or
c) the methods of use and/or methods for producing very short fibre polymerisable liquid composites that can be produced by combining the aforesaid resins, resin systems and/or resin blends and treated fibres and other types of reinforcement fillers to produce suitable very short fibre polymerisable liquid composites.

The fibres (“Fibres”) selected may be selected from a range of materials, including but not limited to glass, ceramics, naturally occurring glasses, polymers, cellulose, protein based or mineral fibres (such as wollastonite, clay particles, micas), or combinations thereof. In some aspects, the fibres may be chosen from E-, S- or C-class glass, optionally coated with a coupling agent. In certain embodiments, preferred fibres may be E-glass, S-glass, or combinations thereof.

Very short fibre polymerisable liquid composites (“VSFPLCs”) are suspensions of very short surface treated, reinforcing fibres in polymerisable resins/thermosets such as, but not limited to, UP resins, Vinyl functional resins, Epoxy resins, Polyurethane resins or combinations thereof.

Certain embodiments are directed to resins that are suited for use with composite materials that are made with short or very short fibres such as glass or ceramic fibres, wherein the composite has one or more improved properties. Certain embodiments are also directed to the production and use of such resins and/or resin systems in such composite materials.

Certain embodiments of the present disclosure are directed to resins with improved properties. Certain embodiments of the present disclosure are directed to these resins for use with formulations that include short or very short fibres, such as glass or ceramic fibre, wherein the formulations in liquid and/or cured form have one or more improved properties. The present disclosure is also directed to the production and use of such resins and/or resin systems in composite materials. To date, the resins that have been available for use with short fibres, or very short fibres in such composites, have lacked and/or under performed with respect one or more properties.

Certain embodiments relate to resins and/or resin systems, which have certain properties that make them more suited for use in composites with short fibres and very short fibres. Certain embodiments relate to resins and/or resins systems that are suitable for use in VSFPLCs. Certain embodiments are directed to producing thermoset resins suitable for use in VSFPLCs and other composites.

Certain aspects of the present disclosure are directed to resins for use with short fibres and/or VSFPLCs for producing products, such as composites and/or laminates, that have one or more of following properties: adequate tensile strength, adequate flexural strength, good ductility (i.e. is not brittle), adequate toughness and/or crack resistance. Certain aspects of the present disclosure are directed to VSFPLC products formulated from tough, crack resistant thermosets, and surface treated very short glass and/or ceramic fibres. For example, very short fibres manufactured by MIRteq Pty Limited.

Certain embodiments of the present disclosure are directed to VSFPLCs that may be used for producing laminates comprising at least one or more of the following properties: a tensile strength greater than 40 MPa, a flexural strength greater than 60 MPa, and/or a sufficient lack of brittleness i.e. Izod un-notched impact resistance greater than or equal to 3 KJ/m². Toughness with respect to certain embodiments may be defined as the area under the stress/strain curve, i.e., the amount of energy measured in Joules required to break a standard test bar that is 120 mm×18 mm×6 mm in flexure which is typically ≧ to 2.5 J. Other values for toughness may also be used. Certain embodiments are directed to methods of making composites with very short fibres wherein the composite has one or more of the following properties: adequate tensile strength, adequate flexural strength, adequate ductility (i.e., lacking brittleness), good impact resistance (greater than or equal to 3 KJ/m²), and/or is resistant to crack propagation, wherein the fibre volume fraction is between 3 to 12%, 10 to 12%, 13 to 17%, 18 to 27%, 28 to 37%, 38 to 45% of the total volume of the composite. In these embodiments, the fibre has little influence on the physical properties of the composite before curing. Other values for good impact resistance may also be used.

In contrast to certain disclosed embodiments, untreated very short fibre composites made with commercially available milled glass and commercially available laminating resins do not produce the minimum properties required for a serviceable liquid composite because commercially available milled fibres surfaces act as a positive catalyst in vinyl functional resins, increase the cross linking density in the interphase over time and causes embrittlement.

In certain embodiments, a substantial portion of the fibres may overlap each other, or substantially overlap each other, because the stress imparted to the fibres is zero, or near zero, at the ends of the fibres and is at a maximum, or near maximum, towards the middle of the fibres.

In certain embodiments, at least one fibre of the plurality of fibres may have at least one other fibre that is within a cylindrical space about the at least one fibre, wherein the cylindrical space has the at least one fibre as its axis and has a diameter that is between 1.25 to 6 times the diameter of the at least one fibre, for example no greater than 1.5 times the diameter of the at least one fibre, such as no greater than twice, no greater than 3 times, no greater than 4 times, no greater than five times, or no greater than 6 times the diameter of the at least one fibre. In certain embodiments, between 50 wt. % and 99 wt. % of the plurality of fibres are independently overlapped by at least one other fibre within the resin-fibre composite, for example, at least 50 wt. %, such as at least 60 wt. %; at least 70 wt. %; at least 75 wt. %; at least 80 wt. %; at least 85 wt. %; at least 90 wt. %; at least 92 wt. %; at least 95 wt. %; at least 97 wt. %; or at least 98 wt. %; of the plurality of fibres are independently overlapped by at least one other fibre within the resin-fibre composite. So if fibres are going to act in concert, it is desirable that they overlap. In certain embodiments, this desirable overlapping therefore defines the minimum quantity of very short fibres that will act together to reinforce composites. See Table 1 below for some exemplary embodiments of composites and of the properties that may be present with varying fibre content. The fibres used in this table are treated very short fibres that have been prepared according to certain embodiments.

TABLE 1

| Very Short Fibre | Flexural | Flexural | Flexural | |
|---|---|---|---|---|
| Content Wt % of | Strength | Modulus | Elongation | Tensile |
| Composite | MPa | GPa | % | Strength MPa |
| 10 to 12 | 60 to 100 | 1 to 3 | 2.8 to 3.3 | 38 to 60 |
| 13 to 17 | 60 to 100 | 2 to 4 | 2.8 to 4 | 38 to 60 |
| 18 to 27 | 70 to 140 | 2 to 5 | 3 to 8 | 40 to 85 |
| 28 to 37 | 80 to 123 | 3 to 6 | 3 to 4.2 | 45 to 72 |
| 38 to 50 | 80 to 110 | 4 to 6.5 | 2.5 to 3.3 | 45 to 64 |

Certain embodiments are directed to treating the fibres to create the chemical bond/adhesion between the resin and the fibres. This treatment involves treating the interphase between the resin composition and the fibre to achieve one or more of the following:
a) plasticize the interphase to reduce, or substantially reduce, interfacial stress in the cured composite;
b) modify the interphase so that one or more of selected physical properties (i.e. tensile modulus, tensile elongation, flexural modulus and/or flexural elongation) are similar, substantially similar, or sufficiently similar to selected physical properties of the bulk resin in the liquid composite and/or cured composite;
c) efficiently transmit stress from the bulk resin to the suspended fibres in the cured composite;
d) passivate the catalytic surface of the fibre in the liquid composite and/or the cured composite;
e) substantially match the surface energy of the fibre with the surface tension of the resin to encourage wetting by reducing the contact angle of the resin on the fibre in the liquid composite; and/or
f) chemically bond the coupling agent to the fibre surface so that the fibre forms a strong chemical bond with the thermoset resin via the coupling agent during the curing process. These chemical bonds allow stresses that form in the cured resin matrix to be efficiently transferred to the very short fibres.

Certain embodiments are to resin-fibre composite(s), comprising:

wherein: the resin-fibre composite has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m²;
viii) a HDT of between 50 to 150° C.;
ix) exhibits increased resistance to crack propagation;
x) energy required to break a standard panel in flexure greater than or equal to 2.5 J; and/or
xi) is substantially isotropic.

In certain aspects, the flexural modulus may be between 1 to 2 GPa; 2 to 2.5 GPa; 3 to 4 GPa; 4.5 to 5.6 GPa; 5.5 to 7 GPa, 1 to 4 GPa or 3 to 7 GPa. In certain aspects, the flexural strength may be between 25 to 125 MPa; 30 to 40 MPa; 35 to 55 MPa; 45 to 80 MPa; 70 to 140 MPa; or 100 to 150 MPa. In certain aspects, the flexural strength may be greater than 25, 30, 40, 55, 70, 100, 120, 140, or 150 GPa. In certain aspects, the flexural elongation at break may be between 2 to 20%; 2 to 2.5%; 3 to 3.8%; 4 to 6%; 5 to 9%; 9 to 20%; 2 to 10% or 15 to 20%. In certain aspects, the flexural elongation at break may be greater than 2%, 6%, 9%, 15% or 20%. In certain aspects, the tensile strength may be between 20 to 35 MPa; 40 to 65 MPa; or 70 to 110 MPa. In certain aspects, the tensile strength may be greater than 20 MPa, 35 MPa, 40 MPa, 65 MPa; 70 MPa 100 MPa or 110 MPa. In certain aspects the tensile modulus may be between 1 to 7 GPa; 1 to 2 GPa; 2.5 to 3.3 GPa; 3.6 to 4.5 GPa; and >4.5 GPa. In certain aspects, the tensile elongation may be between 2% to 15%; 2 to 2.5%; 3 to 4%; and 3.5 to 8%. In certain aspects, the unnotched Izod impact strength may be between 1.5 to 6 KJ/m2; 1.5 to 2 KJ/m2; 2.5 to 3.5 KJ/m2; 3.5 to 6 KJ/m2. In certain aspects, the HDT may be between 50 to 150° C.; 50 to 60° C.; 60 to 85° C.; 75 to 112° C.; 70 to 75° C.; 110 to 150° C. In certain aspects, the energy required to break a standard panel in flexure may greater than or equal to 2.5 J, 3 J, 3 J, 3.5 J, 4 J or 6 J. In certain aspects, the energy required to break a standard panel in flexure may between 2.5 to 3 J; 3 to 3.5 J; 4 to 6 J; 2.5 to 6 J or 3 to 6 J.

Certain embodiments are directed to sufficiently matching the properties of the interphase with those of the bulk resin to reduce embrittlement in the cured composite (i.e. the loss of flexural elongation over time).

Certain embodiments are directed to combining selected resins with selected short fibres that act in synergy to produce VSFPLCs with optimum properties. Certain embodiments are directed to producing strong, tough thermosets with excellent resistance to crack propagation wherein selected properties of the interphase and the bulk resin are sufficiently similar and maintain appropriate adhesion between the interphase and the fibre surface.

In certain embodiments, it is desirable to keep the length of the fibres used very short so that an appropriate viscosity of the liquid composite may be maintained. In certain aspects, appropriate viscosities range from 500 to 5,000 cPs at 25° C. In other aspects, appropriate viscosities range from 300 to 7,000 cPs, 700 to 6,000 cPc, 1,000 to 4,000 cPs, or 750 to 5,000 cPs at 25° C. One of the advantages of certain disclosed embodiments is that resin-fibre mixtures have an appropriate viscosity such that the mixtures may be sprayable and/or pumpable. In certain embodiments this is accomplished by combining the resin matrix with very short fibres wherein the coatings on the surfaces of these fibres are able to chemically bond with the resin matrix during polymerization/curing allowing stresses to be efficiently transmitted from the resin matrix into the fibres.

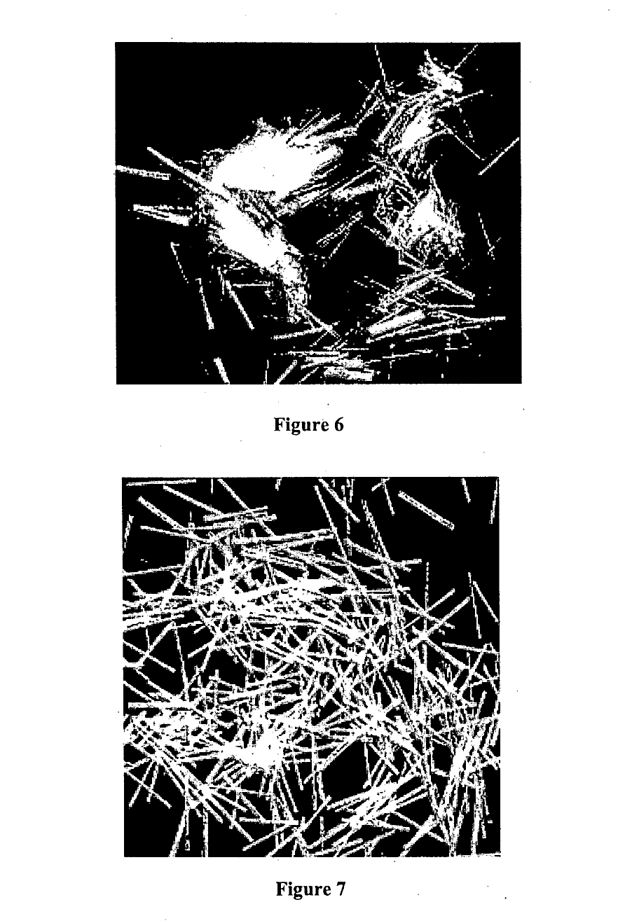

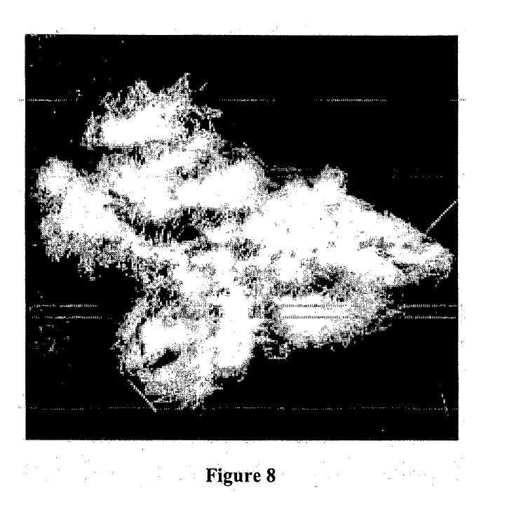

VSFPLCs can be used to replace standard fibreglass lay-ups in open and closed moulding applications. They can also be used as an alternative to thermoplastics in resin injection moulding and rotational moulding and can be used with traditional laminates. Some of the advantages of VSFPLC technology over standard fibreglass fabrication include one or more of the following: more environmentally friendly than most current fibreglass fabrication technologies; quicker and easier to use than current fibreglass fabrication technologies; productivity gains; and/or produces a safer work environment. VSFPLC materials are isotropic, or substantially isotropic, which means they can be moulded more easily and open up more design opportunities than standard fibreglass laminates. They also have much improved dimensional stability, more consistent physical properties, involve less labour because there is less materials handling and lamination, and/or lower hazardous air pollutants in the work environment. FIG. 6 is a photo of untreated standard E-glass rovings of about 4 mm lengths that is used to mill suitable fibres. The rovings have been rubbed between the hands to illustrate how the strands separate into discrete filaments when the rovings are milled. FIG. 7 is a photo of treated thermoplastic resin injection moulding E-glass fibres of about 4 mm lengths that have been rubbed between the hands in the same manner as the glass rovings in FIG. 6. These fibres are treated so that they do not separate into discrete filaments because it is important that they do not break down when sheared in a thermoplastic resin injection machine. They rely on frictional interaction and their strand length for their strength contribution. FIG. 8 is a photomicrograph of the milled and untreated FIG. 6 E-glass rovings broken down into individual filaments less than 1 mm, according to certain embodiments. The strength of the chemical bond achieved between the resin and the treated fibres is at least in part a function of the increased surface area provided by the glass filaments.

Additional advantages of certain embodiments may be found, for example, in resin injection and rotational moulding applications. For example, one or more of the following advantages may be present in certain embodiments: the moulds and resin injection equipment used is cheaper to build than that used in current thermoplastic injection; and/or certain VSFPLCs allow for improved productivity compared with RTM and light RTM processes currently used in thermoset injection molding as no, or less, glass reinforcement is required to be tailored and placed into moulds prior to injection. This allows for quicker mould turnaround than resin infusion moulding and therefore provides improved productivity; VSFPLC laminates may be isotropic, or substantially isotropic and therefore are much easier to design than standard long fibreglass laminates; VSFPLC laminates have better dimensional stability compared with standard long fibreglass laminates (standard long fibre laminates have mean fibre lengths equal to or greater than 2 mm); and VSFPLCs have more consistent physical properties.

Certain aspects of the present application are directed to approaches that maintain high yield stress and at the same time reduce embrittlement in the resin-fiber composites and/or VSFPLC laminates. These approaches require attention to one or more of the following four areas: 1) the fibre surface; 2) the interphase; 3) the bulk resin; and/or 4) the fibre fraction.

The Fibre Surface and Treatment and the Fibre Fraction

In certain embodiments, it is desirable that the fibres used are minimized as the fibres can act as a positive catalyst which can change the properties of the interphase so that it may be more brittle than the matrix resin.

In certain embodiments, it is desirable that the fibres used in VSFPLCs are processed such that positive catalyst activities are reduced and/or minimized. Positive catalyst activities can change the properties of the interphase so that it may become more brittle than the matrix resin. For example, fibres manufactured by MIRteq Pty Ltd may be used as these fibres, have little adverse effect on the resin interphase and are suitable for the manufacture of VSFPLCs.

In certain embodiments, fibres may include microglass milled fibers, such as E-glass filaments. These fibres may provide reinforcement in VSFPLCs to increase mechanical properties; such as impact, tensile, compressive and flexural; improve dimensional stability; and/or minimize distortion at elevated temperatures. For example, suitable fibres may include, but are not limited to, one or more of the following characteristics: a mean fibre diameter of 10 microns; a mean fibre length of less than 500 microns, (with minimal dust); an aspect ratio of 33:1; a loose bulk density of 0.22 to 0.30 g/cc; a moisture content of less than 0.1%; a loss on ignition of less than 1.05%; are free, or substantially free, of contaminations, such as contamination from foreign matter, dirt, oil, or grease, as well as free, or substantially free, of hard lumps of nodulated and/or unmilled fibers; a white color; a silane sizing; and/or a Floccular appearance.

Certain embodiments are directed to a modification on the surface of very short reinforcing fibres suspended in vinyl functional resins wherein the resulting interphase has the same, substantially the same, or similar bulk physical properties to the matrix resin.

Table 2 below compares energy at break between exemplary embodiments and commercially available fibres.

TABLE 2

| | | Average | |
|---|---|---|---|
| | | Flexural | |
| | | Yield | |
| | | Stress | Average |
| | % Glass in | (ASTM | Energy at |
| Glass Treatment | Resin | D790) | Break Izod |
| Untreated glass from various | 20% by | 76 MPa | 1.2 J. |
| sources in laminating resin | weight | | |
| Untreated glass from various | 20% by | 85 MPa | 1.9 J. |
| sources in exemplary resin | weight | | |
| MIRteq treated glass in | 20% by | 112 MPa | ≧2.5 J |
| exemplary resin | weight | | Range 2.5 to 6 J. |

The surfaces of silane treated ceramic fibres may be catalytic. They can increase the crosslinking density close to the fibres in what is called the interphase zone. This may have the effect of causing the cured composite to become brittle with time. The fibres used in certain embodiments of the present disclosure have been treated so that the surface no longer acts as a catalyst (or substantially reduces this activity), and/or the crosslinking density/properties of the interphase substantially mirror one or more selected properties of the matrix resin (i.e. tensile modulus, tensile elongation, flexural modulus and/or flexural elongation).

In certain embodiments, it is desirable for the resins used in VSFPLCs to be as tough and resilient as possible. This is exemplified by the energy required to break panels. Resins used in VSFPLCs with tensile elongations under 2% give <1 Joule of the energy required to break a standard panel with 20% glass content by weight. Resins used in VSFPLCs with tensile elongations between 2-4% require 1-2 joules to rupture a 20% glass filled panel. Resins used in VSFPLCs with tensile elongations between 4-6% require 2-2.8 joules to rupture a 20% glass filled panel. Panels made from resins used in VSFPLCs with tensile elongation >6% require greater than 3 joules to rupture a 20% glass filled panel. Typically, the higher the tensile elongation of the matrix resin the greater the energy required to rupture the panel.

In certain liquid composite embodiments which use fibres that have not been treated with appropriately (e.g., MIRteq treatments or other treatments) the articles become brittle with time. This happens because the untreated fibres behave as a catalyst that increases the cross linking density in the interphase such that the interphase is more highly cross linked than the bulk resin matrix. This embrittling is a time dependent process. As time passes the interphase become more and more brittle and therefore possibly no longer fit for service.

In certain embodiments, a coupling agent may be needed in VSFPLCs as the fibres may be shorter than their corresponding critical fibre length. A potential problem with coupling agents and naked ceramic fibres is that they both have a catalytic surface that increases the crosslinking density in the interphase thereby causing embrittlement.

Certain embodiments are directed to treating the fibres to create the chemical bond/adhesion between the resin and the fibres and the use of such fibres. This treatment involves treating the interphase between the resin composition and the fibre to achieve one or more of the following:
a) plasticize the interphase to reduce, or substantially reduce, interfacial stress in the cured composite;
b) modify the interphase so that one or more selected physical properties are similar, substantially similar, or sufficiently similar to selected physical properties of the bulk resin in the liquid composite and/or cured composite; (i.e. tensile modulus, tensile elongation, flexural modulus and/or flexural elongation)
c) efficiently transmit stress from the bulk resin to the suspended fibres in the cured composite;
d) passivate the catalytic surface of the fibre in the liquid composite and/or cured composite;
e) match the surface energy of the fibre with the surface tension of the resin to encourage wetting by reducing the contact angle of the resin on the fibres in the liquid composite; and/or
f) chemically bond the coupling agent to the fibre surface so that the fibre forms a strong chemical bond with the thermoset resin via the coupling agent during the curing process. These chemical bonds allow stresses that form in the cured resin matrix to be efficiently transferred to the very short fibres.

A variety of short fibres and very short fibres may be used with certain embodiments.

VSFPLC fibres may be treated with coupling agents. In some aspects, it is desirable that the treated fibres minimize the positive catalyst activity. In some aspects, it is desirable that the fibres used herein do not substantially increase the cross-linking density in the interphase.

In certain embodiments, the fibres may have a length distribution as follows: 98% passing through a 1 mm sieve and at least 50% passing through a 0.5 mm screen with approximately 10% passing through a 0.1 mm screen. An exemplary mean fibre length may be between 0.3 and 0.7 mm. Other mean fibre lengths may also be used as disclosed herein. In certain embodiments, the fibre length and/or the fibre length distribution may have an impact on the performance and/or properties of the cured composite. In certain embodiments, the mean, fiber length is between 0.2 to 0.4 mm, 0.5 to 1 mm, 0.2 to 0.7 mm, 0.3 to 1 mm, or 0.3 to 0.8 mm or 0.3 to 0.7 mm.

In some embodiments, to minimize the surface of treated fibres from becoming catalysts for accelerating free radical polymerization, it may be useful to passivate the fibre surface. For example, this may be achieved by: 1. coating the fibre surface with humectants; or 2. emulsifying a quantity of water in one of the fibre coating solutions and adding these to the fibres when compounding coatings on to the surface of the fibres. For example, the fibres may already be coated with humectants as well as mixed with an emulsion. Other ways to passivate the fibres may also be used. In certain embodiments, an aim of the fibre treatment is to produce in the cured laminate an interphase with physical properties similar to, or the same as, the bulk resin matrix.

In certain embodiments, suitable fibres, for example E-glass and S-glass, may have one or more of the following characteristics: strength, such as tensile strength of between 20 to 110 MPa or a flexural strength of between 30 to 150 MPa; minimal or no leaching when placed in deionized water; generally chemically resistant; and/or good electrical resistance. Other ranges and characteristics may also be used as disclosed herein. The fibre length may be between about 40 to 100μ, 40 to 150μ, 40 to 200μ, 40 to 250μ, 40 to 300μ, 40 to 350μ up to 1,500μ. In certain embodiments, it is desirable that the fibre distribution is such that it does not cause matting when dispersed in an un-thixed laminating resin with a viscosity between 300 cPs and 700 cPs in the weight percent range of 12 to 65% of the total laminate composite. In certain embodiments, it is desirable that the fibre distribution be such that it results in minimum matting when dispersed in an un-thixed laminating resin that have a viscosity between 200 cPs and 900 cPs, 300 cPs and 500 cPs, 250 cPs and 700 cPs, or 400 cPs and 600 cPs in the weight percent range of 5 to 70%, 10 to 40%, 20 to 65%, 30 to 70%, or 15 to 65% of the total laminate composite. Various combinations of the viscosity range and weight percentage range are contemplated as long as the matting is kept at an acceptable level. In certain embodiments, various fibre lengths and fibre distributions may be used as long as the fibre length and fibre distribution are such that it does not cause matting when dispersed. Composites made with short fibres or very short fibres may have certain properties that differ from the properties of long fibres when used in certain resin-fibre formulations. Typical long fibre composites may be defined as composites made with at least 5% of the fibres in the composite, on a weight basis where the fiber length is longer than 2 mm.

The amount of fibre used in the resin/fibre composite may vary. In certain embodiments, the weight percentage of the fibres may be between 5 to 65 wt. %, 10 to 65 wt. %, 12 to 65 wt. %, 10 to 50 wt. %, 20 to 50 wt. % or 10 to 30 wt. % of the resin-fibre composite.

In certain embodiments, the properties and characteristics that have been attributed the at least one fibre of the plurality of fibres within a resin composition, a resin-fibre composite, or a liquid resin-fibre composite as disclosed herein may be attributable to between 50 wt. % to 99 wt. % of the plurality of fibres in said resin composition, said resin-fibre composite, or said liquid resin-fibre composite. For example, at least 50 wt. % of the plurality of fibres, such as at least 75 wt. %; at least 85 wt. %; at least 90 wt. %; at least 92 wt. %; at least 95 wt. %; at least 98 wt. %; at least 99 wt. % of the plurality of fibres in said resin composition, said resin-fibre composite, or said liquid resin-fibre composite. In certain embodiments, the properties and characteristics attributed to the at least one fibre may be between 75 wt. % to 99 wt. %; 95 wt. % to 99 wt. %; 50 wt. % to 70 wt. %; 85 wt. % to 98 wt. %; 75 wt. % to 90 wt. % or 95 wt. % to 98 wt. % of the plurality of fibres in said resin composition, said resin-fibre composite, or said liquid resin-fibre composite In some embodiments, VSFPLCs have at least 98% of fibres less than 1 mm on a weight basis. In other embodiments, at least 86%, 88%, 90%, 94%, or 98% of fibres may be less than or equal to 0.7 mm, 0.9 mm, 1 mm, 1.1 mm, 1.2 mm, or 1.3 mm on a weight basis. In some embodiments up to 40% of fibres may be less than 0.2 mm. In some embodiments up to 20%, 25% 30%, 35% 40%, 45% or 50% of the fibres may be less than 0.1 mm 0.2 mm, 0.3 mm, 0.4 mm or 0.5 mm. In some embodiments, it is desirable that substantial chemical bonding of the resin to the fibres occurs in such formulations for a substantial portion of the fibres used.

The use of very short fibres represents a radical departure from the resin to glass interphase in typical long fibre laminates. In typical long fibre laminates most of the interaction between resin and glass is frictional interaction and the fibre length of these fibres is typically greater than 2 mm. In typical long fibre laminates, there is a gap/discontinuity between the resin matrix and the fibre. Cracks that form in typical long fibre composite resin matrix are arrested at this surface. VSFPLCs do not have this gap/discontinuity, hence their inherent tendency to brittle failure and a need for certain of the disclosed embodiments.

This tendency to brittleness in VSFPLCs comes from cracks initiating in the resin and traveling to the glass surface as a crack not a craze. Because the resin in certain VSFPLCs may be substantially chemically bonded to the fibres, or a substantial portion of the fibres, a portion of the energy driving the propagation of the crack is focused at a point, or points, on the fibre, and the fibre may, rupture allowing the crack to propagate through the fibre.

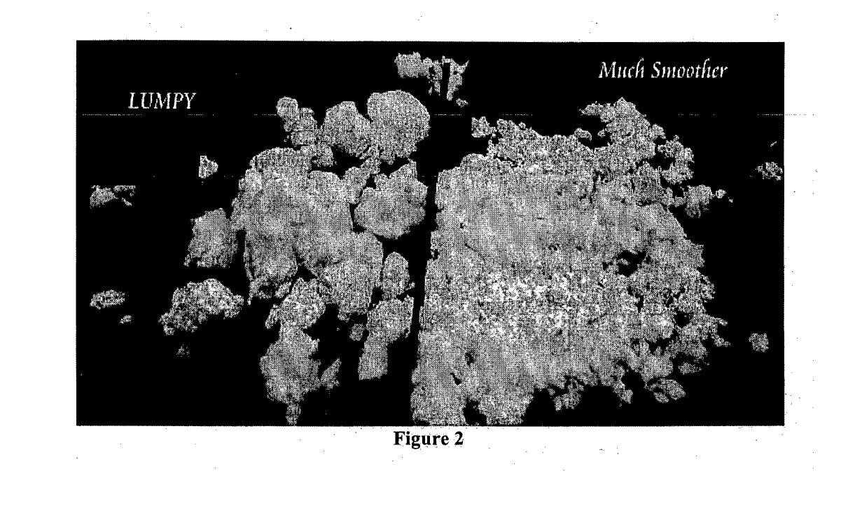

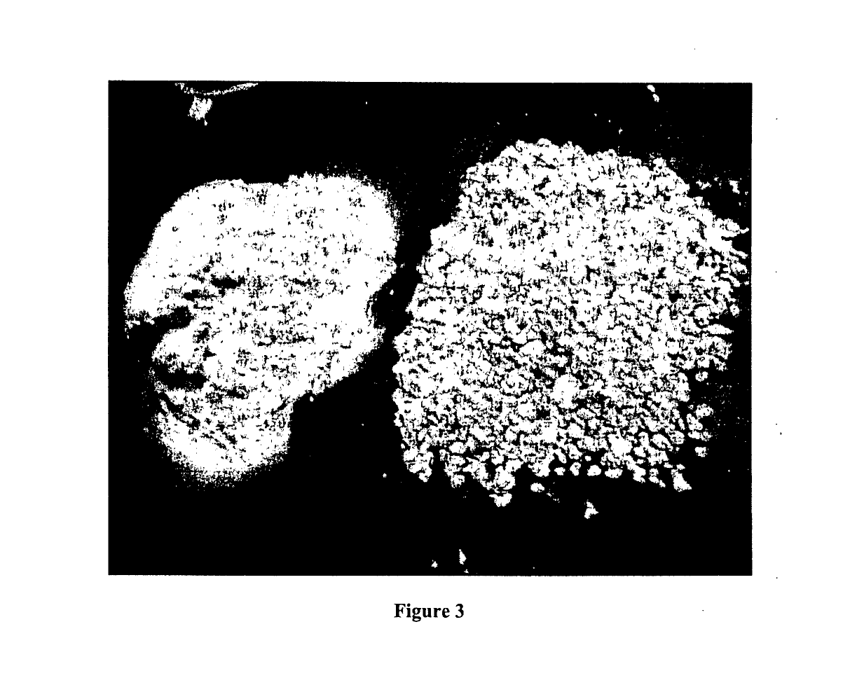

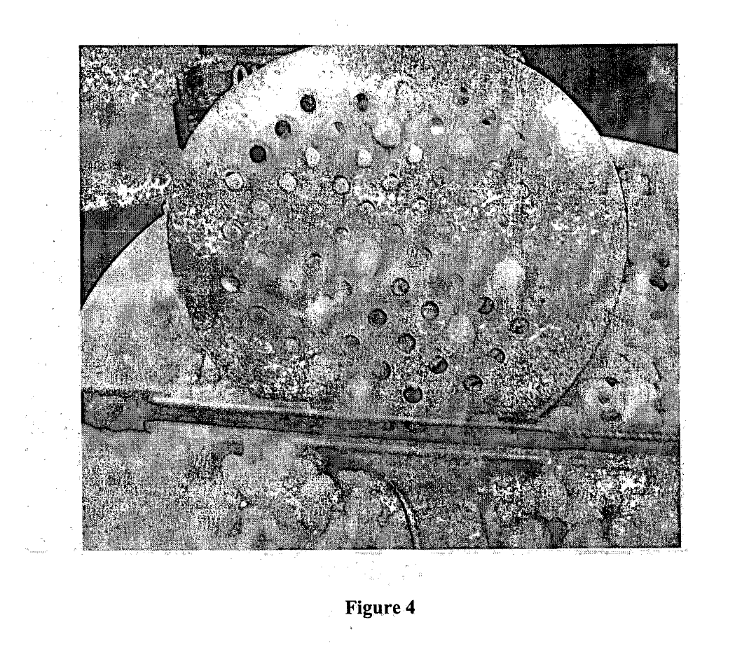

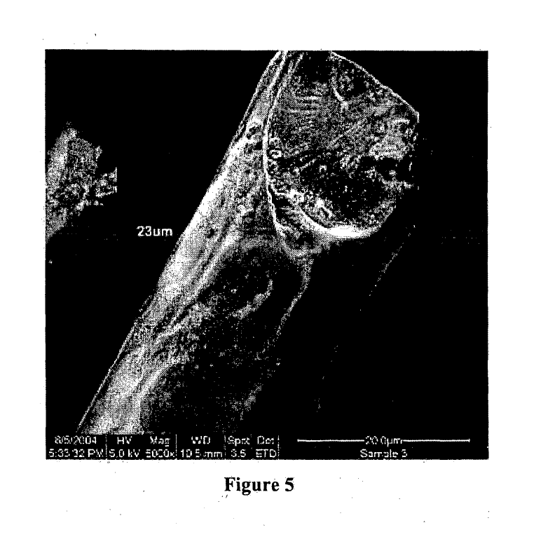

In certain embodiments, a relatively small percentage of long fibres, i.e., fibres longer than 1 mm, may interact to form pills and/or agglomerates of fibres, especially when dispersed in a liquid (See for example, FIG. 2, FIG. 3, and FIG. 4). These pills are difficult to remove because they keep reforming. FIGS. 2 and 3 depict the effect of fiber length on pill formation. In FIG. 3, the glass sample on the left has very few long fibres and therefore does not have a tendency to pill. In contrast, the glass sample on the right has a slightly higher mean fibre length and forms pills regularly. FIG. 4 depicts pill formation in milled fibres.

In some embodiments, it is difficult to disperse long fibres evenly in liquid composites which may cause the long fibres to produce lumps. These lumps if present in liquid composites may not accept chemical additives such as promoters and initiators, and therefore may form areas of under-cure in the composite, weakening the structure. In addition, long fibres may also impede air release, again weakening the structure. To work towards eliminating or reducing pill formation: 1) reduce the mean fibre length to below 1 mm; reduce the percentage of fibres longer than 1 mm, 1.1 mm, 1.25 mm, 1.4 mm, 1.5 mm, 1.7 mm or 2 mm to less than 3%, 5%, 7% or 10% as a fraction weight, or combinations thereof. In certain embodiments, the mean fibre length may be in one of the following ranges 0.2 mm to 0.4 mm; 0.3 mm to 0.5 mm; 0.6 mm to 0.7 mm; 0.8 mm to 0.9 mm; 0.2 mm to 1 mm or 0.3 mm to 0.9 mm.

In order to facilitate a substantially even fibre distribution with as near a uniform inter-fibre distribution, in some embodiments it may be desirable to make a paste by dispersing the fibres in resin using approximately equal weights of fibres and resin in a planetary mixer prior to dispersing in the matrix resin. If this process is carried out thoroughly, a substantial or sufficient portion of the fibres become coated with resin/polymer. Such dispersion aids in the eliminating and/or reducing pill formation. In some aspects, eliminating pill formation is desirable for maintaining strength and/or for cosmetic reasons. The presence of pills may cause irregularities in the surface of cured VSFPLC objects. Exemplary treated fibres that may be used are disclosed herein.

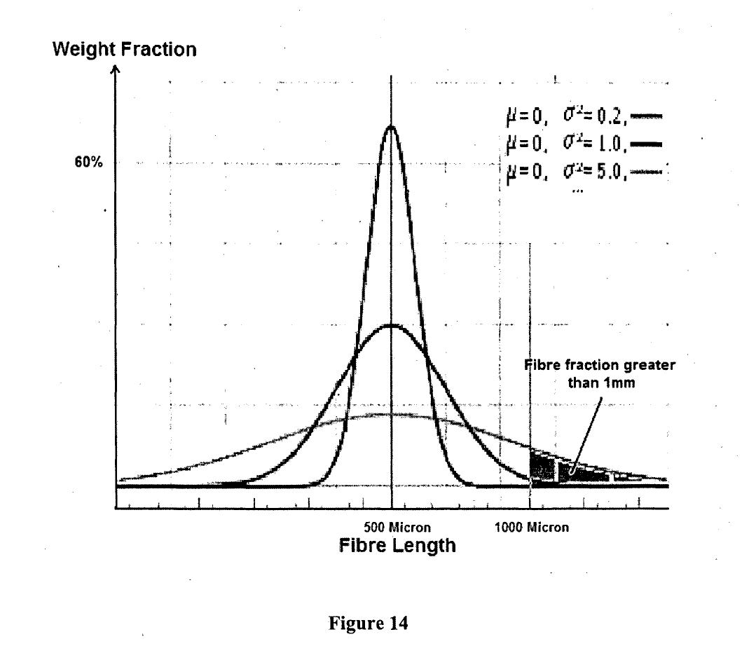

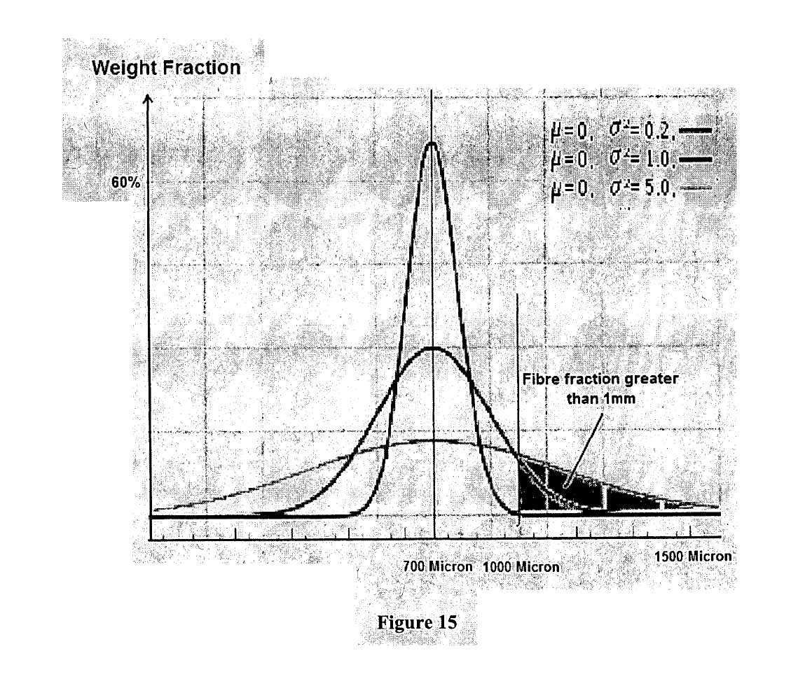

In certain embodiments, the fibre length distribution may also be relevant to the performance of the resin-fibre composites. For example, FIG. 14 and FIG. 15 show two graphs depicting three separate fibre distributions per graph. These graphs illustrate that as the mean fibre fraction grows the greater the need for a tight fibre distribution in certain embodiments. In these embodiments, once the fibre fraction over approximately 1 mm in length exceeds about 3% by weight of the liquid resin-fibre it may impact on the rheology of the liquid composite and encourage pill formation.

In certain embodiments, the optimum fibre fractions expressed in weight % of the liquid composite is between 15% and 50%, where the desire is to optimise both yield stress and energy to rupture a standard panel (120 mm×18 mm×6 mm) in flexure. In other embodiments, the optimum fibre fractions expressed in weight % of the liquid composite may be other percent ranges as disclosed herein.

In certain embodiments, the optimum mean fibre length distribution for glass and/or ceramic fibres may be between 200 microns and 700 microns. In other embodiments, the mean fibre length distribution may be other ranges as disclosed herein. In certain embodiments, the optimum fibre diameter distribution is between 5 microns and 20 microns. In other embodiments, the fibre diameter distribution may be other ranges as disclosed herein, for example between 5 microns and 10 microns, 5 microns and 25 microns, 10 microns to 25 microns, or 5 microns and 30 microns.

In certain embodiments, liquid composites made with surface treated wollastonite fibres may have an aspect ratio greater than 6 with a preferred aspect ratio of 12 or greater. In other embodiments, composites made with surface treated wollastonite fibres may have an aspect ratio greater than 6, 8, 10, 12, 14, 16 or 18.

In certain embodiments, the fibres used may have an aspect ratio greater than 6 with a preferred aspect ratio of 12 or greater, such as between 20 and 40. In other embodiments, the fibres may have an aspect ratio greater than 6, 8, 10, 12, 14, 16, 20, 25, 30, 35, 38, 40, 42, 45, 47, 50, 53, 55, 57 or 60.

In certain embodiments, liquid composites made with surface treated fibres may have an aspect ratio greater than 6 with a preferred aspect ratio of 12 or greater, such as between 20 and 40. In other embodiments, composites made with surface treated fibres may have an aspect ratio greater than 6, 8, 10, 12, 14, 16, 20, 25, 30, 35, 38, 40, 42, 45, 47, 50, 53, 55, 57 or 60.

In certain embodiments, fibre length and fibre length distributions in VSFPLCs may be restricted by the desired rheological properties. For example, over a certain % of long fibres (for example, fibres longer than 1 mm) the liquid composite may start to lose it homogenous appearance and matting may start to form in the dispersion. This is undesirable as it interferes with the material's viscosity, degrades the cosmetic appearance and/or reduces the serviceability of the cured composite.

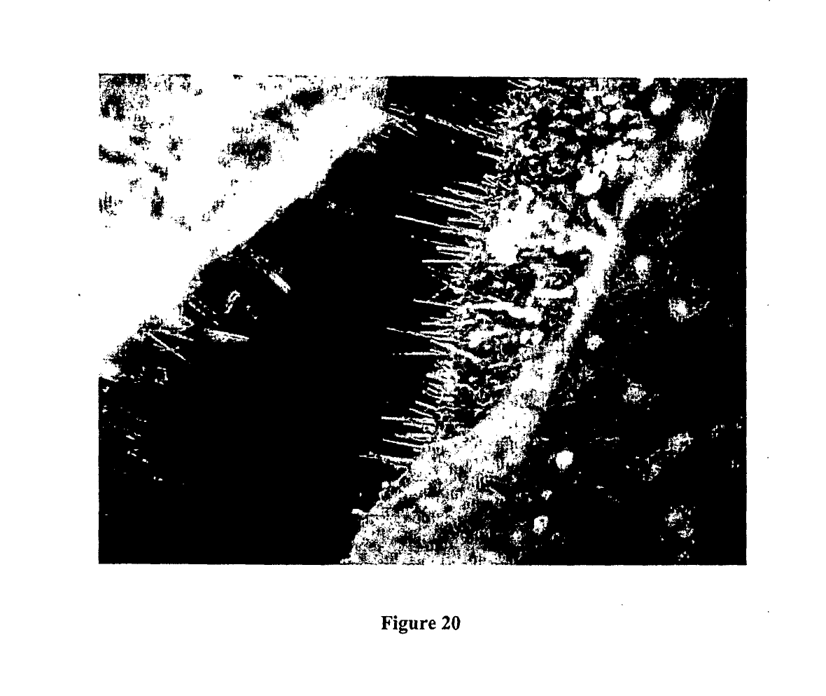

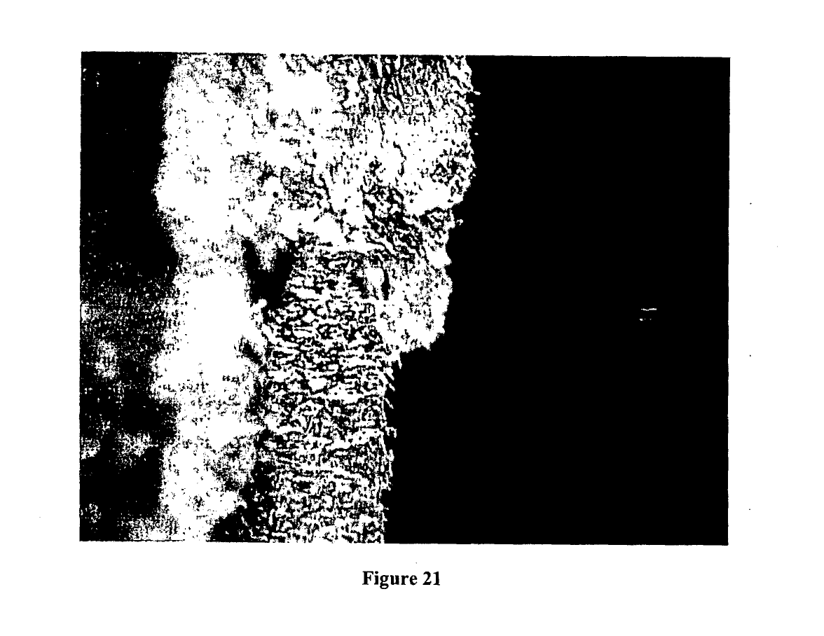

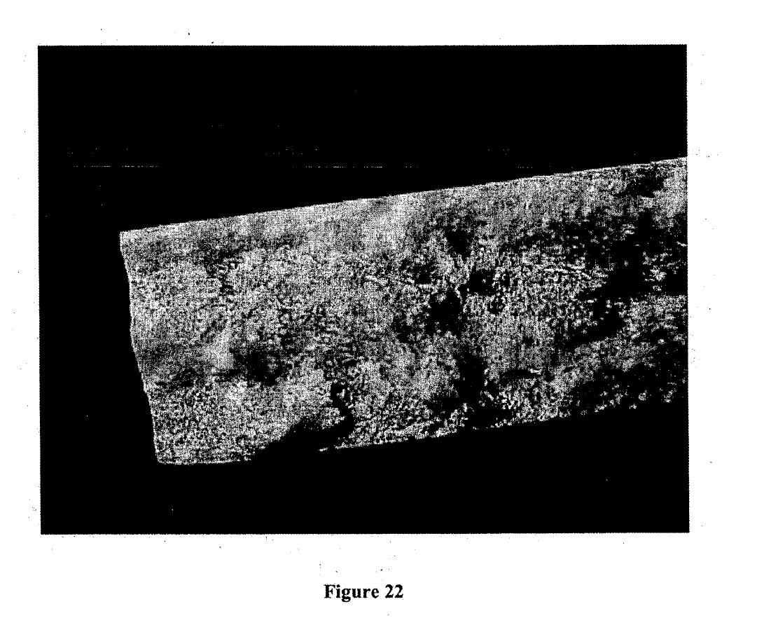

The fracture mechanics and the interaction between long fibre composites and VSFPLCs may be very different. VSFPLCs resin class interactions are through strong chemical bonds which when fractured fracture the bonded fibres—See micrographs FIGS. 21 and 22. Standard fibreglass interactions are frictional. See micrograph FIG. 20 where the absence of chemical bonding on the individual fibres is clearly apparent.

In certain embodiments, both Sheet Moulding Compounds (SMC)/glass composites and Bulk Moulding Compounds (BMC)/glass composites may be prepared with similar fibre treatments disclosed herein. SMC and BMC are both highly filled systems, therefore the fibreglass in these systems has to compete with the fillers for the resin coating. The fibre treatments disclosed herein result in fibres that are substantially coated with a resin solution prior to incorporation into a SMC or BMC formulation. The result is that the fibres will interact more intimately with the other components of the BMC and SMC formulations thereby improving the cosmetic finish, yield stress, minimizing fibre separation in deep pressings and improving the overall performance of the laminate.

### Making VSFPLC Fibres

The following discussion is directed to certain VSFPLC fibres that may be used with respect to certain disclosed embodiments. Many of the points discussed under this section may however be applicable to other disclosed embodiments.

The type of fibre, fibre length distribution, fibre diameter, and/or the volume ratio of fibres in VSFPLCs may each play a role in the properties of the cured composite.

The rheology of the liquid resin-fibre composite may impact the fibre length used in certain embodiments. In certain embodiments, filaments in VSFPLCs are typically shorter than 1 mm. Longer fibres tend to result in the formation of pills and/or localised thickening that limits the amount of glass than can be added to a VSFPLC, and therefore may adversely affect the physical properties of the cured laminate.

With respect to fibre diameter, it was initially theorized that the finer the glass filaments the stronger the resulting VSFPLC laminate. This was because the finer the diameter of the filament the shorter the filament length necessary to provide a given aspect ratio. This has not proved to be the case because the treatment—coupling agents—silanes and their resultant compounds provide a catalytic surface for free radical polymerisation. This is not a desirable outcome because silane coupling agents increase the cross-linking density in the interphase causing the resultant composite to become brittle. Fine diameter fibres have an increased specific, surface which only aggravates the catalytic problem. (The higher the specific surface, the stronger the catalytic effect). One way to limit the catalytic effect of the fibres is to reduce their surface area. The surface area to volume ratio of a cylinder is inversely proportional to the mean diameter of the filaments. So other things being equal, the larger the diameter of the filament the weaker its catalytic effect for a given volume of fibres. Also, the mean distance between filaments will increase for fibres with a greater diameter, which may be a very desirable outcome. The greater the mean distance between fibres the more chance a crack has to stabilise before it reaches the fibre surface. The lower the cross-linking density at the fibre surface the less energy the propagating crack has while travelling through the interphase, this means less energy is focused at a point on the surface of the fibre minimizing its tendency to rupture. By experiment, with respect to certain embodiments, the suitable diameter fibres are in the range 5 to 20 micron. Other diameters may be used as disclosed herein.

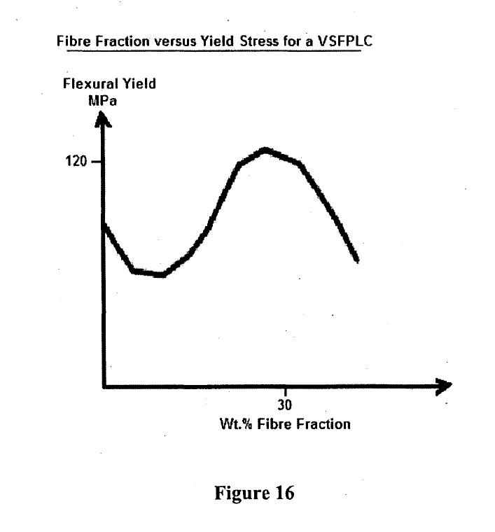

With, respect to fibre volume fraction, this may impact on the performance of a VSFPLC since it is related to the volume % of reinforcing fibres in the composite. FIG. 16 illustrates the effect of fibre fraction on the yield stress of a VSFPLC composite. As the catalytic nature of the fibre surface decreases, the initial dip caused by the addition of a small quantity of fibres becomes less pronounced. The second dip is caused by the inter-fibre distance decreasing, which reduces the resin's ability to stabilise cracks before they reach the interphase and ultimately the fibre surface.

With respect to the catalytic surface, minimizing the surface area of the fibres may limit their effectiveness as catalysts. The larger the fibre diameter the lower the surface area of the fibres for a given fibre volume/weight fraction, the lower the catalytic effect. In certain embodiments, this is desirable. As the diameter of a fibre increases so does its critical fibre length. This is because the tensile strength of the fibre increases by the square of the radius, while the specific surface is decreasing. This therefore may set, in certain embodiments, a typical upper limit for fibre diameters. In certain embodiments, it is believed that the optimum aspect ratio for a fine glass filament is between 20 and 40 times its length for use with certain VSFPLCs. So in examples where the desired fibres are less than 1 mm to optimise rheological/flow properties then a mean fibre length of approximately 900, 850, 800, 750, 700, 600, 500, 400, 300 or 250, microns may be selected depending on the fiber diameter. Typically such fibres may have a mean diameter somewhere between 5 microns and 20 microns diameter. As disclosed herein, other mean fibre lengths or ranges and/or diameters or ranges of diameters may be used. In certain embodiments, it may be desirable that the fibres used have a surface substantially free of surface contaminations. In certain applications, to activate the surface of fibres it may be desirable to boil them in clean water buffered at between pH8-9 for approximately 10 minutes. In certain embodiments, substantially coating the fibres in silane coupling agents may be undertaken. However silane coatings may be catalytic with respect to free radical polymerisation of UP resin solutions. Typically, the more thoroughly the fibre is coated with silane the stronger its catalytic affect.

With respect to catalytic surface modification, the aim is to reduce the crosslinking density at the interphase by reducing the catalytic effect of the filament surface. This may be accomplished with, for example, monomer deficient viscous resins, water, hindered phenols, hindered amines, other free radical scavengers or combinations thereof. It may be desirable in certain embodiments, to keep these compounds at the fibre/filament surface during a VSFPLCs life as a liquid. One way of accomplishing this is to mix the VSFPLC fibre into the resin just prior to commencing the curing reaction. Another way is to modify the surface of the fibre so that the chemicals that reduce crosslinking stay associated with the filament after mixing into the resin.

Below are some non-limiting examples of modifying solutions that reduce the crosslinking density:

Modifying Solution 1.

Using 83 grams of Z6030, 23 grams of TMP and 33 grams of DPG prepare as follows:

1. Dissolve 23 grams of TMP in 33 grams of DPG and heat to 120° C. to drive off water.
2. Thereafter add 1 gram tin catalyst and add 83 grams of Z6030 and heat at 110° C. until viscosity starts to build.
3. Cool and store at room temperature.

Modifying Solution 2.

Using 83 grams of Z6030, 17 grams of Pentaerithritol and 33 grams of DPG prepare as follows:

1. Dissolve 17 grams of Pentaerithritol in 33 grams of DPG and heat to 120° C. to drive off water.
2. Thereafter, add 1 gram tin catalyst and add 83 grams of Z6030 and heat at 110° C. until viscosity starts to build.
3. Cool and store at room temperature.

Modifying Solution 3.

Using 83 grams of Z6030, 23 grams of TMP and 28 grams of DEG prepare as follows:

1. Dissolve 23 grams of TMP in 28 grams of DEG and heat to 120° C. to drive off water.
2. Add 1 gram tin catalyst and add 83 grams of Z6030 and heat at 110° C. until viscosity starts to build.
3. Cool and store at room temperature.

Modifying Solution 4.

Using 83 grams of Z6030, 17 grams of Pentaerithritol and 28 grams of DEG prepare as follows:

1. Dissolve 17 grams of Pentaerithritol in 28 grams of DEG and heat to 120° C. to drive off water.
2. Add 1 gram tin catalyst and add 83 grams of Z6030 and heat at 110° C. until viscosity starts to build.
3. Cool and store at room temperature.

Modifying Solution 5.

Using 83 grams of Z6030, 23 grams of TMP and 18 grams of PG prepare as follows:

1. Dissolve 23 grams of TMP in 18 grams of PG and heat to 120° C. to drive off water.
2. Add 1 gram tin catalyst and add 83 grams of Z6030 and heat at 110° C. until viscosity starts to build.
3. Cool and store at room temperature.

Modifying Solution 6.

Using 83 grams of Z6030, 17 grams of Pentaerithritol and 18 grams of Ethylene Glycol prepare as follows:

1. Dissolve 17 grams of Pentaerithritol in 18 grams of Ethylene Glycol and heat to 120° C. to drive off water.
2. Add 1 gram tin catalyst, add 83 grams of Z6030 and heat at 110° C. until viscosity starts to build.
3. Cool and store at room temperature.

The above modifying/hydrogen bonding solutions are representative of polyfunctional and difunctional alcohols that can be used with silanes to coat silaceous surfaces and render them hydrophilic, according to certain embodiments.

Adding Coupling Agent to fibres:
a) Sieve fibres through a 1 mm screen. In these embodiments, do not sieve for more than about 30 seconds. It should be noted that longer fibres may pass through a 1 mm screen. Discard the oversize, and keep what falls through. The aim is to separate fibres less than 1 mm from the longer fibres. Sieve about 80 grams at a time until you have enough fibres for your testing. For example, sieving between 800 grams and 1.2 Kg at a time is acceptable for these illustrative experiments. Other ways to obtain the appropriate fibres may also be used.
b) Boil the sieved fibres in water buffered at between pH8-9 for about 10 minutes to remove contamination from the surface Z6030 (this process is optional depending on the particular fibres being tested).
c) Pour off the hot water and add about 6 litres of 0.25 water and 20 grams of Z6030 or Z6032, or Dynasylan MEMO
d) Mix thoroughly for five minutes and then add 50 ml of acrylic acid and stir for 1 hour. Then add 40 g of hydrolysing solution and mix for about 45 minutes until the hydrolysing solution actually hydrolyses and reacts with the fibre surface. This is done at 25° C.
e) Thereafter, drain off the solution and centrifuge the fibre. Form a bed of fibres on a tray about 10 mm thick. Place a thermocouple in the fibres in the tray such that the sensing element is about 5 mm below the surface of the fibres. Heat the fibres in an oven until the thermocouple reads 123° C. Hold it at this temperature for 5 minutes and then allow it to cool in a fan forced oven to room temperature. These are coupled fibres with a hydrophilic surface capable of entering into free radical polymerisation with components of the matrix resin.

Emulsions are prepared from low monomer content UP resins, preferably with saturated acid to unsaturated acid ratios greater than 1:1 on a mole fraction basis. Water resin emulsions typically add between 0.2% and 0.4% by weight of water to the hydrophylic surface of the fibres. These emulsions are used to coat fibres prior to them being added to the matrix resin. One aim of the emulsion is to loosely bond water to the hydrophylic surface of the fibre. The water is released from the fibre during exotherm reducing the cross-linking density in the interphase during the curing reaction.

Thereafter, compound 5 grams of emulsion with 36 grams of coupled glass and compound until they are thoroughly mixed and the filaments are coated. These fibres are now ready to go into resins to make liquid composites.

VSFPLCs are different to long fibre composites. Typically, long fibre composites are composites made with at least 90% of the fibres in the composite, on a weight basis, being longer than 2 mm. In contrast, certain VSFPLC embodiments typically have 95% of fibres <1 mm on a weight basis. In certain embodiments, the fibres used in VSFPLCs are so short, such that it is necessary to reduce the critical fibre length to typically less than 0.2 mm. In other embodiments, the fibres used have a critical fibre length less than or equal to 0.1 mm. In other embodiments, the critical fibre length may be less than or equal to 0.4 mm, 0.3 mm, 0.25 mm, 0.15 mm, or 0.075 mm. This results in the need for chemical bonding of the resin to the fibres. In these embodiments, reducing the critical fibre length is useful in order to impart significant stress into these very short fibres. This represents a radical departure from the resin to glass interphase in typical long fibre laminates. In typical long fibre laminates most of the interaction between resin and glass is frictional interaction and the critical fibre length of these fibres is typically greater than 2 mm. In other words, in typical long fibre laminates, there is a gap/discontinuity between the resin matrix and the fibre. Cracks that form in typical long fibre composite resin matrices are arrested at this surface. Certain embodiments of the disclosed VSFPLCs do not have this gap/discontinuity, hence their inherent tendency to brittle failure. This tendency to brittleness comes from cracks initiating in the resin and travelling to the glass surface as a crack not a craze. Because the resin in certain VSFPLC embodiments are intimately chemically bonded to the glass, the energy driving the propagation of the crack is focused at a point on the fibre, and the fibre ruptures allowing the crack to propagate through the fibre unhindered. Typically, there is a minimum net thickness of resin coating a substantially portions of the fibres, in order for the majority of crazes to be “stabilized” before they reach a fibre surface.

Exemplary, commercially available resins that provide the required properties for use in VSFPLCs are moderately high molecular weight bisphenol based epoxy vinyl ester resins with monomer (styrene) contents below 35%. With such low monomer contents these resins tend to be more viscous in the liquid state. They are not ideal resins in certain embodiments, but they can be used in VSFPLC formulations if impact resistance of the final product is of less concern. For certain high impact resistance, VSFPLCs need a more flexible blended resin with a more resilient UP and less VE resin. Other resins and methods for synthesizing UP and VE resins which are suited for use in VSFPLCs, according to certain embodiments are disclosed herein. For example, monomer deficient VE resins may be modified by adding reactive oligomers of the appropriate molecular shape, such that the blends are more suitable as VSFPLC resins. One such oligomers blend is a 50/50 mixture of CHDM CHDA oligomer diacrylate with terephthalic acid HPHP oligomer diacrylate, added as a 15% addition to the monomer deficient resins. This addition increases the yield stress by approximately 12% and elongation at peak load by up to approximately 50%.

### Coupling Agents

The coupling agent may be selected from a variety of coupling agents. In certain embodiments, the coupling agent comprises a plurality of molecules, each having a first end adapted to bond to the fibre and a second end adapted to bond to the resin when cured. An exemplary coupling agent is Dow Z-6030 (methacryloxypropyltrimethoxysilane). Other exemplary coupling agents are Dow Z-6032, and Z-6075 (vinyl triacetoxy silane) and similar coupling agents available from DeGussa and Crompton, for example Dynasylan. OCTEO (Octyltriethoxysilane), DOW Z6341 (octyltriethoxysilane), Dynasylan GLYMO (3-glycidyloxypropyltrimethoxysilane), DOW Z6040 (glycidoxypropyltrimethoxysilane), Dynasylan IBTEO (isobutyltriethoxysilane), Dynasylan 9116 (hexadecyltrimethoxysilane), DOW Z2306 (i-butyltrimethoxysilane), Dynasylan AMEO (3-aminopropyltriethoxysilane), DOW Z6020 (aminoethylaminopropyltrimethoxysilane), Dynasylan MEMO (3-methacryloxypropyltrimethoxysilane), DOW Z6030, DOW Z6032 (vinylbenzylaminoethylaminopropyltrimethoxysilane), DOW Z6172 (vinyl-tris-(2-methoxyethoxy) silane), DOW Z6300 (vinyltrimethoxysilane), DOW Z6011 (aminopropyltriethoxysilane) and DOW Z6075 (vinyl triacetoxy silane). Other exemplary coupling agents are titanates and other organo-metal ligands.

The amount of coupling agent used in the resin-fibre composition may vary. In certain embodiments, the coupling agent composition is present between 0.5 to 5 wt. % of the weight of fibres in the composite. In other embodiments, the coupling agent composition is present between 0.5 to 1.5 wt. %, 1 to 3 wt. %, 0.5 to 2 wt. % or in other suitable weight percentage ranges of the weight of fibres in the composite.

### Resin and Polyester Components

In certain embodiments, VSFPLCs made with toughened Vinyl Ester and Polyester resins can be used as alternatives to thermoplastics. For example, such embodiments are useful in small to medium runs in injection moulding applications. Certain embodiments of the resins disclosed herein can compete on an equal footing, or substantially equal footing, where strength is one of the selection factors if the fibre coating and resin systems are optimized.

Certain embodiments also relate to methods for producing thermoset resins suitable for use in VSFPLCs wherein the length of the surface treated, reinforcing fibres are kept very short so that they do not substantially increase the viscosity of the liquid composite. In some aspects this can be characterized as where the viscosity is such that the resin-fibre mixture is sprayable and/or pumpable.

Certain aspects of the present disclosure are directed to methods and/or formulations for improving the toughness and/or improving the UP and VE laminating/infusion resins resistance to crack propagation. Certain methods and/or formulations are directed to a balance between aromatic and cycloaliphatic structures to modify molecular interactions and crystalinity. Certain aspects are also directed to using a blend of long and short chain diols, asymmetric diols, branched or non-branched to reduce crystalinity and other molecular associations. Some of these embodiments may be used in lamination/infusion resins.

Certain embodiments are directed to the formulation and properties of the base resins or resins that are suitable for use in short fibre composites. Certain embodiments are directed to the formulation and properties of the base resins or resins that are suitable for use in VSFPLCs. Certain embodiments are directed to how to synthesize resins that comprise one or more of the following properties: strong, tough, and/or high elongation. Certain embodiments are directed to how to synthesize polyester and/or vinyl ester resins which are formulated to work synergistically with short fibre composites, VSFPLCs, and/or MIRteq fibres and comprise one or more of the following properties: strong, tough, and/or high elongation.

A resin composition may, for example, include a polyester having one or more polyester segments linked via one or more linkages. The one or more polyester segments may include one or more carboxylic acid residues, such as one or more dicarboxylic acid residues, and one or more alcohol residues, such as one or more diol residues. The resin may include multiple polyester segments, such as two or more polyester segments, three or more, four or more, five or more, or six or more polyester segments. The multiple polyester segments may be linked together via covalent bonds, such as one or more ester bonds. The multiple polyester segments may be linked together sequentially or in parallel. A suitable polyester segment of the resin may be derived from the polyesterification of one or more carboxylic acids with one or alcohols.

Carboxylic acid residues may include dicarboxylic acid residues, such as saturated dicarboxylic acid residues, unsaturated dicarboxylic acid residues, cyclic dicarboxylic acid residues, or aromatic dicarboxylic acid residues; and/or monocarboxylic acid residues, such as saturated or unsaturated monocarboxylic acid residues, for example, vinylic-containing acid residues.

Alcohol residues may include saturated diol residues, unsaturated diol residues, ether-containing diol residues, cyclic diols residues, and/or aromatic diol residues.

In certain embodiments, the resin composition may, for example, be terminated with alcohol residues, comprising a mixture of polyesters represented by following formulae, wherein the resin comprises a structure represented by Formula (I), (II), (III), or (IV):

R₂R₁-R₂ₚR₃R₄-R₃_{q}R₆R₅-R₆ᵣₙH (I)

R₂R₁-R₂ₚR₃R₄-R₃_{q}R₆R₅-R₆ᵣR₅ₙH (II)

R₁R₂-R₁ₚR₄R₃-R₄_{q}R₅R₆-R₅ᵣₙH (III)

R₁R₂-R₁ₚR₄R₃-R₄_{q}R₅R₆-R₅ᵣR₆ₙH (IV)

wherein:

i) R₁, R₃, and R₅ independently represent residues of one or more dicarboxylic acids;
ii) R₂, R₄, and R₆ independently represent residues of one or more diols;
iii) p independently represents an average value of 2-10;
iv) q independently represents an average value of 2-10;
v) r independently represents an average value of 0-10; and
vi) n independently represents an average value of 1-2.

R₁ independently represents residues of one or more carboxylic acids, comprising: an aromatic dicarboxylic acid; a cycloaliphatic dicarboxylic acid; orthophthalic acid, such as halogenated derivatives; isophthalic acid, such as halogenated derivatives; terephthalic acid, such as halogenated derivatives; 1,4-cyclohexane dicarboxylic acid (1,4-CHDA); phthalic acid; hydrogenated phthalic acid; and/or derivatives or mixtures thereof; wherein the residues of the one or more carboxylic acids may be derived from an acid, ester, anhydride, acyl-halogen form, or mixtures thereof;

R₂ independently represents residues of one or more alcohols, comprising: ethylene glycol; propylene glycol; pentaerythritol; trimethylol propane; MP diol; neopentyl glycol; glycols having a molecular weight of 210 Daltons or less; and/or derivatives or mixtures thereof;

R₃ independently represents residues of one or more carboxylic acids, comprising: 1,4-CHDA, a C₁-C₂₄ saturated dicarboxylic acid, such as succinic acid, glutaric acid, adipic acid, pimelic acid, suberic acid, azelaic acid, sebaic acid, and/or higher homologes; and/or derivatives or mixtures thereof; wherein the residues of the one or more carboxylic acids may be derived from an acid, ester, anhydride, acyl-halogen form, or mixtures thereof;

R₄ independently represents residues of one or more alcohols, comprising: diethylene glycol; triethylene glycol; dipropylene glycol; pentaerythritol; 1,6-hexane diol, and higher homologes; large cyclic aliphatic diols, such as large cyclic aliphatic primary diols; 2-butyl-2-ethyl-1,3-propane diol; pendant allyl alcohols and diols; neopentyl glycol; HPHP diol; aliphatic epoxies; cycloaliphatic epoxies; and/or derivatives or mixtures thereof;

R₅ independently represents residues of one or more carboxylic acids, comprising: a saturated and or an unsaturated acid, for example, a vinylic-containing acid, such as maleic acid, fumaric acid, acrylic acid, methacrylic acid, crotonic acid, and/or higher homologes, isomers, or derivatives thereof; an unsaturated acid anhydride, for example, a vinylic-containing anhydride, such as maleic anhydride, succinic anhydride, and/or higher homologes, isomers, or derivatives thereof; and/or derivatives or mixtures thereof; wherein the residues of the one or more carboxylic acids may be derived from an acid, ester, anhydride, acyl-halogen form, or mixtures thereof; and

R₆ independently represents residues of one or more alcohols, comprising: saturated diol or an unsaturated diol, such as saturated or unsaturated straight chain diol; and/or

Branched saturated or unsaturated diol, wherein the diol may comprise one or more degrees of unsaturation; and wherein:

p independently represents an average value of 1-10;
q independently represents an average value of 1-10;
r independently represents an average value of 0-10; and
n independently represents an average value of 1-2.

A suitable first polyester segment of the one or more polyester segments may be derived from the polyesterification of the one or more R₁ carboxylic acids with one or more R₂ alcohols. The first polyester segment may have a molecular weight of 1,500 Daltons or less, for example 300-1,500 Daltons. The first polyester segment may have a polydipersity index (PDI) of between 1 to 2.5. The first polyester segment may effect, provide some control, or control over one or more resin properties, such as flexural modulus and/or HDT.

A suitable second polyester segment of the one or more polyester segments may be derived from the polyesterification of one or more R₃ carboxylic acids with one or more R₄ alcohols. The second polyester segment may have a molecular weight of 800 Daltons or more, for example 800-2,000 Daltons. The second polyester segment may have a polydipersity index (PDI) between 1-2.5. The second polyester segment may effect, provide some control, or control over one or more resin properties, such as impact resistance and/or elongation. A suitable third polyester segment of the one or more polyester segments may be derived from the polyesterification of one or more R₅ carboxylic acids with one or more R₆ alcohols. The 3rd polyester segment may have a molecular weight of 800 Daltons or more, for example 800-2,000 Daltons. The 3rd polyester segment may have a polydipersity index (PDI) between 1-2.5. The third polyester segment may effect, provide some control, or control over one or more resin properties, such as cross-linking density.

Certain embodiments are directed to vinyl functional resins and polyester resins that may be suitable for use in VSFPLCs, such as: Derakane 8084 and 8090 made by Ashland Chemical Company, Swancor 890 and 891, Reichhold's Dion 9400, Dion 9500, Dion 9600, Dion 9800 and Dion 9102. Another suitable resin in certain embodiments is the rubber modified resin RF3200 made by Cray Valley. However, the above resins lack certain desirable properties in some embodiments.

FIG. 12 illustrates a formula for vinyl esters suitable for use as a VSFPLC matrix resin, where n=10 or greater in certain embodiments.

Certain short fibre composites or VSFPLCs may be made with moderately high molecular weight rubber modified bisphenol based epoxy vinyl ester resins with monomer (styrene) contents in ranges between 25 to 30%, 30 to 35%, 35 to 50%. They may not be desirable resins in some applications, but they can be used, for example, in VSFPLC formulations if impact resistance of the final product is of less concern. However, as disclosed herein, vinyl ester resins may be modified by, for example, adding vinyl functional oligomers and polymers of the appropriate molecular shape, such that the blends are more suitable as VSFPLC resins for certain applications. Certain embodiments are directed to formulating unsaturated polyester resins which have suitable properties, as standalone resins and/or as blending resins.

In some aspects, monomer deficient vinyl ester resins may be modified by adding vinyl functional oligomers and/or polymers of the appropriate molecular shape, such that the blends are more suitable for use in certain VSFPLC resins. Certain aspects are directed to formulating unsaturated polyester resins that have suitable properties, as standalone resins and/or as blending resins.

In addition, to the selection of molecular building blocks, the esterification reactions may be carried out in three or more stages to position moieties at specific locations in the growing unsaturated polyester. The end result being tailor made UP resins with specific molecular structures. These UP resins may be blended with each other, other suitable unsaturated polyester resins, VE resins, or combinations thereof to obtain resin formulations with selected desirable properties. Certain aspects are directed to resins that produce cured composites which sufficiently inhibit crack propagation by stabilizing the craze zone ahead of the propagating crack. These resins can be further modified with polyester acrylates, butadiene acrylates, methacrylates, other UP resins or combinations thereof. Certain aspects are directed to produce resins that are tough, resist crack propagation, have flexural strengths equal to, or greater than 70, 80, 90, 100, 110, 120, 130, 140 or 150 MPa.

A polyester resin, for example, may have one or more polyester segments linked via one or more linkages. The one or more polyester segments may include one or more carboxylic acid residues, such as one or more dicarboxylic acid residues, and one or more alcohol residues, such as one or more diol residues. The resin may include multiple polyester segments, such as two or more polyester segments, three or more, four or more, five or more, or six or more polyester segments. The multiple polyester segments may be linked together via covalent bonds, such as one or more ester bonds. The multiple polyester segments may be linked together sequentially or in parallel. A suitable polyester segment of the resin may be derived from the polyesterification of one or more carboxylic acids with one or more alcohols.

Carboxylic acid residues may include dicarboxylic acid residues, such as saturated dicarboxylic acid residues, unsaturated dicarboxylic acid residues, cyclic dicarboxylic acid residues, or aromatic dicarboxylic acid residues; and/or monocarboxylic acid residues, such as saturated or unsaturated monocarboxylic acid residues, for example, vinylic-containing acid residues.

Alcohol residues may include saturated diol residues, unsaturated diol residues, ether-containing diol residues, cyclic diols residues, and/or aromatic diol residues.

A suitable first polyester segment of the one or more polyester segments may be derived from the polyesterification of one or more carboxylic acids with one or more alcohols, wherein the one or more carboxylic acids may include the acid, ester, anhydride, or acyl-halogen forms of the following: aromatic dicarboxylic acid and/or cycloaliphatic dicarboxylic acid, such as orthophthalic acid, isophthalic acid, terephthalic acid, 1,4-cyclohexane dicarboxilic acid, and/or hydrogenated phthalic acid; and wherein the one or more alcohols may include: ethylene glycol, propylene glycol, pentaerythritol, trimethylol propane, MP diol, neopentyl glycol, glycols having a molecular weight of 210 Daltons or less, and/or or derivatives thereof. The first polyester segment may have a molecular weight of 1,500 Daltons or less, for example 300 to 1,000, 500 to 1,000, 800 to 1,500, 1,000 to 1,500, or 500 to 1,500 Daltons. The first polyester segment may have a polydipersity index (PDI) in the range 1 to 2.5. The first polyester segment may effect, provide some control, or control over one or more resin properties, such as flexural modulus and/or HDT.

A suitable second polyester segment may be derived from the polyesterification of one or more carboxylic acids with one or more alcohols, wherein the one or more carboxylic acids may include the acid, ester, anhydride, or acyl-halogen forms of the following: 1,4-CHDA, C₁-C₂₄ saturated dicarboxylic acids, such as succinic acid, glutaric acid, adipic acid, pimelic acid, suberic acid, azelaic acid, sebaic acid, and/or, higher homologes; and wherein the one or more alcohols may include: straight and/or branched chain diols having a molecular weight of 50, 60, or 65 Daltons or more, such as diethylene glycol, trimethylene glycol, dipropylene glycol, pentaerythritol, 1,6-hexane diol, and higher homologes, large cyclic primary diols, 2-butyl-2-ethyl-1,3-propane diol, neopentyl glycol, HPHP diol, aliphatic epoxies, cycloaliphatic epoxies, and/or derivatives thereof. The second polyester segment may have a molecular weight of 2,000 Daltons or more, for example: 700 to 2,000, 900 to 1,500, 800 to 2,000, 1,000 to 1,500, 1,000 to 2,000, 1,500 to 2,000 Daltons, or 1,500 to 3,000 Daltons. The second polyester segment may have a polydipersity index (PDI) between 1 to 2.5. The second polyester segment may effect, provide some control, or control over one or more resin properties, such as impact resistance and/or elongation.

A suitable third polyester segment of the one or more polyester segments may be derived from the polyesterification of one or more carboxylic acids with one or more alcohols, wherein the one or more carboxylic acids may include the acid, ester, anhydride, or acyl halogenated forms of the following: unsaturated acids, for example, vinylic-containing acids, such as maleic acid, fumaric acid, acrylic acid, methacrylic acid, crotonic acid, and/or higher homologes, isomers, or derivatives thereof; or unsaturated acid anhydrides, for example, vinylic-containing anhydrides, such as maleic anhydride, succinic anhydride, and/or higher homologes or derivatives thereof; and wherein the one or more alcohols may include: straight and/or branched chain diols which may or may not have one or more degrees of unsaturation. The third polyester segment may have a molecular weight of 1,400 Daltons or more, for example 1,400-10,000 Daltons. The third polyester segment may have a polydipersity index (PDI) between 1 to 2.5. The third polyester segment may also effect, provide some control or control over one or more resin properties, such as cross-linking density.

In certain embodiments, the resin composition may have a molecular weight of between 3,000 and 15,000 Daltons. In other embodiments, the resins composition may have a molecular weight of between 2,500 and 25,000 Daltons, 4,000 to 17,000 Daltons, 3,000 to 6,000 Daltons, 5,000 to 12,000 Daltons as well as other molecular weight ranges.

In certain VSFPLCs, the bulk resin may be formulated to produce sufficiently strong fibrils in the craze zone when the bulk resin ruptures to stabilize the craze ahead of a crack preventing it from propogating. It is desirable that these fibrils be sufficiently strong such that they are capable of sufficiently stabilizing, substantially stabilizing or stabilizing the craze zones ahead of cracks and to inhibit these cracks from propagating. In certain embodiments, the resin fraction is the dominant factor in determining certain bulk properties in VSFPLCs. In certain embodiments, it is desirable that there is sufficient volume of resin around each fibre such that the composite is capable of stabilizing the craze zone ahead of a propagating crack. The stabilizing of the craze zone reduces the destructive energy reaching the interphase and ultimately the fibre surface. In certain embodiments, the resin fraction may be 50%, 60%, 70%, 80%, 90%, or 95% of the total weight of the composite. In certain embodiments, the resin fraction may be between 50 to 95%, 60 to 85%, 50 to 80%, 50 to 60%, 70 to 95%, 80 to 95% or 90 to 95% of the total weight of the composite. In certain embodiments, it is desirable that sufficient volume of resin be present such that a substantial portion of the fibres are substantially surrounded by resin. In certain embodiments, it is desirable that sufficient volume of resin be present such that a substantial portion of the fibres are substantially surround by resin and the composite is capable of substantially stabilizing, sufficiently stabilizing or stabilizing a substantial portion of the craze zones found in the composite ahead of crack propagation.

As discussed herein, the tendency to brittleness in certain VSFPLCs comes in part from cracks initiating in the resin and traveling to the glass surface as a crack not a craze. Because the resin in certain VSFPLCs are intimately chemically bonded to the glass, a, portion of the energy driving the propagation of the crack may be focused at a point on the fibre, and the fibre may rupture allowing the crack to propagate through the fibre.

Therefore, in certain VSFPLCs selected properties of the composites are related to the composition of the resin matrix. Therefore, in certain embodiments, (where the volume fraction range of the fibres is 8 to 35%, 6 to 40%, 8 to 20%, 10 to 35%, 20 to 50% as these fractions leave the resins as the dominant volume and the filaments/fibres individually wetted) it may be desirable that there is a minimum net thickness of resin coating on a substantially portion of the fibres in the composite in order for the majority of crazes to be stabilized before they reach a fibre surface. In certain embodiments the volume fraction lies between 8% and 18% by volume for fibres in certain VSFPLCs.

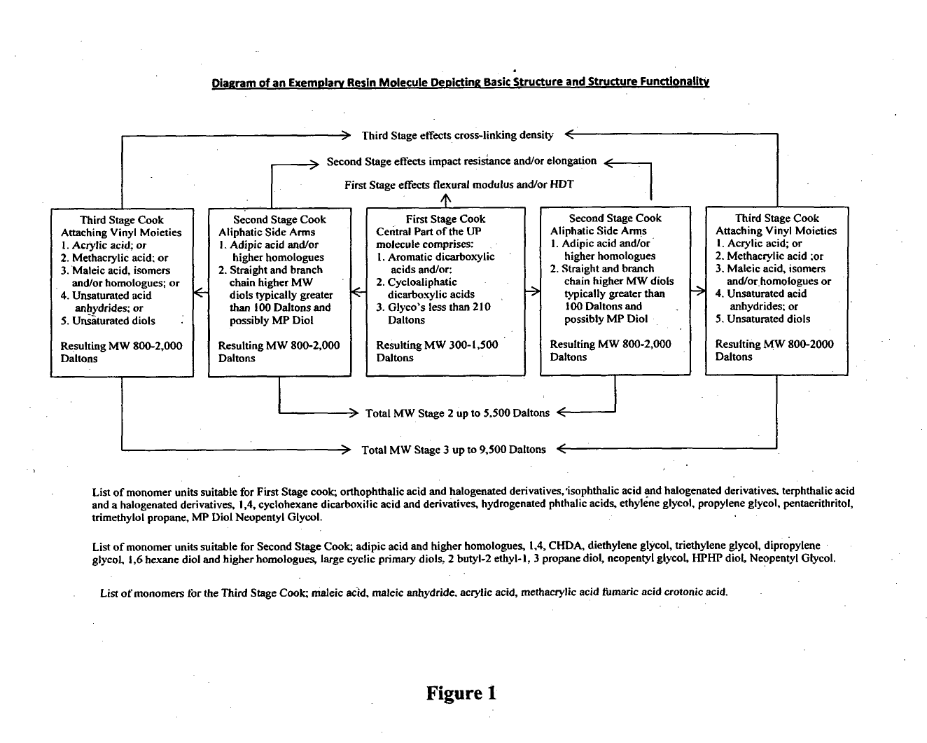

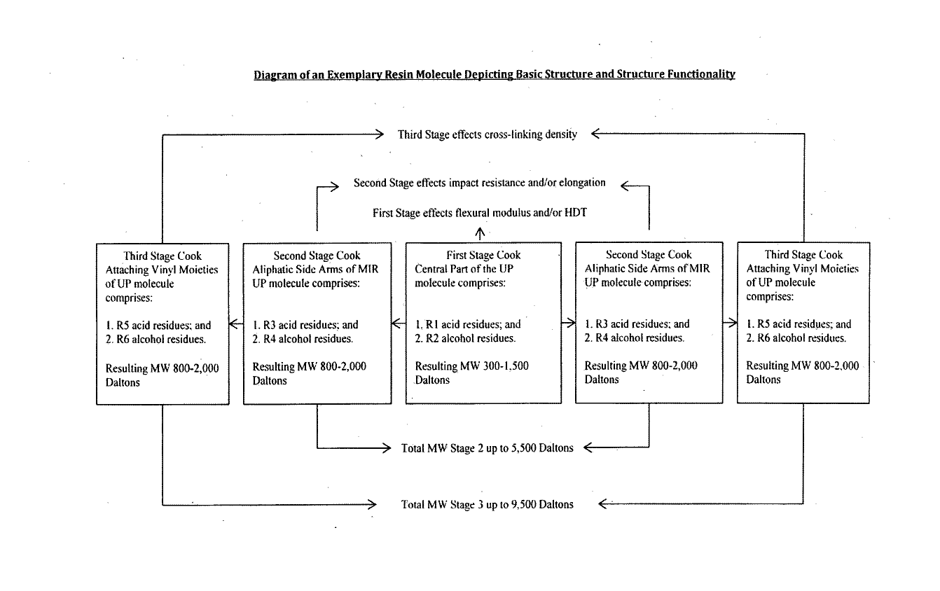

FIG. 1 provides a diagram of specific types of molecular structures which may be used to produce unsaturated polyesters with desired properties, according to certain disclosed embodiments. See also FIG. 13. As illustrated, these resins may be cooked in a reactor under nitrogen in a three, or four stage cook, according to certain embodiments. It is also possible to use 1, 2, 3, or 4 stages (In a 4 stage cook the unsaturated moieties may be removed from the 3^{rd} stage into the 4^{th} stage). In certain embodiments, it is possible to use 3 or 4 stage cooks with polyesters. In these embodiments, care is taken during the cooking process to position, glycols, saturated acids, and unsaturated acids at particular positions in the growing polymer chain. These polyester resins are made from combinations of one or more of the following: orthophthalic acid, isophthalic acid and esters, terephthalic acid and esters, cyclohexane dicarboxilic acid, adipic acid, malaic acid fumaric acid, acrylic acid, methacrylic acid, ethylene glycol, diethylene glycol, propylene glycol, dipropylene glycol, MP diol, HPHP diol, CHDM, pentarithritol, pendant allyl alcohols and diols, bisphenol, bisphynol epoxies, aliphatic epoxies, and/or cycloaliphatic epoxies. FIG. 1 describes a three stage UP resin cook. The first stage effects, partially controls, or controls flex modulus and/or HDT. The second stage effects, partially impacts, or imparts impact resistance and/or toughness. And the third stage effects, partially controls, or controls cross-linking density as the UP resin cures.

In certain embodiments, it is possible to do a 1 or 2 stage cook with vinyl esters.

Vinyl functional monomers may be added during the cooling process when the cook is substantially completed to adjust viscosity and/or assist in the crosslinking reactions during final curing. The choice and quantity of reactive diluents may affect the properties of the cured resin. The reactive diluents may be selected from the following representative of classes of vinyl functional monomers or combinations thereof: Styrene, Alpha Methyl Styrene, methylmethacrylate monomer, ethylene glycol dimethacrylate, diethylene glycol dimethacrylate, 1,6 hexanediol dimethacrylate, polyethylene glycol dimethacrylate, TMP trimethacrylate, ethoxylated bisphenol a dimethacrylate, CN9101 Aliphatic allyl oligomer, isodecyl methacrylate, lauryl methacrylate, 2 phenoxy ethyl acrylate, isobornyl acrylate, polyethylene glycol monomethacrylate, propoxylated NPG diacrylate or combinations thereof. Other reactive diluents may also be used.

The following Sartomer acrylates and methacrylates can be used to toughen UP and VE resins: SR242, SR257, SR313, SR324, SR335, SR339, SR340, SR379, SR423, SR495, SR506. Typical additions are between 2% and 10%.

The following Sartomer acrylates and methacrylates can also be used to increase the HDT of UP and VE resins: SR206, SR209, SR238, SR247, SR268, CD540, CD541, SR350, SR351, SR444. These acrylates and methacrylates can be used separately or in combinations. Typical additions are between 2 and 10%. For example a 2% addition of TMPTA increases the HDT of certain resins, for example, MIRteq's MIR100 resin from 51° C. to 62° C.

In certain embodiments, a polyester resin may be suitable for a closed moulding. The resin may used as a general purpose resin or as vinyl ester resin. For example, the suitable resin may include, but is not limited to, one or more of the following characteristics: a flexural strength of at least 100 MPa; a flexural elongation of between 6% and 15%; a flexural modulus of at least 2.9 GPa; a tensile strength of about 30 to 110 MPa; a tensile elongation of about 6 to 15%; a tensile modulus of less than 3 GPa; and/or a HDT of 50 to 150° C.

In certain embodiments, the synthesis and preparation of unsaturated polyesters may be a combination of cooking a particular unsaturated polyester at two activities, i.e., with a ratio of saturated to unsaturated acids; 0.9:1 and 3:2 and blending these to produce a base resin of desired properties, then adding to this base resin an oligomer or polymer or combinations to further modify properties. If amide thixatropes are used in VSFPLC formulations they are sheared into the resin at this stage taking care that the mixing temperature does not exceed 25° C.

Certain embodiments are directed to processes for combining fibres and resins as disclosed herein wherein mixing is carried out with air release agents to minimize entrapped air. The resin-fibre mixture is then subjected to a vacuum of 28 to 29 inches of mercury to remove residual air. In addition, the resin-fibre mixture may include adding promoters such as cobalt octoate, cobalt naphthenate, potassium octoate, calcium octoate, zinc octoate, zirconium octoate, copper naphthenate, dimethyl aniline, diethyl aniline, acetyl acetone or combinations thereof. For example, these can be added singularly or in combination to the VSFPLCs in concentrations at least 0.01%, 0.03%, 0.05%, 0.07%, 0.1%, 0.2%, 0.3%, 0.4%, 0.5%, 0.6%, 0.7%, 0.8%, 0.9%, 1%, 1.2%, 1.4%, or 2% calculated on the total resin, oligomers and monomer content.

Certain embodiments are directed to processes for combining fibres and resins as disclosed herein wherein the short fibre mixture or VSFPLCs mixture includes promoters such as cobalt octoate, cobalt naphthenate, potassium octoate, calcium octoate, zinc octoate, zirconium octoate, copper naphthenate, dimethyl aniline, diethyl aniline, acetyl acetone. These can be added singularly, or in combination, to the short fibre mixture, or VSFPLCs mixture, in concentrations 0.01%, 0.03%, 0.05%, 0.07%, 0.1%, 0.2%, 0.3%, 0.4%, 0.5%, 0.6%, 0.7%, 0.8%, 0.9%, 1%, 1.2% 1.4%, or 2% calculated on the total resin, oligomers and monomer content. Certain embodiments are directed to products comprising short fibres VSFPLCs mixture wherein the product also comprises promoters such as cobalt octoate, cobalt naphthenate, potassium octoate, calcium octoate, zinc octoate, zirconium octoate, copper naphthenate, dimethyl aniline, diethyl aniline, acetyl acetone, or combinations thereof in concentrations of 0.01%, 0.03%, 0.05%, 0.07%, 0.1%, 0.2%, 0.3%, 0.4%, 0.5%, 0.6%, 0.7%, 0.8%, 0.9%, 1%, 1.2%, 1.4%, or 2% calculated on the total resin, oligomers and monomer content.

Certain embodiments are directed to processes for combining fibres and resins as disclosed herein wherein, at least one thixatrope is added to the mixture. Certain embodiments are directed to products comprising combining fibres and resins wherein the product also comprises at least one added thixatrope. These thixatropes may be chosen, for example, from surface modified clays, amide thixatropes, modified urea based thixatropes, hydrogenated caster oils, fumed silica thixatropes, surface coated fumed silica thixatropes, or combinations thereof. Thixatropes may be at one of the following weight percentages: 0.3%, 0.4%, 0.5%, 0.6%, 0.7%, 0.8%, 0.9%, 1%, 1.2%, 1.4%, 1.6%, 1.8%, 2%, 2.4%, 2.8%, 3%, 3.5%, 4%, 4.5%, 5%, 5.5%, 6%, 7%, 8%, 9% or 10% calculated on the total resin, oligomers and monomer content, depending on the requirements of the formulation. In certain embodiments, thixatropes may be at one of the following weight percentages: at least 0.3%, at least 0.7%, at least 1%, at least 1.6%, at least 2%, at least 4%, at least 8%, or at least 10% calculated on the total resin, oligomers and monomer content. Certain embodiments are directed to processes for combining fibres and resins as disclosed herein wherein the short fibre mixture or VSFPLCs mixture comprises: at least one promoter selected from cobalt octoate, cobalt naphthenate, potassium octoate, calcium octoate, zinc octoate, zirconium octoate, copper naphthenate, dimethyl aniline, diethyl aniline, acetyl acetone, or combinations thereof in concentrations 0.01%, 0.05%, 0.07%, 0.1%, 0.3%, 0.4%, 0.6%, 0.9%, 1%, 1.2%, 1.4%, or 2%; and at least one thixatrope selected from surface modified clays, amide thixatropes, hydrogenated caster oils, fumed silica thixatropes, modified urea based thixatrope, and surface coated fumed silica thixatropes or combinations thereof at one of the following weight percentages 0.3%, 0.4%, 0.5%, 0.6%, 0.7%, 0.8%, 0.9%, 1%, 1.2%, 1.4%, 1.6%, 1.8%, 2%, 2.4%, 2.8%, 3%, 3.5%, 4%, 4.5%, 5%, 5.5%, 6%, 7%, 8%, 9%, 10%. Certain embodiments are directed to products comprising fibres and resins wherein the product also contains at least one promoter and at least one thixatrope.

Certain embodiments are directed to processes for combining fibres and resins as disclosed herein wherein the short fibre mixture or VSFPLCs mixture further comprises at least one added air release agent. Air release agents may be added at the following weight percentage calculated on total resin, oligomers and monomer content: 0.5%, 0.75%, 1%, 1.25%, 1.5%, 2%, 2.5%, 3%, or 4%. Various commercially available air release agents may be used. In some aspects air release agents that are suitable for use in high molecular weight alkyd formulations such as BYK A500, BYK A515, BYK A555, Bevaloid 6420, or Swancor 1317, EFKA 20 or equivalents of the aforementioned air release agents manufactured by other companies may be used.

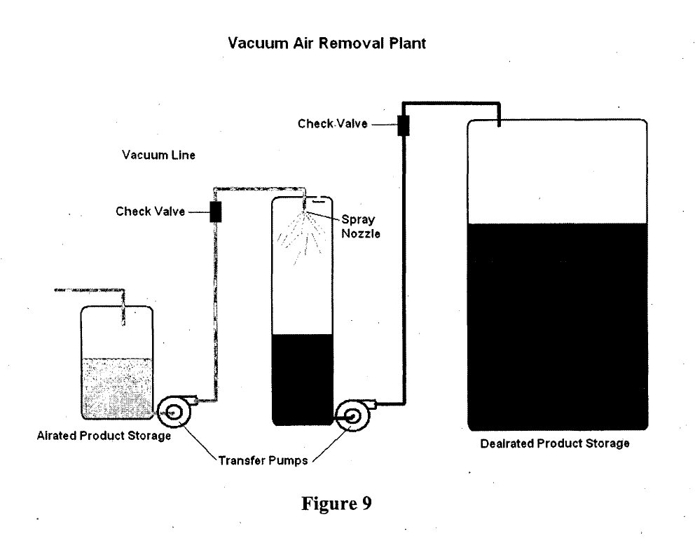

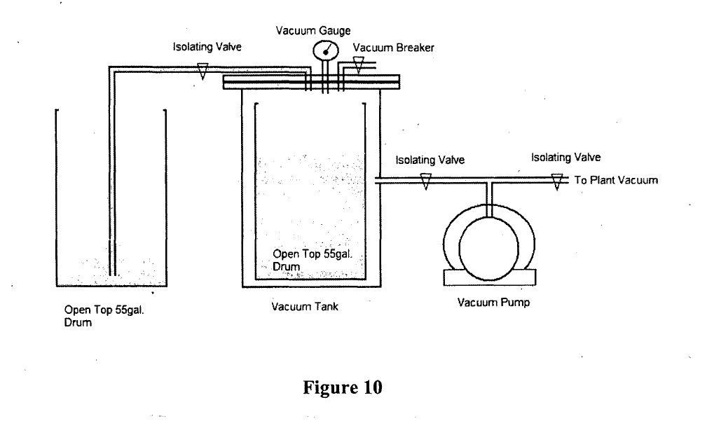

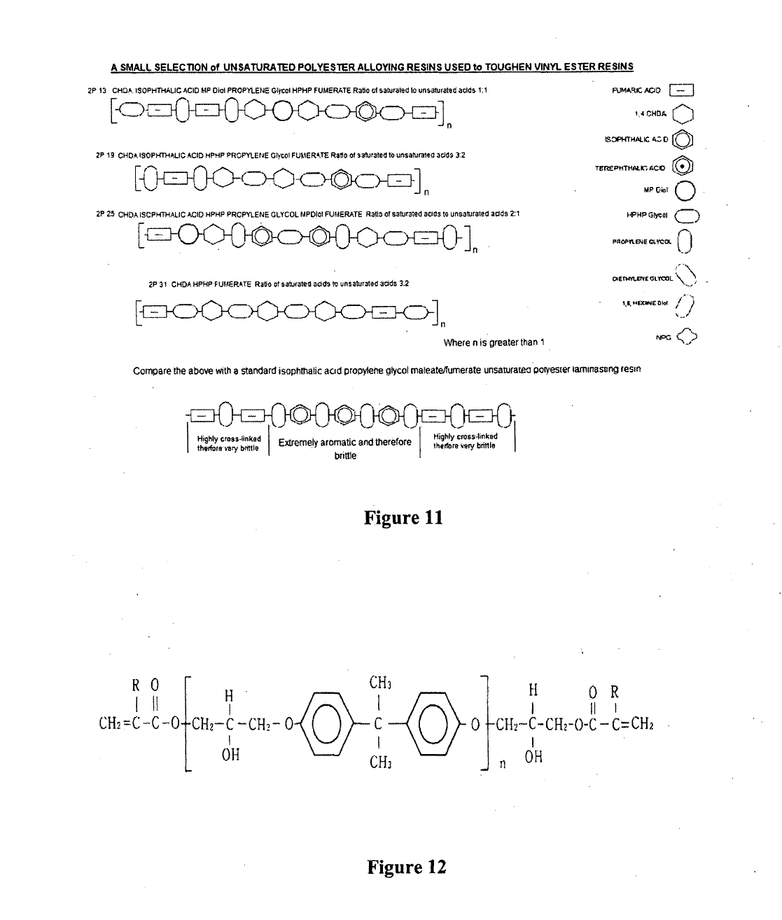

Certain embodiments are directed to processes for combining fibres and resins as disclosed herein, further comprising a process for removing air from the formulation. For example, this may be done under 28″ to 29″ of Hg vacuum in an air removal plant depicted in FIG. 9. FIG. 10 is a schematic illustration of another vacuum air removal process, according to certain embodiments.

Certain embodiments are directed to processes for combining fibres and resins as disclosed herein wherein the short fibre mixture or VSFPLCs mixture further comprises adding at least one HALS (Hindered Amine Light Stabilizer) and/or hindered phenols to moderate free radical reactions. The HALS and/or hindered phenols may be added in the range 0.01 to 0.1%. Examples of HALS and/or hindered phonels that may be used include: HQ, MEHQ, TBHQ, TBC, TBA, etc., or combinations thereof. In some aspects, the HALS and/or hindered phenols may be selected from various high molecular weight hindered amine light stabilizers, the choice depending on the VSFPLC formulation, and its end use.

Certain embodiments are directed to processes wherein at least one initiator is used. For example, the at least one initiators may be selected from: low molecular weight MEKP, medium molecular weight MEKP, high molecular weight MEKP, cumene hydroperoxide, cyclohexanone peroxide, BPO, or mixtures of these initiators in order to initiating a curing reaction. Initiators are usually added in the range 1 to 3% calculated on the total weight of monomer, oligomers and polymer present in the formulation, the temperature of the VSFPLC at the time of adding the initiator and/or the gel time required.

Certain embodiments are directed to processes for combining fibres and resins as disclosed herein wherein the process further comprises placing the short fibre formulation and/or the VSFPLC formulation into or onto moulds so that when the formulation cures it produces a solid moulded item.

Certain embodiments are directed to processes for combining fibres and resins as disclosed herein wherein the short fibre mixture or VSFPLCs mixture further comprises adding at least one pigment paste to the formulation. Pigment paste may be added at 1% of formulation weight up to 20% of formulation weight. In certain embodiments, the amount may further vary because some mineral fillers may be considered part of the pigment paste formulation.

Certain embodiments are directed to processes for combining fibres and resins as disclosed herein wherein the short fibre mixture or VSFPLC mixture further comprises adding at least one initiator selected from: low molecular weight MEKP, medium molecular weight MEKP, high molecular weight MEKP, cumene hydroperoxide, cyclohexanone peroxide, BPO, or mixtures of these initiators in order to initiating a curing reaction and adding at least one pigment paste to the formulation. Initiators may be added in the range of 1 to 3% calculated on the total weight of monomer, oligomers and polymer present in the formulation, the temperature of the VSFPLC at the time of adding the initiator and/or the gel time required. Furthermore, these formulations may be placed into, or onto moulds so that when the formulation cures it produces a solid moulded item.

Certain embodiments are directed to processes for combining fibres and resins as disclosed herein wherein the short fibre mixture or VSFPLCs mixture further comprises adding at least one mineral filler to the formulation. Mineral fillers can be added separately or in combination. In some aspects the fillers may be added in the range 5 to 25% of the total formula weight, depending on the application required.

Certain embodiments are directed to processes for combining fibres and resins as disclosed herein wherein the process further comprises removing the catalytic effect of the surfaces of fumed silica thixatrope by treating these thixatropes with a resin-monomer-water emulsion. For example, this may be made by adding a small amount of water to a resin solution and then emulsifying the mixture. This may be the same emulsion which may be used to passivate the VSFPLC fibre surfaces as disclosed herein.

### Formulations for Production of Test Panels

In exemplary formulations, the formulated vinyl ester resins were cured in clear cast and contained no thixatrope. They were promoted using 0.3% of a 6% solution of cobalt octoate, and 0.1% of 100% DMA. These were initiated with 2.2% high molecular weight MEKP. The temperature of the components and the test space was always 25° C. plus/minus 0.5° C. The clear cast polyester panels were promoted with 0.5% of a 6% solution of cobalt octoate with 0.3% of a 10% solution of potassium octoate. The polyester formulations were catalyzed with 2.2% medium reactivity MEKP against test conditions and were held at 25° C. The resins containing VSFPLC fibres were all thixed with BYK 410 modified polyurea thixatrope.

### Resin and Oligomer Synthesis

The exemplary resin and oligomer synthesis were carried out in a 3 litre glass reactor. The reactor is able to reach 235° C. It is very efficiently lagged and has melt temperature condenser inlet temperature and condenser outlet temperature monitoring. It has not as yet been modified to allow for vacuum stripping of unreacted volatiles. The samples were held in a vacuum at 29″ Hg and 30° C. for 30 minutes prior to testing.

Table 3 below lists exemplary resins to illustrate the type of molecular engineering used to produce suitably tough resins for use in VSFPLC formulations.

Table 3 of Cooks to Date

| | COOK | CELSIUS | |
|---|---|---|---|
| OLIGOMERS | TIME | TEMPERATURE | COOK COMMENTS |
| 2HPHP1,4,CHDA | 3 hours | 1^{st} stage 180° C.-200° C. | Residual Acrylic Acid |
| Diacrylate | 2 hours | 2^{nd} stage 130° C.-140° C. | Cook ok |
| HPHP Diacrylate | 2 hours | 1st stage 115° C.-119° C. | Cook had to be stopped and |
| | 2 hours | 2^{nd} stage 120° C.-130° C. | restarted due to polyacrylic acid |
| | | | buildup. Residual acrylic acid |
| 2HPHP Terephthalic | 3.5 hours | 1^{st} stage 150° C.-234° C. | As above |
| Acid Diacrylate | 3 hours | 2^{nd} stage 130° C.-154° C. | |
| 2CHDM CHDA | 1.5 hours | 1^{st} stage 140° C.-188° C. | As above |
| Diacrylate | 2 hours | 2^{nd} state 120° C.-151° C. | |
| POLYMERS | | | |
| Saturated/Unsaturated | COOK | TEMPERATURE | |
| Ratio | TIME | CELSIUS | COOK COMMENTS |
| CHDA PTA HPHP | 4 hours | 1^{st} stage 220° C.-240° C. | Good cook resin - too flexible |
| CHDM | 3 hours | 2^{nd} stage 180° C.-220° C. | |
| Fumarate 2:1 | | | |
| CHDA PIA HPHP PG | 2.5 hours | 1^{st} stage 170° C.-258° C. | Good cook but ratio of saturated |
| Fumarate 2:1 | 4 hours | 2^{nd} stage 160° C.-228° C. | acids to unsaturated acids too low. |
| | | | Masks contribution of backbone |
| | | | moieties. High acid No. |
| CHDA PIA MP DIOL | 4 hours | 1^{st} stage 180° C.-237° C. | As above high acid No. |
| PG HPHP | 1.5 hours | 2^{nd} stage 180° C.-220° C. | |
| Fumarate 1:1 | 3 hours | 3^{rd} stage 180° C.-232° C. | |
| CHDA PIA PG MP | <3 hours | 1^{st} stage 170° C.-220° C. | Acid not too high |
| DIOL HPHP | <2 hours | 2^{nd} stage 171° C.-205° C. | |
| Fumarate 3:2 | 3.5 hours | 3^{rd} stage 177° C.-233° C. | |
| Acid number <20 KOH/g | 3 hours | 1^{st} stage 180° C.-231° C. | 3 stage cook. |
| | 4.5 hours | 2^{nd} stage 180° C.-256° C. | Stage 1 PIA PG HPHP |
| | 1.5 hours | 3^{rd} stage 180° C.-224° C. | Stage 2 CHDA HPHP PG |
| | | | Stage 3 Fumaric acid MP Diol |
| HPHP CHDA Fumarate | 1.5 hours | 1^{st} stage 159° C.-166° C. | Acid No <20 |
| 2:1 | 3 hours | 2^{nd} stage 185° C.-224° C. | Very flexible |
| | | | Very slow reactivity |
| | | | Makes good additive 15% or < |
| Terephthalic acid NPG | 4 hours | 1^{st} stage 180° C.-236° C. | Acid No <20 mg KOH/g. |
| MPDiol Fumarate | 3 hours | 2^{nd} stage 160° C.-228° C. | Very stiff, and very reactive |
| PTA Hexane Diol | 4 hours | 1^{st} stage 170° C.-238° C. | Gelled, would not accept styrene |
| Fumarate 3:2 | 4 hours | 2^{nd} stage 170° C.-217° C. Very | below 100° C., sieved to remove gel |
| | | slow cooling | Stored as a paste in styrene and |
| | | | disperses well in resins |
| CHDA NPG PG | 4 hours | 160° C.-230° C. | Acid Value 12 mg KOH/g. |
| Fumarate 3:2 | | | |
| PTA NPG PG Fumarate | 6 hours | 1.90° C.-250° C. | Acid Value 2.9 mg KOH/g. |
| 3:2 | | | |
| CHDA DEG Fumarate | 7 hours | 160° C.-230° C. | Acid Value 12 mg KOH/g. |
| 3:2 | | | |
| PTA DEG Fumarate 3:2 | 6.5 hours | 190° C.-250° C. | Acid Value <25 mg KOH/g. |

Table 4 below is a summary of physical strength data for certain exemplary UP resins used in certain VSFPLC formulations. As can be seen from the data, the formulations when cured have flexural moduluses less than 3 GPa for clear casts, and less than 4.5 GPa for fibre filled VSFPLC laminates. These formulations exhibited excellent impact toughness.

Table 4: Summary of Physical Strength Data for a Selection of UP Resins Used in VSFPLC Formulations.

TABLE 4

| RESIN | | | |
|---|---|---|---|
| Weight: 70% Resin and 30% | FLEXURAL | | TENSILE |
| Treated Fibres | STRENGTH | MODULUS | STRENGTH |
| Momentum 411-350 | 114 MPa | 2.5 GPa | 71 MPa |
| Momentum 411-350 modified | 125 MPa | 2.7 GPa | 66 MPa |
| with 20% blend chda chdm/ | | | |
| tere HPHP diacrylates | | | |
| SWANCOR CHEMPULSE | 133 MPa | 3 GPa | 84 MPa |
| CHEMPULSE modified with | 135 MPa | 2.7 GPa | 85 MPa |
| 15% HPHP - chda diacrylate | | | |
| CHEMPULSE modified with | 141 MPa | 2.9 GPa | 89 MPa |
| 15% blend chda chdm/tere | | | |
| HPHP diacrylates | | | |
| CHEMPULSE Terephthalic | 133 MPa | 2.9 GPa | 85 MPa |
| acid DEG Fumerate with | | | |
| 15% blend chda chdm/tere | | | |
| HPHP diacrylates | | | |
| Terephthalic acid NPG | 130 MPa | 2.8 GPa | 87 Pa |
| MP Diol fumarate | | | |

As discussed herein, many of the commercially available VE and UP resins do not have the desired resistance to crack propagation. The most common strategies for making UP resins more impact resistant, and increasing their tensile elongations are:

1. Adding a saturated dicarboxilic acid such as adiptic acid to reduce aromaticity;
2. Reducing the proportion of unsaturated acids in the formula;
3. Using high molecular weight and/or branched diols in the formula; and/or
4. Adding a plasticizer such as a phthalic acid or adiptic acid esters, or combinations thereof.

These approaches, on their own, or in concert, produce UP resins with low mechanical strength, and low HDTs. As disclosed herein, in certain embodiments, the properties of VSFPLCs may be dependent on the properties of the bulk resin, the known approaches for improving tensile elongation and impact resistance of UP resins therefore may not be appropriate for VSFPLC formulations.

The present disclosure provides resins and methods for producing resins that have the needed toughness, and/or resistance to crack propagation. In certain embodiments, the disclosed resins create a balance between aromatic and cycloaliphatic structures to modify molecular interactions and crystalinity. The present disclosure also discloses using blends of long and short chain diols, branched or non-branched to reduce crystalinity and other molecular associations.

On top of the selection of molecular building blocks, the esterification reactions are carried out in two or preferably three or more stages to position moieties at specific locations in the growing polyester. The end result being tailor made UP resins with specific molecular structures. These UP resins are blended to obtain UP resin formulations with desirable properties. One of the aims in the development of these resins is to produce cured composites which inhibit crack propagation by stabilizing the craze zone ahead of the “propagating” crack. These resins can be further modified with polyester acrylates and or methacrylates. Certain embodiments, disclose resins that are tough and/or resist crack propagation and have flexural strengths between 75 MPa and 120 MPa.

Table 3 lists a small sample of exemplary resins to illustrate the type of molecular engineering necessary to produce suitably tough resins for use in certain VSFPLC formulations.

Commercially available UP resins have vinyl groups randomly positioned throughout the molecule.

No resin currently sold in the market is optimized to deliver the desired combination of properties. The resin backbone needs to be constructed/synthesized in ways to express the desired properties of all the subgroups in the molecules.

A single stage cook guarantees that the unsaturated moieties (vinyl groups) will be randomly distributed in the molecule adversely affecting properties. Two stage cooks are a better option but they limit the distance apart of the vinyl groups. Also vinyl groups are not necessarily positioned at the ends of the molecule but randomly scattered through the second stage. This leads to reduce expression of the contribution of the building blocks in the resin not associated with crosslinking. Two stage cooked resins are may be acceptable for blending resins but may not be desirable for certain applications. Two stage cooks have to, by their very nature, sacrifice HDT for elongation. This is not desirable for a VSFPLC. In two stage cooks we have to increase the ratio of saturated to unsaturated acids to achieve a given elongation.

This leads to a lower HDT for a given elongation. A slight improvement in HDT can be achieved with these resins by adding a small percentage of polyfunctional alcohol in the second stage esterification and by incorporating small quantities of di, tri, and tetra functional vinyl monomers in the monomer mix during the “let down” process when functional monomers are added to the polyester.

With respect to three stage cooks, disclosed herein resin structures require a multi stage esterification. This may be broken down to high and low HDT variants (high HDT is greater than 70° C. and low HDT is less than 70° C.) The high HDTS may have a central core dominated by aromatic compounds and other cyclic compounds. Low HDT variants may have a low aromatic content in the growing polyester.

Disclosed in FIG. 1 and in FIG. 13 are exemplary ways to create suitable UP resins for use with certain VSFPLCs. One of the aims in synthesizing these exemplary resins is to maximize HDT and achieve tensile elongations greater than 7%. Other tensile elongations may be used as disclosed herein. Stage 1. In Stage 1 the aromatic and cycloaliphatic dicarboxilic acids are esterified with low molecular weight glycols such as ethylene glycol, propylene glycol, MP Diol, or NPG, or combinations thereof. The presence of these structures add stiffness to the growing polyester. For steric reasons it is desired that these structures are in the centre of the growing polyester. The higher the molecular weight of the first stage polyester the stiffer and the higher the HDT of the resulting unsaturated polyester all other stages being equal. The melt temperature during the first stage firstly stabilizes at 160 to 175° C. for the first order polymerisation reaction to complete, then the temperature climbs to 190 to 210° C. for completion of the second order reactions then the reactor is heated to 225° C. until back end temperature starts to fall. The power is then switched off and the flow of sparging gas is increased to strip out the last of the water and other volatiles and build a little more molecular weight.

Stage 2. When the melt temperature drops below 180° C. the second stage reactor charge is added and the heating procedure is repeated. As previously mentioned this stage is dominated by strait and branched structures as these impart resilience, elongation and toughness.

Stage 3. Care is taken to add TBHQ at approximately 0.13% of the estimated melt weight to prevent gelling during the third stage cook. The last of the reactants are now added to the melt including the chemicals that contain the unsaturated moieties. The esterification is continued until the Acid Value of the melt drops below 20 mg/g KOH. The nitrogen sparge is then increased, the aim being to strip out any residual volatiles during the cooling process. The melt is then rapidly cooled to about 120° C. The melt is then let down with the reactive monomer/monomers and rapidly cooled to room temperature. This process results in three useful outcomes. First, the aromatic/bulky moieties are in the centre of the polyester. Second, the moieties that supply elongation and resilience are substantially free from crosslinking and able express their property contributions. Third, the vinyl groups are positioned as sufficiently far apart allowing the rest of the molecule to contribute their properties to the UP unhindered by crosslinking. With respect to, high HDT variants these have a tight central core, and lower saturated to unsaturated acid ratios, i.e., 4:3, 5:4, 6:5, 7:6, and 1:1. They may also include a small percentage of TMP or penta erithritol to create some crosslinking of the growing polymer. Typically, these are effective when incorporated in the first stage of the cooking.

Stage 1 is where aromatic and cyclo aliphatic acids/glycols are used. The presence of these structures adds stiffness to the growing molecule. For steric reasons it desirable that these structures are in the center of the molecule. The higher the molecular weight of this first stage polymerization the stiffer the molecule all other things being equal. The more linear the structure of the growing molecule the stiffer the resultant molecule-again all other things being equal. As the percentage molecular weight of this first stage grows so does the stiffness increase and the HDT increases. It is a combination of structure and mole percentage that effects, partially controls or controls the influence of this portion of the polyester on the properties of the finished UP molecules. Below are some examples of three Stage cooks.

### Example 1

| | |
|---|---|
| CHDA PTA, HPHP, CHDH Fumerate | 2:1 |
| Tensile yield stress | 30 MPa |
| Tensile modulus | 1.4 GPa. |
| Tensile elongation | N/A |
| Flexural strength | 40 MPa |
| Flexural elongation | Did not break |
| HDT | N/A |

### Example 2

| | |
|---|---|
| CHDA, PTA, TMP, HPHP, CHDM Fumerate | 4:3 |
| Tensile stress @ yield | 60 MPa |
| Tensile modulus | 2.5 GPa |
| Tensile elongation | 8.8% |
| Flexural strength | 107 MPa |
| Flexural elongation | 12% |
| HDT | 63° C. |

Above demonstrates the effect of increasing the ratio of unsaturated acids.

### Example 3

| | |
|---|---|
| PIA, PG, TMP, HPHP, CHDA, DPG, Fumerate | 4:3 |
| Acid value | C: 15 mg KOH/g |
| Tensile strength | 59 MPa |
| Tensile elongation | 9% |
| Flexural strength | 80 MPa |
| Flexural elongation | Did not break |
| HDT | 62° C. |

### Example 4

| | |
|---|---|
| PIA, PTA, PG CHDA, DPG, Maleate | 4:3 |
| Acid value | C: 12 mg KOH/g |
| Tensile strength | 65 MPa |
| Tensile elongation | 5% |
| Flexural strength | 120 MPa |
| Flexural elongation | 8.5% |
| HDT | 71° C. |

The HDT of examples 2, 3, and 4 above are typically much higher than flexible resins available in the market today. This is partly due to a small 0.5 Molar addition of TMP in the primary cook and 2% TMPTA in the monomer package.

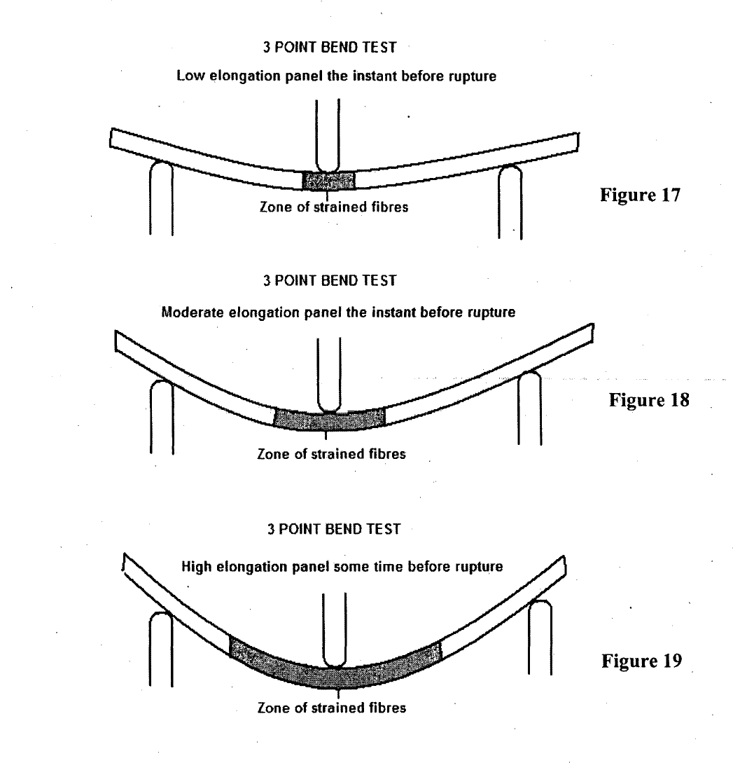

FIG. 17, FIG. 18 and FIG. 19 depict the volume of strained fibres for a brittle panel versus less brittle panels. FIG. 17 illustrates a low elongation panel the instance before rupture. It is estimated that for this brittle panel there are approximately 1,500 fibres bearing load. FIG. 18 illustrates a moderate elongation panel the instance before rupture. It is estimated that for this panel there are approximately 4,150 fibres bearing load, which is far stronger than the 1,500 fibre panel. FIG. 19 illustrates a high elongation panel the instance before rupture. It is estimated that for this panel there are approximately 6,090 fibres bearing load. These Figures confirm that the 6,090 fibre panel carries more load than the 4,150 fibre panel and significantly more load than 1,500 fibre panel. The more resilient the matrix resin is the more fibres are implicated in bearing the load as the panel deflects more and more. This is why in certain VSFPLCs it is desirable to use resins with high elongation. The stiffer the resin, the more load is required to deflect a panel a given distance. Certain VSFPLCs require as high a flexural modulus resilient resin as it can utilize. Such resins are not available because they are not required for composites whose mean fibre length is many times the critical fibre length.

In certain embodiments, it is possible to blend existing commercial resins to create resin blends that have suitable properties for use in the formulation of certain VSFPLCs. Below are some examples of blended resins that are suitable for use with certain VSFPLCs.

Table 5 Blends of Resilient Unsaturated Polyester Resins With Vinyl Ester Resins.

TABLE 5

| Resin | | | | | |
|---|---|---|---|---|---|
| Weight | Name | Name | Name | | Blend Properties |
| Proportion | of | of | of | Name of | Flex Strength MPa |
| Resins | Resins | Resins | Resins | Resins | Flex Elongation % |
| 70/30 | F010/ | F013/ | F010/ | F013/1508 | 90-112 MPa |
| | 0922 | 0922 | 1508 | | 8%-9% |
| 69/31 | F010/ | F013/ | F010/ | F013/1508 | 85-112 MPa |
| | 0922 | 0922 | 1508 | | 8%-9% |
| 68/32 | F010/ | F013/ | F010/ | F013/1508 | 80-108 MPa |
| | 0922 | 0922 | 1508 | | 8%-11% |
| 67/33 | F010/ | F013/ | F010/ | F013/1508 | 75-102 MPa |
| | 0922 | 0922 | 1508 | | 8%-11% |
| 66/34 | F010/ | F013/ | F010/ | F013/1508 | 70-87 MPa |
| | 0922 | 0922 | 1508 | | 8.5%-12% |
| 65/35 | F010/ | F013/ | F010/ | F013/1508 | 70-86 MPa |
| | 0922 | 0922 | 1508 | | 9.5%-12% |
| 64/36 | F010/ | F013/ | F010/ | F013/1508 | 65-85 MPa |
| | 0922 | 0922 | 1508 | | 10%-12.5% |
| 63/37 | F010/ | F013/ | F010/ | F013/1508 | 63-85 MPa |
| | 0922 | 0922 | 1508 | | 10%-12.5% |
| 62/38 | F010/ | F013/ | F010/ | F013/1508 | 62-83 MPa |
| | 0922 | 0922 | 1508 | | 10%-12.5% |
| 61/39 | F010/ | F013/ | F010/ | F013/1508 | 62-83 MPa |
| | 0922 | 0922 | 1508 | | 10%->12.5% |
| 60/40 | F010/ | F013/ | F010/ | F013/1508 | 55-76 MPa |
| | 0922 | 0922 | 1508 | | >12.5% |

In table 5, Resin F010 is Vipel® F010 which is available from AOC, East Collierville, Tenn., USA, and is a bisphenol A epoxy-based vinyl ester resin dissolved in styrene. Resin 0922 is STYPOL 040-0922 which is available from Cook Composites and Polymers, Kansas City, Mo. Resin F013 is Vipel® F013 which available from AOC, East Collierville, Tenn., USA, and is bisphenol A epoxy-based vinyl ester resin dissolved in styrene. Resin 1508 is a flexible unsaturated polyester resin made by Cray Valley, Paris, France.

Table 6. Blends of Resilient Unsaturated Polyester Resins With Vinyl Ester Resins.

TABLE 6

| Resin | | | | |
|---|---|---|---|---|
| Weight | | | | |
| Proportion | | | | |
| Resins | Name of Resins | Name of Resins | Name of Resins | Blend Properties |
| 70/30 | Dion 9800/1508 | Dion 9800/0922 | Dion 9800/ | Adequate elongation, |
| | | | Polylite 31830 | tough and low HDT |
| 69/31 | Dion 9800/1508 | Dion 9800/0922 | Dion 9800/ | Adequate elongation, |
| | | | Polylite 31830 | tough, low HDT |
| 68/32 | Dion 9800/1508 | Dion 9800/0922 | Dion 9800/ | Adequate elongation, |
| | | | Polylite 31830 | tough, low HDT |
| 67/33 | Dion 9800/1508 | Dion 9800/0922 | Dion 9800/ | Adequate elongation, |
| | | | Polylite 31830 | tough, low HDT |
| 66/34 | Dion 9800/1508 | Dion 9800/0922 | Dion 9800/ | Adequate elongation, |
| | | | Polylite 31830 | tough, low HDT |
| 65/35 | Dion 9800/1508 | Dion 9800/0922 | Dion 9800/ | Adequate elongation, |
| | | | Polylite 31830 | tough, low HDT |
| 64/36 | Dion 9800/1508 | Dion 9800/0922 | Dion 9800/ | Adequate elongation, |
| | | | Polylite 31830 | tough, low HDT |
| 63/37 | Dion 9800/1508 | Dion 9800/0922 | Dion 9800/ | Adequate elongation, |
| | | | Polylite 31830 | tough, low HDT |
| 62/38 | Dion 9800/1508 | Dion 9800/0922 | Dion 9800/ | Adequate elongation, |
| | | | Polylite 31830 | tough, low HDT |
| 61/39 | Dion 9800/1508 | Dion 9800/0922 | Dion 9800/ | Adequate elongation, |
| | | | Polylite 31830 | tough, low HDT |
| 60/40 | Dion 9800/1508 | Dion 9800/0922 | Dion 9800/ | Adequate elongation, |
| | | | Polylite 31830 | tough, low HDT |
| 58/42 | Dion 9800/1508 | Dion 9800/0922 | Dion 9800/ | Adequate elongation, |
| | | | Polylite 31830 | tough, low HDT |
| 56/44 | Dion 9800/1508 | Dion 9800/0922 | Dion 9800/ | Adequate elongation, |
| | | | Polylite 31830 | tough, low HDT |
| 54/46 | Dion 9800/1508 | Dion 9800/0922 | Dion 9800/ | Adequate elongation, |
| | | | Polylite 31830 | tough, low HDT |
| 52/48 | Dion 9800/1508 | Dion 9800/0922 | Dion 9800/ | Adequate elongation, |
| | | | Polylite 31830 | tough, low HDT |
| 50/50 | Dion 9800/1508 | Dion 9800/0922 | Dion 9800/ | Adequate elongation, |
| | | | Polylite 31830 | tough, low HDT |

In table 6, Dion 9800 is urethane modified vinyl ester resins available from Reichhold Industries, Inc.'s North Carolina, USA. Resin 1508 is a flexible unsaturated polyester resin made by Cray Valley, Paris France. Resin 0922 is STYPOL 040-0922 which is available from Cook Composites and Polymers, Kansas City, Mo. Resins Polylite 31830 is also known as POLYLITE® 31830-00 and is un-promoted, low reactive, low viscosity flexible, isophthalic acid modified unsaturated polyester resin dissolved in styrene available from Reichhold Industries, Inc.'s, North Carolina, USA.

Table 7. Blends of Vinyl Ester resins.

TABLE 7

| Resin Weight | | | |
|---|---|---|---|
| Proportion | | | |
| Resins | Name of Resins | Name of Resins | Blend Properties |
| 75/35 | Dion 9800/Dion 9600 | Dion 31038/Dion 9600 | Adequate elongation, |
| | | | tough and low HDT |
| 70/30 | Dion 9800/Dion 9600 | Dion 31038/Dion 9600 | Adequate elongation, |
| | | | tough and low HDT |
| 69/31 | Dion 9800/Dion 9600 | Dion 31038/Dion 9600 | Adequate elongation, |
| | | | tough, low HDT |
| 68/32 | Dion 9800/Dion 9600 | Dion 31038/Dion 9600 | Adequate elongation, |
| | | | tough, low HDT |
| 67/33 | Dion 9800/Dion 9600 | Dion 31038/Dion 9600 | Adequate elongation, |
| | | | tough, low HDT |
| 66/34 | Dion 9800/Dion 9600 | Dion 31038/Dion 9600 | Adequate elongation, |
| | | | tough, low HDT |
| 65/35 | Dion 9800/Dion 9600 | Dion 31038/Dion 9600 | Adequate elongation, |
| | | | tough, low HDT |
| 64/36 | Dion 9800/Dion 9600 | Dion 31038/Dion 9600 | Adequate elongation, |
| | | | tough, low HDT |
| 63/37 | Dion 9800/Dion 9600 | Dion 31038/Dion 9600 | Adequate elongation, |
| | | | tough, low HDT |
| 62/38 | Dion 9800/Dion 9600 | Dion 31038/Dion 9600 | Adequate elongation, |
| | | | tough, low HDT |
| 61/39 | Dion 9800/Dion 9600 | Dion 31038/Dion 9600 | Adequate elongation, |
| | | | tough, low HDT |
| 60/40 | Dion 9800/Dion 9600 | Dion 31038/Dion 9600 | Adequate elongation, |
| | | | tough, low HDT |
| 58/42 | Dion 9800/Dion 9600 | Dion 31038/Dion 9600 | Adequate elongation, |
| | | | tough, low HDT |
| 55/45 | Dion 9800/Dion 9600 | Dion 31038/Dion 9600 | Adequate elongation, |
| | | | tough, low HDT |

In Table 7, resin Dion 9800 is a urethane modified vinyl ester resin available from Reichhold Industries, Inc.'s North Carolina, USA. Resin Dion 9600 is a flexible, tough vinyl ester resin available from Reichhold Industries, Inc.'s North Carolina, USA. Resin Dion 31038 also know as Dion® 31038-00 is a urethane modified vinyl ester resin available from Reichhold Industries, Inc.'s North Carolina, USA.

Additional blends of vinyl ester resins may be produced according to certain embodiments, by blending Dion 9600 (which is a flexible, tough vinyl ester resin) with Dion 9400. The HDT of Dion 9600 is too low for many applications, however, blending a certain portion of Dion 9400 novolac vinyl ester resin with the Dion 9600 improves both yield stress and HDT. The resins can be blended in the following ratios 5% Dion 9400 in 95% Dion 9600, 10% Dion 9400 in 90% Dion 9600, 15% in Dion 9400 in 85% Dion 9600, or 20% in Dion 9400 in 80% Dion 9600. These blends retain adequate elongation with increasing HDT. Dion 9600 is a flexible, tough vinyl ester resin available from Reichhold Industries, Inc.'s North Carolina, USA. Dion® 9400 is a non-accelerated, novolac epoxy based vinyl ester resin available from Reichhold Industries, Inc.'s North Carolina, USA.

Using certain disclosed embodiments, the resins and/or resin-fibre composites disclosed herein can improve one or more of the following properties: tensile yield stress, tensile elongation, flexural elongation and/or toughness (Izod impact strength) by a minimum of 10% over known similar resin-fibre composites. In certain embodiments, these properties may be improved by at least 10%, 20%, 30%, 40% or 50% over known similar resin-fibre composites and sometimes as much as 35 to 50% for energy to rupture/failure.

As illustrated by this example Dion 9600 LC has the following properties flexural strength 81 MPa, flex elongation 5.8%, flexural modulus 3.1 GPa, and required 3.6 Joules to rupture a standard panel. Dion 9600+12% Dion 9400 flexural strength was 90 MPa, flex elongation was 6.9% flex modulus was 3.4 GPa and required 5.6 Joules to rupture a standard panel. This represented a 33% increase in elongation and 56% increase in the energy required to rupture a standard panel. Thus, blending off the shelf resins may improve the properties of resins for use in certain VSFPLCs, according to certain embodiments.

The molecular structure of unsaturated polyester and vinyl ester resins may determine certain properties of the cured resin. For example, with respect to vinyl ester resins as discussed herein, more particularly visphenol-A epoxy vinyl ester resins. However, this discussion may be also applicable to unsaturated polyester resins, acrylic resins, epoxy resins, urethane resins, or combinations thereof. When resins solidify either as a result of a curing reaction as in the case of thermosets or due to a dramatic lowering of temperature as in the case of thermoplastic resins adjacent molecules or associations. If these associations are strong and regular in parts of the molecular structure, then ‘zones of crystalinity’ may be formed. These zones of crystalinity contribute to the polymer becoming more rigid and/or stiff.

In certain embodiments, these zones may have varying degrees of distinctness. In certain embodiments, in order to attempt to influence certain properties the resin formula may be formulated to increase rigidity (i.e. crystalinity) and add plasticisers in sufficient quantities to give the desired bulk properties.

For example, certain plasticisers may be characterized as more reactive plasticers and less reactive plasticers.

In certain embodiments, unsaturated polyesters resins and/or vinyl ester resins may function as plasticers. In certain embodiments, adding very flexible unsaturated polyester resins and/or vinyl ester resins to much stiffer resins may result in more flexible resin mixtures.

In certain embodiments, resins whose molecular structure interferes with the ability of the base resin to form zones of crystalinity and/or strong intermolecular associations may be added to resin mixtures. These additives may not follow the Law of Mixtures and can have a profound effect on the properties of the resin blend when added, for example, in the range 3-15%. This may be described in general terms as alloying resins. Other ranges may also be used as disclosed herein.

### Example 5

Reichhold Dion 9600 plus 13% Dion 9400. This example is a good illustration of alloying as Dion 9400 is a novolac vinyl ester resin with a low elongation in its own right but when added at between 12-13 to Dion 9600 it significantly increases elongation and toughness of the resin when used in liquid composites.

Table 7. Displaying the Results of Adding Increasing Amounts of Dion 9400 to Dion 9600 in liquid composites.

TABLE 7

| | | | | Energy |
|---|---|---|---|---|
| | Flexural | Flex | Elongation | to |
| | Yield | Modulus | at | Break |
| Product/Resin | MPa | MPa | Break | Panel |
| Dion 9600 Neat | 81 | 3,100 | 5.8% | 3.63 J |
| Dion 9600 + 5% Dion 9400 | 77 | 3,100 | 7.1% | 4.73 J |
| Dion 9600 + 10% Dion 9400 | 92 | 3,500 | 5.9% | 4.4 J |
| Dion 9600 + 12% Dion 9400 | 90 | 3,400 | 6.9% | 5.58 J |
| (note the significant change | | | | |
| at or near a particular | | | | |
| concentration) | | | | |
| Dion 9600 + 13% Dion 9400 | 87 | 3,400 | 6.6% | 5.2 J |
| Dion 9600 + 15% Dion 9400 | 94 | 3,500 | 5.6% | 4.21 J |

### Example 6

Table 8 Depicting The Effect of Small Quantities of Tailor Made UP Resins Dissolved in Derakane 411/350 Bisphenol A Epoxy Vinyl Ester Resin.

TABLE 8

| | | | | Energy |
|---|---|---|---|---|
| | Flexural | Flex | Elongation | to |
| | Yield | Modulus | at | Break |
| Product/Resin | MPa | MPa | Break | Panel |
| Derakane 411/350 Neat | 115 | 3,050 | 7% | N/A |
| Clear Cast | | | | |
| Derkane 411/350 + 14% | 132 | 3,200 | >12% | N/A |
| PIA CHDA EG HPHP | | | | |
| Fumerate Clear Cast | | | | |
| Derakane 411/350 + 3% of a | 137 | 3,200 | 11.5% | |
| 50/50 blend of CHDA | | | | |
| CHDM Di Acrylate and | | | | |
| PTA HPHP Di Acrylate | | | | |
| Clear Cast | | | | |

In the following, further embodiments are explained with the help of subsequent examples.

### Example 7

A resin, comprising:

i) a first polyester segment, comprising one or more first dicarboxylic acid residues and one or more first diol residues;
ii) a second polyester segment, comprising one or more second dicarboxylic acid residues and one or more second diol residues; and
iii) a third polyester segment, comprising one or more third vinylic-containing acid residues, one or more saturated carboxylic acid residues and one or more third diol residues;
wherein:
a) the terminal ends of the first polyester segment are conjugated to the second polyester segments;
b) the second polyester segments, conjugated to the first polyester segment, are further conjugated to the third polyester segments; and
c) the resin, terminating with the third polyester segments, terminates with the one or more third vinylic-containing acid residues and/or the one or more third diol residues.

### Example 8

The resin of example 7, wherein the first polyester segment is centrally located within the resin.

### Example 9

The resin of any one of examples 7 to 8, wherein the first polyester segment comprises aromatic and/or bulky residues.

### Example 10

The resin of any one of examples 7 to 9, wherein the first polyester segment provides rigidity and/or comprises a high HDT for its elongation.

### Example 11

The resin of any one of examples 7 to 10, wherein the first polyester segment has a molecular weight in the range of between 300 to 1,500 Daltons.

### Example 12

The resin of any one of examples 7 to 11, wherein the one or more first dicarboxylic acid residues comprises one or more cyclic dicarboxylic acid residues.

### Example 13

The resin of any one of examples 7 to 12, wherein the one or more first dicarboxylic acid residues comprises cycloaliphatic dicarboxylic acid residues and/or aromatic dicarboxylic acid residues.

### Example 14

The resin of any one of examples 7 to 13, wherein the one or more first dicarboxylic acid residues comprises cycloaliphatic dicarboxylic acid residues.

### Example 15

The resin of any one of examples 7 to 14, wherein the one or more first dicarboxylic acid residues comprises one or more aromatic dicarboxylic acid residues.

### Example 16

The resin of any one of examples 7 to 15, wherein the one or more first diol residues comprises one or more glycol residues.

### Example 17

The resin of any one of examples 7 to 16, wherein the one or more first diol residues have a molecular weight of 210 Daltons or less.

### Example 18

The resin of any one of examples 7 to 17, wherein the first polyester segment comprises:

i) one or more cycloaliphatic dicarboxylic acid residues and/or aromatic dicarboxylic acid residues; and
ii) one or more glycol residues.

### Example 19

The resin of any one of examples 7 to 18, wherein first polymer segment further comprises a small percentage of a crosslinking agent, comprising TMP or penta erythritol, in the order of 1 to 5% on a weight basis.

### Example 20

The resin of any one of examples 7 to 19, wherein the second polyester segment provides elongation and resilience properties.

### Example 21

The resin of any one of examples 7 to 20, wherein the second polyester segment is substantially free from cross-linking.

### Example 22

The resin of any one of examples 7 to 21, wherein the second polyester segment has a molecular weight in the range of between 800 to 2,000 Daltons.

### Example 23

The resin of any one of examples 7 to 22, wherein the one or more second dicarboxylic acid residues comprises saturated dicarboxylic acid residues.

### Example 24

The resin of any one of examples 7 to 23, wherein the one or more second diol residues comprises straight and/or branched diols having a molecular weight of 85 Daltons or more.

### Example 25

The resin of any one of examples 7 to 24, wherein the second polyester segment comprises one or more saturated dicarboxylic acid residues and one or more diol residues having a molecular weight greater than 100 Daltons.

### Example 26

The resin of any one of examples 7 to 25, wherein the third polyester segment effects crosslinking density.

### Example 27

The resin of any one of examples 7 to 26, wherein the third polyester segment has a molecular weight in the range of between 800 to 2,000 Daltons.

### Example 28

The resin of any one of examples 7 to 27, wherein a portion of the resin is conjugated to at least one of fibre via a coupling agent residue.

### Example 29

The resin of example 28, wherein:

i) the plurality of the fibres conjugate to the resin via the coupling agent residue are non-catalytic;
ii) a substantial portion of the plurality of fibres that are conjugated to the resin via the coupling agent residue are non-catalytic; and/or
ii) an interphase between the at least one fibre of the plurality of fibres and the resin having substantially the same properties as the resin, wherein the substantially same properties are selected from one or more of the following: tensile modulus, tensile elongation; flexural modulus and/or flexural elongation.

### Example 30

the resin of any one of examples 7 to 29, wherein the coupling agent bonds to the surface of the fibre and bonds to the one or more third vinylic-containing acid residues segment via an oligomer bridge created by the reactive diluent in the resin formulation.

### Example 31

The resin of any one of examples 7 to 30, wherein the resin comprises a ratio of 0.9:1 to 3:2 of saturated to unsaturated acids.

### Example 32

The resin of any one of examples 7 to 31, wherein the resin comprises a ratio of 4:3 of saturated to unsaturated acids.

### Example 33

The resin of any one of examples 7 to 32, wherein the resin comprises a ratio of 5:4 of saturated to unsaturated acids.

### Example 34

The resin of any one of examples 7 to 33, wherein the resin comprises a ratio of 6:5 of saturated to unsaturated acids.

### Example 35

The resin of any one of examples 7 to 34, wherein the resin comprises a ratio of 7:6 of saturated to unsaturated acids.

### Example 36

The resin of any one of examples 7 to 35, wherein the resin comprises a ratio of 1:1 of saturated to unsaturated acids.

### Example 37

The resin of any one of examples 7 to 36, wherein the resin comprises a high HDT variant compared with commercially available resins with the same elongation.

### Example 38

The resin of any one of examples 7 to 37, wherein the resin comprises a low HDT variant.

### Example 39

The resin of any one of examples 7 to 38, wherein resin, or portion thereof, comprises one or more of the following properties:

i) a flexural modulus of between 1 to 7 GPa;
ii) a flexural strength of between 30 to 150 MPa;
iii) a flexural elongation at break of between 2. to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m²;
viii) a HDT of between 50 to 150° C.;
ix) exhibits increased resistance to crack propagation;
x) energy required to break a standard panel in flexure greater than or equal to 2.5 J; and/or
xi) is substantially isotropic.

### Example 40

The resin of any one of examples 7 to 39, wherein the resin comprises a structure represented by formula (I), (II), (III), or (IV):

R₂R₁-R₂ₚR₃R₄-R₃_{q}R₆R₅-R₆ᵣₙH (I)

R₂R₁-R₂ₚR₃R₄-R₃_{q}R₆R₅-R₆ᵣR₅ₙH (II)

R₁R₂-R₁ₚR₄R₃-R₄_{q}R₅R₆-R₅ᵣₙH (III)

R₁R₂-R₁ₚR₄R₃-R₄_{q}R₅R₆-R₅ᵣR₆ₙH (IV)

wherein:
i) R₁, R₃, and R₅ independently represent residues of one or more dicarboxylic acids;
ii) R₂, R₄, and R₆ independently represent residues of one or more diols;
iii) p independently represents an average value of 2-10;
iv) q independently represents an average value of 2-10;
v) r independently represents an average value of 0-10; and
vi) n independently represents an average value of 1-2.

### Example 41

The resin of any one of examples 7 to 40, wherein R1 independently represents residues of one or more carboxylic acids, comprising: an aromatic dicarboxylic acid; a cycloaliphatic dicarboxylic acid; orthophthalic acid; isophthalic acid; terephthalic acid; 1,4-cyclohexane dicarboxylic acid (1,4-CHDA); phthalic acid; hydrogenated phthalic acid; and/or derivatives or mixtures thereof; and

wherein the residues of the one or more carboxylic acids may be derived from an acid, ester, anhydride, acyl-halogen form, or mixtures thereof.

### Example 42

The resin of any one of examples 7 to 41, wherein R2 independently represents residues of one or more alcohols, comprising: ethylene glycol; propylene glycol; pentaerythritol; trimethylol propane; MP diol; neopentyl glycol; glycols having a molecular weight of 210 Daltons or less; and/or derivatives or mixtures thereof.

### Example 43

The resin of any one of examples 7 to 42, wherein R3 independently represents residues of one or more carboxylic acids, comprising: 1,4-CHDA; a C1-C24 saturated dicarboxylic acid; and/or derivatives or mixtures thereof; and

wherein the residues of the one or more carboxylic acids may be derived from an acid, ester, anhydride, acyl-halogen form, or mixtures thereof.

### Example 44

The resin of any one of examples 7 to 43, wherein the C1-C24 saturated dicarboxylic acid, comprises: succinic acid; glutaric acid; adipic acid; pimelic acid; suberic acid; azelaic acid; sebaic acid; and/or higher homologes.

### Example 45

The resin of any one of examples 7 to 44, wherein R4 independently represents residues of one or more alcohols, comprising: diethylene glycol; triethylene glycol; dipropylene glycol; pentaerythritol; 1,6-hexane diol, and higher homologes; large cyclic aliphatic diols; large cyclic aliphatic primary diols; 2-butyl-2-ethyl-1,3-propane diol; pendant allyl alcohols and diols; neopentyl glycol; HPHP Diol; aliphatic epoxies; cycloaliphatic epoxies; and/or derivatives or mixtures thereof.

### Example 46

The resin of any one of examples 7 to 45, wherein R5 independently represents residues of one or more carboxylic acids, comprising: an unsaturated acid; an unsaturated acid anhydride; and/or derivatives or mixtures thereof; and

wherein the residues of the one or more carboxylic acids may be derived from an acid, ester, anhydride, acyl-halogen form, or mixtures thereof.

### Example 47

The resin of any one of examples 7 to 46, wherein the unsaturated acid comprises a vinylic-containing acid.

### Example 48

The resin of any one of examples 7 to 47, wherein the vinylic-containing acid, comprises: maleic acid, fumaric acid, acrylic acid, methacrylic acid, crotonic acid, and/or higher homologes, isomers, or derivatives thereof.

### Example 49

The resin of any one of examples 7 to 48, wherein the unsaturated acid anhydride comprises a vinylic-containing anhydride.

### Example 50

The resin of any one of examples 7 to 49, wherein the vinylic-containing anhydride, comprises: maleic anhydride, succinic anhydride, and/or higher homologes, isomers, or derivatives thereof.

### Example 51

The resin of any one of examples 7 to 50, wherein R6 independently represents residues of one or more alcohols, comprising one or more saturated diols and optionally one or more unsaturated diols, wherein the diol comprises one or more degrees of unsaturation.

### Example 52

The resin of any one of examples 7 to 51, wherein the unsaturated diol comprises an unsaturated straight chain diol and/or an unsaturated branched chain diol.

### Example 53

A resin-fibre cured composite, comprising

A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and
C) a coupling agent composition, wherein the coupling agent composition is present between 0.5 to 5 wt. % of the weight of fibres in the composite; wherein:
a) the resin-fibre composite has one or more of the following properties:
i) a flexural strength of between 30 to 150 MPa;
ii) a tensile strength of between 20 to 110 MPa;
iii) an unnotched Izod impact strength of between 1.5 to 6 KJ/m²; and/or
iv) exhibits increased resistance to crack propagation;
b) the plurality of fibres have one or more of the following characteristics:
i) at least 85 wt. % of the plurality of fibres are less than 1 mm in length;
ii) a mean fibre length in the range between 200 to 700 microns; and/or
iii) a mean fibre diameter in the range of between 5 to 20 microns.

### Example 54

The resin-fibre composite of Example 53, wherein the fibre volume fraction is between 3 to 45% of the resin-fibre composite.

### Example 55

The resin-fibre composite of any one of Examples 53 to 54, wherein the resin-fibre composite has a flexural modulus of between 1 to 7 GPa.

### Example 56

The resin-fibre composite of any one of Examples 53, to 55, wherein the resin-fibre composite has a flexural elongation at break of between 2 to 20%.

### Example 57

The resin-fibre composite of any one of Examples 53 to 56, wherein the resin-fibre composite has a tensile modulus of between 1 to 7 GPa.

### Example 58

The resin-fibre composite of any one of Examples 53 to 57, wherein the resin-fibre composite has a tensile elongation of between 2 to 15%.

### Example 59

The resin-fibre composite of any one of Examples 53 to 58, wherein the resin-fibre composite has a HDT of between 50 to 150° C.

### Example 60

The resin-fibre composite of any one of Examples 53 to 59, wherein the resin-fibre composite has an energy required to break a standard panel in flexure greater than or equal to 2.5 J.

### Example 61

The resin-fibre composite of any one of Examples 53 to 60, wherein the resin-fibre composite is substantially isotropic.

### Example 62

The resin-fibre composite of any one of Examples 53 to 61, wherein a substantial percentage of the plurality of fibres have an aspect ratio of between 6 to 60.

### Example 63

The resin-fibre composite of any one of Examples 53 to 62, wherein the no more than 3 wt. % of the plurality of fibres are greater than 2 mm in length.

### Example 64

The resin-fibre composite of any one of Examples 53 to 63, wherein the no more than 5 wt. % of the plurality of fibres are greater than 1 mm in length.

### Example 65

The resin-fibre composite of any one of Examples 53 to 64, wherein at least 85 wt. % of the plurality of fibres are independently overlapped by at least one other fibre within the resin-fibre composite.

### Example 66

The resin-fibre composite of any one of Examples 53 to 65, wherein a substantial percentage of the plurality of fibres have an aspect ratio of between 6 to 60; no more than 3 wt. % of the plurality of fibres are greater than 2 mm in length; and no more than 5 wt. % of the plurality of fibres are greater than 1 mm in length.

### Example 67

The resin-fibre composite of any one of Examples 53 to 66, wherein a portion of the resin composition is conjugated to the at least one fibre of the plurality of fibres via a coupling agent residue of said coupling agent composition.

### Example 68

The resin-fibre composite of any one of Examples 53 to 67, wherein a substantial portion of the plurality of fibres that are conjugated via the coupling agent residue are substantially non-catalytic.

### Example 69

The resin-fibre composite of any one of Examples 53 to 68, wherein an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation.

### Example 70

The resin-fibre composite of any one of Examples 53 to 69, wherein a portion of the resin composition is adhered via the coupling agent residue to at least one fibre of the plurality of fibres.

### Example 71

The resin-fibre composite of any one of Examples 53 to 70, wherein the interphase is plasticized to reduce, or substantially reduce, interfacial stress in the cured composite.

### Example 72

The resin-fibre composite of any one of Examples 53 to 71, wherein the interphase and the resin composition are similar, substantially similar, or sufficiently similar, wherein the physical properties are selected from one or more of the following: tensile modulus, tensile elongation flexural modulus and/or flexural elongation.

### Example 73

The resin-fibre composite of any one of Examples 53 to 72, wherein the interphase efficiently transmits stress from the resin composition to the at least one fibre in the cured composite.

### Example 74

The resin-fibre composite of any one of Examples 53 to 73, wherein the interphase passivates the catalytic surface of the at least one fibre in the cured composite.

### Example 75

The resin-fibre composite of any one of Examples 53 to 74, wherein the resin composition, comprises: a blend of at least two or more resins; wherein the blend of at least two or more resins has a viscosity in the range of between 50 to 5,000 cPs at 25° C.

### Example 76

The resin composition of Example 75, wherein the blend of at least two or more resins comprises a weight ratio of between 70/30 to 50/50.

### Example 77

The resin-fibre composite of any one of Examples 53 to 74, wherein the resin, comprises:

i) a first polyester segment, comprising one or more first dicarboxylic acid residues and one or more first diol residues;
ii) a second polyester segment, comprising one or more second dicarboxylic acid residues and one or more second diol residues; and
iii) a third polyester segment, comprising one or more third vinylic-containing acid residues and one or more third diol residues;
wherein:
a) the terminal ends of the first polyester segment are conjugated to the second polyester segments;
b) the second polyester segments, conjugated to the first polyester segment, are further conjugated to the third polyester segments;
c) the resin, terminating with the third polyester segments, terminates with the one or more third vinylic-containing acid residues and/or the one or more third diol residues.

### Example 78

A resin-fibre composite, comprising:

A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and the fibre volume fraction is between 3 to 45% of the resin-fibre composite; and
C) a coupling agent composition, wherein the coupling agent composition is present between 0.5 to 5 wt. % of the weight of fibres in the composite;
wherein:
a) the resin-fibre composite has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m²;
viii) a HDT of between 50 to 150° C.;
ix) exhibits increased resistance to crack propagation;
x) energy required to break a standard panel in flexure greater than or equal to 2.5 J; and/or
xi) is substantially isotropic;
b) the plurality of fibres have one or more of the following characteristics:
i) at least 85 wt. % of the plurality of fibres are less than 1 mm in length;
ii) a mean fibre length in the range between 200 to 700 microns;
iii) a mean fibre diameter in the range of between 5 to 20 microns;
iv) a substantial percentage of the plurality of fibres have an aspect ratio of between 6 to 60;
v) no more than 3 wt. % of the plurality of fibres are greater than 2 mm in length; and/or
vi) no more than 5 wt. % of the plurality of fibres are greater than 1 mm in length;
c) the resin-fibre composite has one or more of the following additional properties:
i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
ii) a portion of the resin composition is conjugated to the at least one fibre of the plurality of fibres via a coupling agent residue of said coupling agent composition;
iii) a substantial portion of the plurality of fibres that are conjugated via the coupling agent residue are substantially non-catalytic;
iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation;
v) a portion of the resin composition is adhered via the coupling agent residue to at least one fibre of the plurality of fibres;
vi) the interphase is plasticized to reduce, or substantially reduce, interfacial stress in the cured composite;
vii) the interphase and the resin composition are similar, substantially similar, or sufficiently similar, wherein the physical properties are selected from one or more of the following: tensile modulus, tensile elongation flexural modulus and/or flexural elongation;
viii) the interphase efficiently transmits stress from the resin composition to the at least one fibre in the cured composite; and/or
ix) the interphase passivates the catalytic surface of the at least one fibre in the cured composite.

### Example 79

A resin, comprising a resin composition having a molecular weight of between 3,000 and 15,000 Daltons;

wherein:
a) the resin composition is between 30 to 95 wt. % of the resin; and
b) the resin, upon curing, has one or more of the following properties:
   i) a flexural modulus of between 1 to 7 GPa;
   ii) a flexural strength of between 30 to 150 MPa;
   iii) a flexural elongation at break of between 2 to 20%;
   iv) a tensile strength of between 20 to 110 MPa;
   v) a tensile modulus of between 1.0 to 7 GPa;
   vi) a tensile elongation of between 2 to 15%;
   vii) an unnotched Izod impact strength of between 1.5 to 6 KJ/m²;
   viii) a HDT of between 50 to 150° C.;
   ix) exhibits increased resistance to crack propagation;
   x) energy required to break a standard panel in flexure greater than or equal to 2.5 J; and/or
   xi) is substantially isotropic.

### Example 80

A resin, comprising:

A) a first polyester segment, comprising one or more first dicarboxylic acid residues and one or more first diol residues;
B) a second polyester segment, comprising one or more second dicarboxylic acid residues and one or more second diol residues; and
C) a third polyester segment, comprising one or more third vinylic-containing acid residues and one or more third diol residues;
wherein:
a) the terminal ends of the first polyester segment are conjugated to the second polyester segments;
b) the second polyester segments, conjugated to the first polyester segment, are further conjugated to the third polyester segments;
c) the resin, terminating with the third polyester segments, terminates with the one or more third vinylic-containing acid residues and/or the one or more third diol residues; and
d) the resin, upon curing, has one or more of the following properties:
i) a flexural modulus of between 1 to 7 GPa;
ii) a flexural strength of between 30 to 150 MPa;
iii) a flexural elongation at break of between 2.5 to 20%;
iv) a tensile strength of between 20 to 110 MPa;
v) a tensile modulus of between 1 to 7 GPa;
vi) a tensile elongation of between 2.0 to 15%;
vii) an unnotched Izod impact strength of between 1.5 to 6 KJ/m²;
viii) a HDT of between 50 to 150° C.;
ix) exhibits increased resistance to crack propagation;
x) energy required to break a standard panel in flexure ≧2.5 J; and/or
xi) is substantially isotropic.

### Example 81

A resin-fibre composite, comprising:

A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and the fibre volume fraction is between 3 to 45% of the resin-fibre composite; and
C) a coupling agent composition, wherein the coupling agent composition is present between 0.5 to 5 wt. % of the weight of fibres in the composite;
wherein:
a) the resin composition comprises:
A) a first polyester segment, comprising one or more first dicarboxylic acid residues and one or more first diol residues;
B) a second polyester segment, comprising one or more second dicarboxylic acid residues and one or more second diol residues; and
C) a third polyester segment, comprising one or more third vinylic-containing acid residues and one or more third diol residues;
wherein:
i) the terminal ends of the first polyester segment are conjugated to the second polyester segments;
ii) the second polyester segments, conjugated to the first polyester segment, are further conjugated to the third polyester segments; and
iii) the resin, terminating with the third polyester segments, terminates with the one or more third vinylic-containing acid residues and/or the one or more third diol residues;
b) the resin-fibre composite has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m²;
viii) a HDT of between 50 to 150° C.;
ix) exhibits increased resistance to crack propagation; and
x) energy required to break a standard panel in flexure greater than or equal to 2.5 J; and/or
xi) is substantially isotropic;
c) the plurality of fibres have one or more of the following characteristics:
i) at least 85 wt. % of the plurality of fibres are less than 1 mm in length;
ii) a mean fibre length in the range between 200 to 700 microns;
iii) a mean fibre diameter in the range of between 5 to 20 microns;
iv) a substantial percentage of the plurality of fibres have an aspect ratio of between 6 to 60;
v) no more than 3 wt. % of the plurality of fibres are greater than 2 mm in length; and/or
vi) no more than 5 wt. % of the plurality of fibres are greater than 1 mm in length;
d) the resin-fibre composite has one or more of the following additional properties:
i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
ii) a portion of the resin composition is conjugated to the at least one fibre of the plurality of fibres via a coupling agent residue of said coupling agent composition;
iii) a substantial portion of the plurality of fibres that are conjugated via the coupling agent residue are substantially non-catalytic;
iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation;
v) a portion of the resin composition is adhered via the coupling agent residue to at least one fibre of the plurality of fibres;
vi) the interphase is plasticized to reduce, or substantially reduce, interfacial stress in the cured composite;
vii) the interphase and the resin composition are similar, substantially similar, or sufficiently similar, wherein the physical properties are selected from one or more of the following: tensile modulus, tensile elongation flexural modulus and/or flexural elongation;
viii) the interphase efficiently transmits stress from the resin composition to the at least one fibre in the cured composite; and/or
ix) the interphase passivates the catalytic surface of the at least one fibre in the cured composite.

### Example 82

A resin-fibre composite, comprising:
A) a resin, comprising:
   a) a first polyester segment, comprising one or more first dicarboxylic acid residues and one or more first diol residues;
   b) at least two second polyester segments, comprising one or more second dicarboxylic acid residues and one or more second diol residues; and
   c) at least two third polyester segments, comprising one or more third vinylic-containing acid residues and one or more third diol residues; and
B) a fibre conjugated to the resin via a coupling agent residue;
   wherein:
i) the terminal ends of the first polyester segment are conjugated to the at least two second polyester segments;
ii) the at least two second polyester segments, conjugated to the first polyester segment, are further conjugated to the at least two third polyester segments; and
iii) the resin, terminating with the at least two third polyester segments, terminates with the one or more third vinylic-containing acid residues and/or the one or more third diol residues.
iv) the fibre conjugated via the coupling agent residue is non-catalytic; and/or
v) an interphase between the fibre and the resin has substantially the same properties as the resin, wherein the substantially same properties are selected from one or more of the following: tensile modulus, tensile elongation, flexural modulus and/or flexural elongation.

### Example 83

A resin-fibre composite, comprising:
A) a resin, derived from:
   a) conjugating each terminal end of a first polyester segment to at least two second polyester segments; and
   b) further conjugating the at least two second polyester segments, conjugated to the first polyester segment, to at least two third polyester segments;
B) a fibre; and
C) a coupling agent residue conjugated to the resin and the fibre;
   wherein:
i) the first polyester segment comprises one or more first dicarboxylic acid residues and one or more first diol residues;
ii) at least two second polyester segments comprise one or more second dicarboxylic acid residues and one or more second diol residues;
iii) at least two third polyester segments comprise one or more third vinylic-containing acid residues, one or more dicarboxilic acid residues and one or more third diol residues; and
iv) the resin terminates with the one or more third vinylic-containing acid residues and/or the one or more third diol residues.

### Example 84

A liquid resin-fibre composite, comprising:
A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and the fibre volume fraction is between 3 to 45% of the resin-fibre composite; and
C) a coupling agent composition, wherein the coupling agent composition is present between 0.5 to 5 wt. % of the weight of fibres in the composite;
   wherein:
a) the liquid resin-fibre composite has one or more of the following properties:
   i) a viscosity in the range of between 50 to 5,000 cPs at 25° C.; and/or
   ii) is substantially isotropic;
b) the resin-fibre composite when cured has one or more of the following properties:
   i) a flexural modulus of between 1 to 7 GPa;
   ii) a flexural strength of between 30 to 150 MPa;
   iii) a flexural elongation at break of between 2 to 20%;
   iv) a tensile strength of between 20 to 110 MPa;
   v) a tensile modulus of between 1 to 7 GPa;
   vi) a tensile elongation of between 2 to 15%;
   vii) an unnotched Izod impact strength of between 1.5 to 6 KJ/m²;
   viii) a HDT of between 50 to 150° C.;
   ix) exhibits increased resistance to crack propagation;
   x) energy required to break a standard panel in flexure ≧2.5 J; and/or
   xi) is substantially isotropic;
c) the plurality of fibres have one or more of the following characteristics:
   i) at least 85 wt. % of the plurality of fibres are less than 1 mm in length;
   ii) a mean fibre length in the range of between 200 to 700 microns;
   iii) a mean fibre diameter in the range between 5 to 20 microns;
   iv) a substantial percentage of the plurality of fibres have an aspect ratio of between 6 to 60;
   v) no more than 3 wt. % of the plurality of fibres are greater than 2 mm in length; and/or
   vi) no more than 5 wt. % of the plurality of fibres are greater than 1 mm in length;
d) the liquid resin-fibre composite has one or more of the following additional properties:
   i) a portion of the resin composition is conjugated to the at least one fibre of the plurality of fibres via a coupling agent residue of said coupling agent composition;
   ii) a substantial portion of the plurality of fibres that are conjugated via the coupling agent residue are substantially non-catalytic;
   iii) an interphase between the at least one fibre of the plurality of fibres and the resin composition having substantially the same properties as the resin composition upon curing, wherein the substantially same properties are selected from one or more of the following: tensile modulus, tensile elongation, flexural modulus and/or flexural elongation;
   iv) a portion of the resin composition is adhered via the coupling agent residue to at least one fibre of the plurality of fibres;
   v) the interphase and the resin composition are similar, substantially similar, or sufficiently similar, wherein the physical properties upon curing are selected from one or more of the following: tensile modulus, tensile elongation flexural modulus and/or flexural elongation;
   vi) the interphase passivates the catalytic surface of the at least one fibre in the cured composite;
   vii) the surface energy of a substantial portion of the plurality of fibres is match with the surface tension of the resin to promote wetting by reducing the contact angle of the resin on the fibre in the liquid resin-fibre composite; and/or
   viii) the coupling agent is chemically bonded to the substantial percentage of the plurality of fibres surfaces so that the substantial percentage of the plurality of fibres forms a chemical bond with a portion of the resin composition via the coupling agent during the curing process.

### Example 85

A liquid resin-fibre composite, comprising:
A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and the fibre volume fraction is between 3 to 45% of the resin-fibre composite; and
C) a coupling agent composition, wherein the coupling agent composition is present between 0.5 to 5 wt. % of the weight of fibres in the composite;
   wherein:
a) the resin composition comprises:
   i) a first polyester segment, comprising one or more first dicarboxylic acid residues and one or more first diol residues;
   ii) a second polyester segment, comprising one or more second dicarboxylic acid residues and one or more second diol residues; and
   iii) a third polyester segment, comprising one or more third vinylic-containing acid residues and one or more third diol residues;
   wherein:
      i) the terminal ends of the first polyester segment are conjugated to the second polyester segments;
      ii) the second polyester segments, conjugated to the first polyester segment, are further conjugated to the third polyester segments; and
      iii) the resin, terminating with the third polyester segments, terminates with the one or more third vinylic-containing acid residues and/or the one or more third diol residues;
b) the liquid resin-fibre composite has one or more of the following properties:
   i) a viscosity in the range of between 50 to 5,000 cPs at 25° C.; and
   ii) is substantially isotropic;
c) the resin-fibre composite has one or more of the following properties:
   i) a flexural modulus of between 1 to 7 GPa;
   ii) a flexural strength of between 30 to 150 MPa;
   iii) a flexural elongation at break of between 2 to 20%;
   iv) a tensile strength of between 20 to 110 MPa;
   v) a tensile modulus of between 1 to 7 GPa;
   vi) a tensile elongation of between 2 to 15%;
   vii) an unnotched Izod impact strength of between 1.5 to 6 KJ/m²;
   viii) a HDT of between 50 to 150° C.;
   ix) exhibits increased resistance to crack propagation;
   x) energy required to break a standard panel in flexure greater than or equal to 2.5 J; and/or
   xi) is substantially isotropic;
d) the plurality of fibres have one or more of the following characteristics:
   i) at least 85 wt. % of the plurality of fibres are less than 1 mm in length;
   ii) a mean fibre length in the range of between 200 to 700 microns;
   iii) a mean fibre diameter in the range of between 5 to 20 microns;
   iv) a substantial percentage of the plurality of fibres have an aspect ratio of between 6 to 60;
   v) no more than 3 wt. % of the plurality of fibres are greater than 2 mm in length; and/or
   vi) no more than 5 wt. % of the plurality of fibres are greater than 1 mm in length;
e) the liquid resin-fibre composite has one or more of the following additional properties:
   i) a portion of the resin composition is conjugated to the at least one fibre of the plurality of fibres via a coupling agent residue of said coupling agent composition;
   ii) a substantial portion of the plurality of fibres that are conjugated via the coupling agent residue are substantially non-catalytic;
   iii) an interphase between the at least one fibre of the plurality of fibres and the resin composition having substantially the same properties as the resin composition upon curing, wherein the substantially same properties are selected from one or more of the following: tensile modulus, tensile elongation, flexural modulus and/or flexural elongation;
   iv) a portion of the resin composition is adhered via the coupling agent residue to at least one fibre of the plurality of fibres;
   v) the interphase passivates the catalytic surface of the at least one fibre in the cured composite.
   vi) the surface energy of a substantial portion of the plurality of fibres is match with the surface tension of the resin to promote wetting by reducing the contact angle of the resin on the fibre in the liquid resin-fibre composite; and/or
   vii) the coupling agent is chemically bonded to the substantial, percentage of the plurality of fibres surfaces so that the substantial percentage of the plurality of fibres forms a chemical bond with a portion of the resin composition via the coupling agent during the curing process.

### Example 86

A method of preparing a resin-fibre composite, comprising:
A) forming a resin, comprising:
   a) reacting one or more first dicarboxylic acid residues with one or more first diol residues to form a first polyester;
   b) reacting each terminal end of the formed first polyester with one or more second dicarboxylic acid residues and one or more second diol residues to form an extended polyester; and
   c) reacting each terminal end of the extended polyester with one or more third vinylic-containing acid residues and one or more third diol residues to form the resin; and
B) conjugating each terminal end of the resin to a plurality of fibres via a coupling agent to form a resin-fibre composite;
   wherein:
a) the resin-fibre composite has one or more of the following properties:
   i) a flexural modulus of between 1 to 7 GPa;
   ii) a flexural strength of between 30 to 150 MPa;
   iii) a flexural elongation at break of between 2 to 20%;
   iv) a tensile strength of between 20 to 110 MPa;
   v) a tensile modulus of between 1.0 to 7 GPa;
   vi) a tensile elongation of between 2 to 15%;
   vii) an unnotched Izod impact strength of between 1.5 to 6 KJ/m²;
   viii) a HDT of between 50 to 150° C.;
   ix) exhibits increased resistance to crack propagation;
   x) energy required to break a standard panel in flexure greater than or equal to 2.5 J and/or
   xi) is substantially isotropic;
b) the plurality of fibres have one or more of the following characteristics:
   i) at least 85 wt. % of the plurality of fibres are less than 1 mm in length;
   ii) a mean fibre length in the range of between 200 to 700 microns;
   iii) a mean fibre diameter in the range of between 5 to 20 microns;
   iv) a substantial percentage of the plurality of fibres have an aspect ratio of between 6 to 60;
   v) no more than 3 wt. % of the plurality of fibres are greater than 2 mm in length; and/or
   vi) no more than 5 wt. % of the plurality of fibres are greater than 1 mm in length;
c) the resin-fibre composite has one or more of the following additional properties:
   i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
   ii) a portion of the resin composition is conjugated to the at least one fibre of the plurality of fibres via a coupling agent residue of said coupling agent composition;
   iii) a substantial portion of the plurality of fibres that are conjugated via the coupling agent residue are substantially non-catalytic;
   iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation;
   v) a portion of the resin composition is adhered via the coupling agent residue to at least one fibre of the plurality of fibres;
   vi) the interphase is plasticized to reduce, or substantially reduce, interfacial stress in the cured composite;
   vii) the interphase and the resin composition are similar, substantially similar, or sufficiently similar, wherein the physical properties are selected from one or more of the following: tensile modulus, tensile elongation flexural modulus and/or flexural elongation;
   viii) the interphase efficiently transmits stress from the resin composition to the at least one fibre in the cured composite; and/or
   ix) the interphase passivates the catalytic surface of the at least one fibre in the cured composite.

### Example 87

A resin composition, comprising: a blend of at least two or more resins;
wherein:
A) the blend of at least two or more resins has one or more of the following properties:
   i) a viscosity in the range of between 50 to 5,000 cPs at 25° C.; and
   ii) is substantially isotropic; and
B) the resin composition has one or more of the following properties:
   i) a flexural modulus of between 1 to 7 GPa;
   ii) a flexural strength of between 30 to 150 MPa;
   iii) a flexural elongation at break of between 2 to 20%;
   iv) a tensile strength of between 20 to 110 MPa;
   v) a tensile modulus of between 1 to 7 GPa;
   vi) a tensile elongation of between 2 to 15%;
   vii) an unnotched Izod impact strength of between 1.5 to 6 KJ/m²;
   viii) a HDT of between 50 to 150° C.;
   ix) exhibits increased resistance to crack propagation;
   x) energy required to break a standard panel in flexure greater than or equal to 2.5 J; and/or
   xi) is substantially isotropic.

### Example 88

The resin composition of example 87, wherein the blend of at least two or more resins, comprises: Resin F010; Resin 0922; Resin F013; Resin 1508; Resin Dion 9800; Resin 1508; Resin 0922; Resin Polylite 31830; Resin Dion 9600; Resin Dion 31038; or Resin Dion 9400 or equivalents.

### Example 89

The resin composition of example 87, wherein the blend of at least two or more resins, comprises:

i) Resin F010 and Resin 0922;

ii) Resin F013 and Resin 0922;

ii) Resin F010 and Resin 1508;

iv) Resin F013 and Resin 1508;

v) Resin Dion 9800 and Resin 1508;

vi) Resin Dion 9800 and Resin 0922;

vii) Resin F010 and Resin 1508;

viii) Resin F013 and Resin 1508;

ix) Resin Dion 9800 and Resin Polylite 31830;

x) Resin Dion 9800 and Resin Dion 9600; or

xi) Resin Dion 31038 and Resin Dion 9600;

xii) Resin Dion 9400 and Resin Dion 9600;

xiii) or equivalent resins from other manufacturers.

### Example 90

The resin composition of any one of examples 87-89, wherein the blend of at least two or more resins comprises a weight ratio of between 70/30 to 50/50.

### Example 91

The resin composition of any one of examples 87 to 89, wherein the blend of at least two or more resins comprises a weight ratio of between 75/35 to 55/45.

### Example 92

A resin-fibre composite, comprising:
A) a blend of at least two or more resins; and
B) a plurality of fibres, wherein the plurality of fibres are between 5 to 65 wt. % of the resin-fibre composite; and the fibre volume fraction is between 3 to 35% of the resin-fibre composite;
C) a coupling agent composition, wherein the coupling agent composition is present between 0.5 to 5 wt. % of the weight of fibres in the composite;
wherein:
a) the blend of at least two or more resins has one or more of the following properties:
i) a viscosity in the range of between 50 to 5,000 cPs at 25° C.; and
ii) is substantially isotropic;
b) the resin-fibre composite has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5 to 6 KJ/m2;
viii) a HDT of between 50 to 150° C.;
ix) exhibits increased resistance to crack propagation;
x) energy required to break a standard panel in flexure greater than or equal to 2.5 J; and/or
xi) is substantially isotropic;
c) the plurality of fibres have one or more of the following characteristics:
i) at least 85 wt. % of the plurality of fibres are less than 1 mm in length;
ii) a mean fibre length in the range between 200 to 700 microns;
iii) a mean fibre diameter in the range of between 5 to 20 microns;
iv) a substantial percentage of the plurality of fibres have an aspect ratio of between 6 to 60;
v) no more than 3 wt. % of the plurality of fibres are greater than 2 mm in length; and/or
vi) no more than 5 wt. % of the plurality of fibres are greater than 1 mm in length;
d) the resin-fibre composite has one or more of the following additional properties:
i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
ii) a portion of the resin composition is conjugated to the at least one fibre of the plurality of fibres via a coupling agent residue of said coupling agent composition;
iii) a substantial portion of the plurality of fibres that are conjugated via the coupling agent residue are substantially non-catalytic;
iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation;
v) a portion of the resin composition is adhered via the coupling agent residue to at least one fibre of the plurality of fibres;
vi) the interphase is plasticized to reduce, or substantially reduce, interfacial stress in the cured composite;
vii) the interphase and the resin composition are similar, substantially similar, or sufficiently similar, wherein the physical properties are selected from one or more of the following: tensile modulus, tensile elongation flexural modulus and/or flexural elongation;
viii) the interphase efficiently transmits stress from the resin composition to the at least one fibre in the cured composite; and/or
ix) the interphase passivates the catalytic surface of the at least one fibre in the cured composite.

### Example 93

The resin-fibre composite of example 92, wherein the blend of at least two or more resins, comprises: Resin F010; Resin 0922; Resin F013; Resin 1508; Resin Dion 9800; Resin 1508; Resin 0922; Resin Polylite 31830; Resin Dion 9600; Resin Dion 31038; or Resin Dion 9400 or equivalents.

### Example 94

The resin-fibre composite of any one of examples 92 to 93, wherein the blend of at least two or more resins, comprises:

### a) Resin F010 and Resin 0922;

### b) Resin F013 and Resin 0922;

### c) Resin F010 and Resin 1508;

### d) Resin F013 and Resin 1508;

### e) Resin Dion 9800 and Resin 1508;

### f) Resin Dion 9800 and Resin 0922;

### g) Resin F010 and Resin 1508;

### h) Resin F013 and Resin 1508;

### i) Resin Dion 9800 and Resin Polylite 31830;

### j) Resin Dion 9800 and Resin Dion 9600; or

### k) Resin Dion 31038 and Resin Dion 9600;

### l) Resin Dion 9400 and Resin Dion 9600;

m) or equivalent resins from other manufacturers.

### Example 95

The resin-fibre composite of any one of examples 92 to 94, wherein the blend of at least two or more resins comprises a weight ratio of between 70/30 to 50/50.

### Example 96

The resin-fibre composite of any one of examples 92 to 94, wherein the blend of at least two or more resins comprises a weight ratio of between 75/35 to 55/45.

### Example 97

A method of preparing a resin-fibre composite, comprising:
A) blending at least two or more resins; and
B) a adding a plurality of fibres, wherein the plurality of fibres are between 5 to 65 wt. % of the resin-fibre composite; and the fibre volume fraction is between 3 to 40% of the resin-fibre composite;
   wherein:
   a) the blend of at least two or more resins has one or more of the following properties:
   i) a viscosity in the range of between 50 to 5,000 cPs at 25° C.; and/or
   ii) is substantially isotropic;
   b) the resin-fibre composite has one or more of the following properties:
   i) a flexural modulus of between 1 to 7 GPa;
   ii) a flexural strength of between 30 to 150 MPa;
   iii) a flexural elongation at break of between 2 to 20%;
   iv) a tensile strength of between 20 to 110 MPa;
   v) a tensile modulus of between 1 to 7 GPa;
   vi) a tensile elongation of between 2 to 15%;
   vii) an unnotched Izod impact strength of between 1.5 to 6 KJ/m²;
   viii) a HDT of between 50 to 150° C.;
   x) exhibits increased resistance to crack propagation;
   x) energy required to break a standard panel in flexure greater than or equal to 2.5 J; and/or
   xi) is substantially isotropic.

### Example 98

The method of example 97, wherein the blend of at least two or more resins, comprises: Resin F010; Resin 0922; Resin F013; Resin 1508; Resin Dion 9800; Resin 1508; Resin 0922; Resin Polylite 31830; Resin Dion 9600; Resin Dion 31038; or Resin Dion 9400 or equivalents.

### Example 99

The method of example 97, wherein the blend of at least two or more resins, comprises:

a) Resin F010 and Resin 0922;

b) Resin F013 and Resin 0922;

c) Resin F010 and Resin 1508;

d) Resin F013 and Resin 1508;

e) Resin Dion 9800 and Resin 1508;

f) Resin Dion 9800 and Resin 0922;

g) Resin F010 and Resin 1508;

h) Resin F013 and Resin 1508;

i) Resin Dion 9800 and Resin Polylite 31830;

j) Resin Dion 9800 and Resin Dion 9600; or

k) Resin Dion 31038 and Resin Dion 9600;

l) Resin Dion 9400 and Resin Dion 9600;

m) or equivalent resins from other manufacturers.

### Example 100

The method of any one of examples 97 to 99, wherein the blend of at least two or more resins comprises a weight ratio of between 70/30 to 50/50.

### Example 101

The method of any one of examples 97 to 99, wherein the blend of at least two or more resins comprises a weight ratio of between 75/35 to 55/45.

### Example 102

The method of any one of examples 97-101, wherein the plurality of fibres have one or more of the following characteristics:
a) at least 85 wt. % of the plurality of fibres are less than 1 mm in length;
b) a mean fibre length in the range between 200 to 700 microns;
c) a mean fibre diameter in the range of between 5 to 20 microns;
d) a substantial percentage of the plurality of fibres have an aspect ratio of between 6 to 60;
e) no more than 3 wt. % of the plurality of fibres are greater than 2 mm in length; and/or
f) no more than 5 wt. % of the plurality of fibres are greater than 1 mm in length.

### Example 103

The method of any one of examples 97-101, wherein:
i) at least one fibre of the plurality of fibres has at least one other fibre that is within a cylindrical space about the at least one fibre, wherein the cylindrical space has the at least one fibre as its axis and has a diameter that is between 1.25 to 6 times the diameter of the at least one fibre;
ii) a substantial portion of the plurality of fibres that are conjugated via the coupling agent residue are substantially non-catalytic; and
iii) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation.

### Example 104

The resin composition of any one of examples 75-76, 87-89, 92-94, or 97-99, wherein the blend of at least two or more resins comprises a weight ratio of between 97/3 for alloying resins up to 50/50 for mixtures that follow the Law of Mixtures.

### Example 105

The resin composition of any one of examples 29-52, 67-78, 81, 84-86, 92-96, or 103-104, wherein the at least one fibre is at least 50 wt. % of the plurality of fibres.

### Example 105

The resin composition of any one of examples 29-52, 67-78, 81, 84-86, 92-96, or 103-104, wherein the at least one fibre is at least 75 wt. % of the plurality of fibres.

### Example 107

The resin composition of any one of examples 29-52, 67-78, 81, 84-86, 92-96, or 103-104, wherein the at least one fibre is at least 85 wt. % of the plurality of fibres.

### Example 108

The resin composition of any one of examples 29-52, 67-78, 81, 84-86, 92-96, or 103-104, wherein the at least one fibre is at least 90 wt. % of the plurality of fibres.

### Example 109

The resin composition of any one of examples 29-52, 67-78, 81, 84-86, 92-96, or 103-104, wherein the at least one fibre is at least 92 wt. % of the plurality of fibres.

### Example 110

The resin composition of any one of examples 29-52, 67-78, 81, 84-86, 92-96, or 103-104, wherein the at least one fibre is at least 95 wt. % of the plurality of fibres.

### Example 111

The resin composition of any one of examples 29-52, 67-78, 81, 84-86, 92-96, or 103-104, wherein the at least one fibre is at least 98 wt. % of the plurality of fibres.

### Example 112

The resin composition of any one of examples 29-52, 67-78, 81, 84-86, 92-96, or 103-104, wherein the at least one fibre is at least 99 wt. % of the plurality of fibres.

### Example 113

The resin composition of any one of examples 78, 81, 86, 92-96, or 103-112, wherein the cylindrical space has a diameter that is no greater than twice the diameter of the at least one fibre.

### Example 114

The resin composition of any one of examples 78, 81, 86, 92-96, or 103-112, wherein the cylindrical space has a diameter that is no greater than 3 times the diameter of the at least one fibre.

### Example 115

The resin composition of any one of examples 78, 81, 86, 92-96, or 103-112, wherein the cylindrical space has a diameter that is no greater than 4 times the diameter of the at least one fibre.

### Example 116

The resin composition of any one of examples 78, 81, 86, 92-96, or 103-112, wherein the cylindrical space has a diameter that is no greater than 5 times the diameter of the at least one fibre.

### Example 117

The resin composition of any one of examples 78, 81, 86, 92-96, or 103-112, wherein the cylindrical space has a diameter that is no greater than 6 times the diameter of the at least one fibre.

### Example 118

The resin composition of any one of examples 29-79, 81, 84-86, or 92-117, wherein at least 50 wt. % of the plurality of fibres are independently overlapped by at least one other fibre within the resin-fibre composite.

### Example 118

The resin composition of any one of examples 29-79, 81, 84-86, or 92-117, wherein at least 75 wt. % of the plurality of fibres are independently overlapped by at least one other fibre within the resin-fibre composite.

### Example 118

The resin composition of any one of examples 29-79, 81, 84-86, or 92-117, wherein at least 85 wt. % of the plurality of fibres are independently overlapped by at least one other fibre within the resin-fibre composite.

### Example 118

The resin composition of any one of examples 29-79, 81, 84-86, or 92-117, wherein at least 90 wt. % of the plurality of fibres are independently overlapped by at least one other fibre within the resin-fibre composite.

### Example 118

The resin composition of any one of examples 29-79, 81, 84-86, or 92-117, wherein at least 92 wt. % of the plurality of fibres are independently overlapped by at least one other fibre within the resin-fibre composite.

### Example 118

The resin composition of any one of examples 29-79, 81, 84-86, or 92-117, wherein at least 95 wt. % of the plurality of fibres are independently overlapped by at least one other fibre within the resin-fibre composite.

### Example 118

The resin composition of any one of examples 29-79, 81, 84-86, or 92-117, wherein at least 98 wt. % of the plurality of fibres are independently overlapped by at least one other fibre within the resin-fibre composite.

### Example 118

The resin composition of any one of examples 29-79, 81, 84-86, or 92-117, wherein at least 99 wt. % of the plurality of fibres are independently overlapped by at least one other fibre within the resin-fibre composite.

While the present disclosure has been described in connection with certain embodiments, it is to be understood that the present disclosure is not to be limited to the disclosed embodiments, but on the contrary, is intended to cover various modifications and equivalent arrangements. Also, the various embodiments described herein may be implemented in conjunction with other embodiments, e.g., aspects of one embodiment may be combined with aspects of another embodiment to realize yet other embodiments. Further, each independent feature or component of any given embodiment may constitute an additional embodiment.

1. A resin-fibre cured composite, comprising:
A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and
C) a coupling agent composition, wherein the coupling agent composition is present between 0.5 to 5 wt. % of the weight of fibres in the composite;
wherein:
a) the resin-fibre composite has one or more of the following properties:
i) a flexural strength of between 30 to 150 MPa;
ii) a tensile strength of between 20 to 110 MPa;
iii) an unnotched Izod impact strength of between 1.5 to 6 KJ/m²; and/or
iv) exhibits increased resistance to crack propagation;
b) the plurality of fibres have one or more of the following characteristics:
i) at least 85 wt. % of the plurality of fibres are less than 1 mm in length;
ii) a mean fibre length in the range between 200 to 700 microns; and/or
iii) a mean fibre diameter in the range of between 5 to 20 microns.

2. The resin-fibre composite of claim 1, wherein the fibre volume fraction is between 4 to 45% of the resin-fibre composite.

3. The resin-fibre composite of claim 2, wherein the resin-fibre composite further comprises one or more of the following properties:
i) a flexural modulus of between 1 to 7 GPa;
ii) a flexural elongation at break of between 2 to 20%;
iii) a tensile modulus of between 1 to 7 GPa;
iv) a tensile elongation of between 2 to 15%;
v) an HDT of between 50 to 150° C.;
vi) an energy required to break a standard panel in flexure of greater than or equal to 2.5 J; or
vii) is substantially isotropic.

4-9. (canceled)

10. The resin-fibre composite of claim 2, wherein the plurality of fibres further have one or more of the following characteristics:
i) a substantial percentage of the plurality of fibres have an aspect ratio of between 6 to 60;
ii) no more than 3 wt. % of the plurality of fibres are greater than 2 mm in length;
iii) no more than 5 wt. % of the plurality of fibres are greater than 1 mm in length; or
iv) at least 85 wt. % of the plurality of fibres are independently overlapped by at least one other fibre within the resin-fibre composite.

11-13. (canceled)

14. The resin-fibre composite of claim 2, wherein a substantial percentage of the plurality of fibres have an aspect ratio of between 6 to 60; no more than 3 wt. % of the plurality of fibres are greater than 2 mm in length; and no more than 5 wt. % of the plurality of fibres are greater than 1 mm in length.

15. The resin-fibre composite of claim 2, wherein a portion of the resin is conjugated to at least one fibre of the plurality of fibres via a coupling agent residue of said coupling agent composition.

16. The resin-fibre composite of claim 2, wherein a substantial portion of the plurality of fibres that are conjugated via the coupling agent residue are non-catalytic.

17. The resin-fibre composite of claim 2, wherein an interphase between the at least one fibre of the plurality of fibres and the resin composition has substantially the same properties as the resin composition, wherein the substantially same properties are selected from one- or more of the following: tensile modulus, tensile elongation, flexural modulus and/or flexural elongation.

18. The resin-fibre composite of claim 2, wherein there is a chemical adhesion via a coupling agent residue of said coupling agent composition between a portion of the resin composition and a substantial percentage of the plurality of fibres.

19. The resin-fibre composite of claim 2, wherein the interphase between the resin composition and the substantial percentage of the plurality of fibres is plasticized to reduce, or substantially reduce, interfacial stress in the cured composite.

20. The resin-fibre composite of claim 2, wherein the interphase is modified so that the physical properties between the at least one fibre of the plurality of fibres and the resin composition are similar, substantially similar, or sufficiently similar, wherein the physical properties are selected from one or more of the following: tensile modulus, tensile elongation flexural modulus and/or flexural elongation.

21. The resin-fibre composite of claim 2, wherein the interphase between the resin composition and the substantial percentage of the plurality of fibres efficiently transmits stress from the resin composition to the substantial percentage of the plurality of fibres in the cured composite.

22. The resin-fibre composite of claim 2, wherein the interphase between the resin composition and the substantial percentage of the plurality of fibres; passivates the catalytic surface of the substantial percentage of the plurality of fibres in the cured composite.

23. The resin-fibre composite of claim 2, wherein the resin composition, comprises: a blend of at least two or more resins; wherein the blend of at least two or more resins has a viscosity in the range of between 50 to 5,000 cPs at 25° C.

24. The resin composition of claim 23, wherein the blend of at least two or more resins comprises a weight ratio of between 97/3 for alloying resins up to 50/50 for mixtures that follow the Law of Mixtures.

25. The resin-fibre composite of claim 1, wherein the resin, comprises:
i) a first polyester segment, comprising one or more first dicarboxylic acid residues and one or more first diol residues;
ii) a second polyester segment, comprising one or more second dicarboxylic acid residues and one or more second diol residues; and
iii) a third polyester segment, comprising one or more third vinylic-containing acid residues and one or more third diol residues;
wherein:
a) the terminal ends of the first polyester segment are conjugated to the second polyester segments;
b) the second polyester segments, conjugated to the first polyester segment, are further conjugated to the third polyester segments;
c) the resin, terminating with the third polyester segments, terminates with the one or more third vinylic-containing acid residues and/or the one or more third diol residues.

26. A resin-fibre composite, comprising:
A) a resin composition having a molecular weight of between 3,000 and 15,000 Daltons, wherein the resin composition is between 30 to 95 wt. % of the resin-fibre composite;
B) a plurality of fibres, wherein the plurality of fibres are between 5 to 65 wt. % of the resin-fibre composite; and the fibre volume fraction is between 3 to 45% of the resin-fibre composite; and
C) a coupling agent composition, wherein the coupling agent composition is present between 0.5 to 5 wt. % of the weight of fibres in the composite;
wherein:
a) the resin-fibre composite has one or more of the following properties:
i) a flexural modulus of between 1 to 7 GPa;
ii) a flexural strength of between 30 to 150 MPa;
iii) a flexural elongation at break of between 2 to 20%;
iv) a tensile strength of between 20 to 110 MPa;
v) a tensile modulus of between 1 to 7 GPa;
vi) a tensile elongation of between 2 to 15%;
vii) an unnotched Izod impact strength of between 1.5. to 6 KJ/m²;
viii) a HDT of between 50 to 150° C.;
ix) exhibits increased resistance to crack propagation;
x) energy required to break a standard panel in flexure greater than or equal to 2.5 J; and/or
xi) is substantially isotropic;
b) the plurality of fibres have one or more of the following characteristics:
i) at least 85 wt. % of the plurality of fibres are less than 1 mm in length;
ii) a mean fibre length in the range between 200 to 700 microns;
iii) a mean fibre diameter in the range of between 5 to 20 microns;
iv) a substantial percentage of the plurality of fibres have an aspect ratio of between 6 to 60;
v) no more than 3 wt. % of the plurality of fibres are greater than 2 mm in length; and/or
vi) no more than 5 wt. % of the plurality of fibres are greater than 1 mm in length;
c) the resin-fibre composite has one or more of the following additional properties:
i) at least one fibre of the plurality of fibres has at least one other fibre that is within a cylinderical space about the at least one fibre, wherein the cylinderical space has the at least one fibre as its axis and has a diameter that is between 1.25 to 6 times the diameter of the at least. one fibre;
ii) a portion of the resin composition is conjugated to the at least one fibre of the plurality of fibres via a coupling agent residue of said coupling agent composition;
iii) a substantial portion of the plurality of fibres that are conjugated via the coupling agent residue are substantially non-catalytic;
iv) an interphase between the at least one fibre of the plurality of fibres and the resin composition having substantially the same properties as the resin composition, wherein the substantially same properties are selected from one or more of the following: tensile modulus, tensile elongation, flexural modulus and/or flexural elongation;
v) a portion of the resin composition is adhered via the coupling agent residue to at least one fibre of the plurality of fibres;
vi) the interphase is plasticized to reduce, or substantially reduce, interfacial stress in the cured composite;
vii) the interphase and the resin composition are similar, substantially similar, or sufficiently similar, wherein the physical properties are selected from one or more of the following: tensile modulus, tensile elongation flexural modulus and/or flexural elongation;
viii) the interphase efficiently transmits stress from the resin composition to the at least one fibre in the cured composite; and/or
ix) the interphase passivates the catalytic surface of the at least one fibre in the cured composite.

27. The resin composition of claim 26, wherein the at least one fibre is at least 50 wt. % of the plurality of fibres.

28-34. (canceled)

35. The resin composition of claim 26, wherein the cylindrical space has a diameter that is no greater than twice the diameter of the at least one fibre.

36-39. (canceled)
